(19) United States
(12) Patent Application Publication
(10) Pub. No.: US 2024/0057108 A1
(43) Pub. Date: Feb. 15, 2024

(54) Hybrid Automatic Repeat Request Feedback with Multi-cell Downlink Control Information

(71) Applicant: Ofinno, LLC, Reston, VA (US)

(72) Inventors: Yunjung Yi, Vienna, VA (US); Esmael Hejazi Dinan, McLean, VA (US); Ali Cagatay Cirik, Chantilly, VA (US); Nazanin Rastegardoost, McLean, VA (US)

(73) Assignee: Ofinno, LLC, Reston, VA (US)

(21) Appl. No.: 18/136,579

(22) Filed: Apr. 19, 2023

Related U.S. Application Data
(63) Continuation of application No. PCT/US2021/055499, filed on Oct. 19, 2021.
(60) Provisional application No. 63/093,686, filed on Oct. 19, 2020.

(51) Int. Cl. H04W 72/232; H04L 1/1829; H04L 1/1867; H04L 5/00

(52) U.S. Cl. CPC H04W 72/232; H04L 1/1854; H04L 1/1887; H04L 1/1864; H04L 5/0055

(57) ABSTRACT

A base station transmits, to a wireless device, a first downlink control information (DCI) indicating resources of a plurality of cells and a first downlink assignment index (DAI) that is associated with a first cell having a smallest cell index from the plurality of cells. The base station may also receive, from the wireless device, uplink signal comprising feedback bits corresponding to the first DCI.

### CROSS-REFERENCE TO RELATED APPLICATIONS

This application is a continuation of International Application No. PCT/US2021/055499, filed Oct. 19, 2021, which claims the benefit of U.S. Provisional Application No. 63/093,686, filed Oct. 19, 2020, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates example configuration parameters for a wireless device to receive control and/or data from a base station.

FIG. 18 configuration parameters of a coreset.

FIG. 19 illustrates an example DCI format for scheduling uplink resource of a single cell.

FIG. 20 illustrates an example DCI format for scheduling downlink resource of a single cell

FIG. 21 illustrates an example scenario of a multi-cell scheduling and a single cell scheduling.

FIG. 22 illustrates an example of HARQ feedback determination.

FIG. 23 illustrates an example of HARQ feedback determination with a plurality of serving cells.

FIG. 24 illustrates an example of HARQ feedback determination with a plurality of serving cells based on a Type-1 HARQ-ACK codebook determination.

FIG. 25 illustrates an example scenario of a HARQ-ACK codebook determination.

FIG. 25 illustrates example parameters of a search space to configure one or more monitoring occasions within a monitoring periodicity.

FIG. 26 illustrates an example embodiment of determining a downlink assignment index.

FIG. 27 illustrates an example pseudo code of an embodiment of a HARQ-ACK codebook determination.

FIG. 28 illustrates an example embodiment of determining HARQ-ACK codebook for two-cell scheduling DCIs and two-transport block scheduling DCIs.

FIG. 29 illustrates an example pseudo code of an embodiment of a HARQ-ACK codebook determination.

FIG. 30 illustrates an example embodiment of a plurality of downlink assignment index fields for a multi-cell scheduling.

FIG. 31 illustrates an example embodiment of determining independent HARQ-ACK codebook between a multi-cell scheduling and a single cell scheduling.

FIG. 32 illustrates an example embodiment of transmitting independent HARQ-ACK codebook between a multi-cell scheduling and a single cell scheduling.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

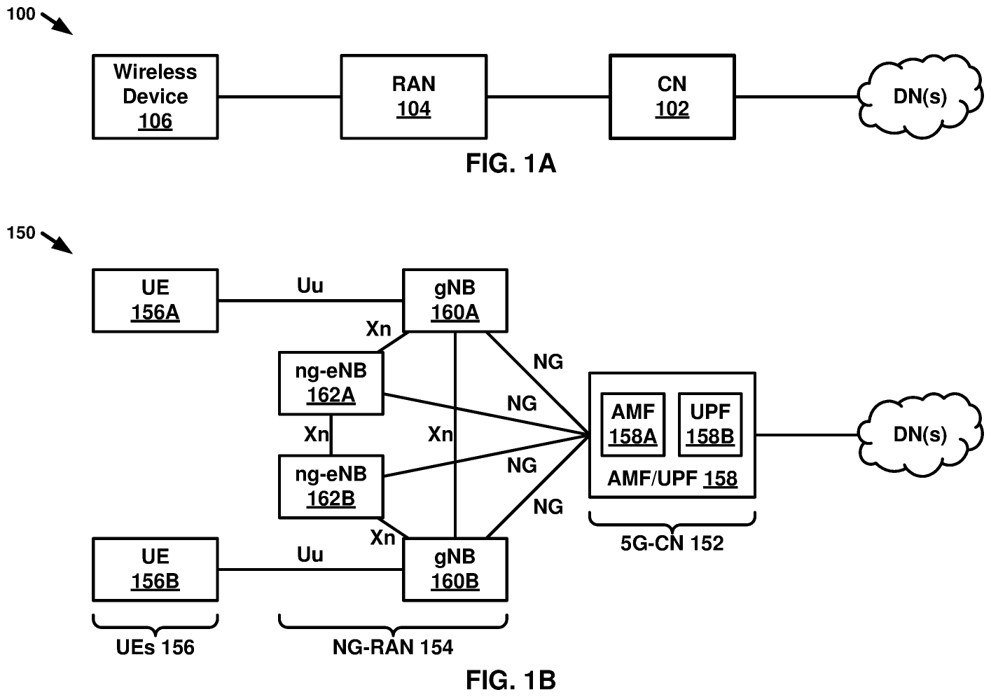

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNs (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, WiFi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNs (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interlace and to other base stations by an Xn interface. The NG and Xn interlaces may be established using direct physical connections and/or indirect connections over an underlying transport network, such as an internet protocol (IP) transport network. The gNBs 160 and/or the ng-eNBs 162 may be connected to the UEs 156 by means of a Uu interlace. For example, as illustrated in FIG. 1B, gNB 160A may be connected to the UE 156A by means of a Uu interlace. The NG, Xn, and Uu interlaces are associated with a protocol stack. The protocol stacks associated with the interlaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interlaces. For example, the gNB 160A may be connected to the UPF 158B of the AMF/UPF 158 by means of an NG-User plane (NG-U) interlace. The NG-U interlace may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interlace may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interlace. For example, the gNB 160A may provide NR user plane and control plane protocol terminations toward the UE 156A over a Uu interlace associated with a first protocol stack. The ng-eNBs 162 may provide Evolved UMTS Terrestrial Radio Access (E-UTRA) user plane and control plane protocol terminations towards the UEs 156 over a Uu interlace, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interlace (e.g., Uu, Xn, and NG interlaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

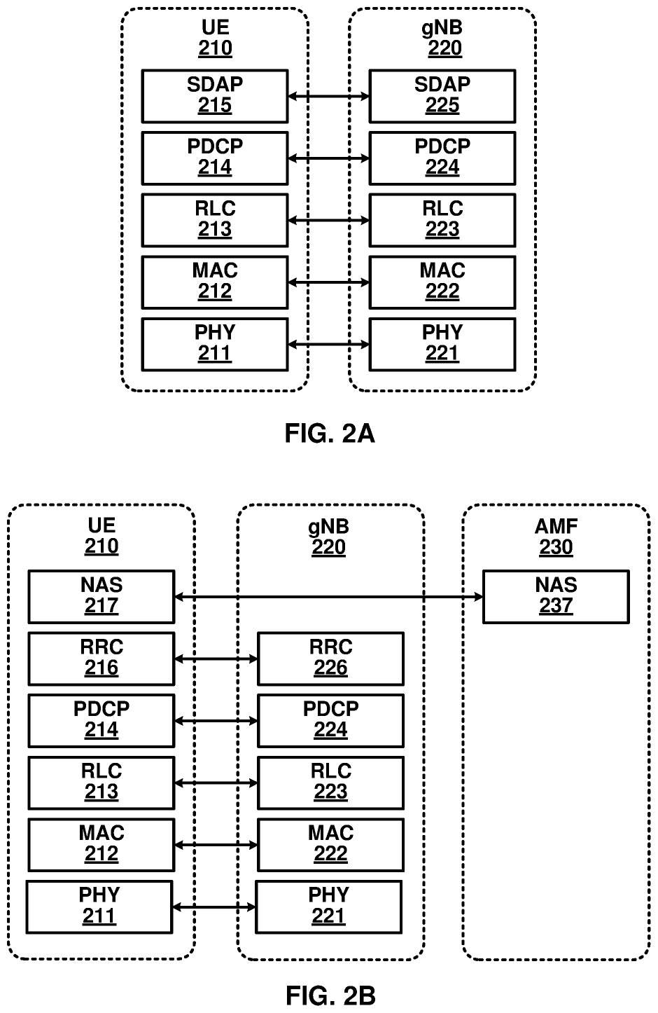

FIG. 2A and FIG. 2B respectively illustrate examples of NR user plane and NR control plane protocol stacks for the Uu interlace that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

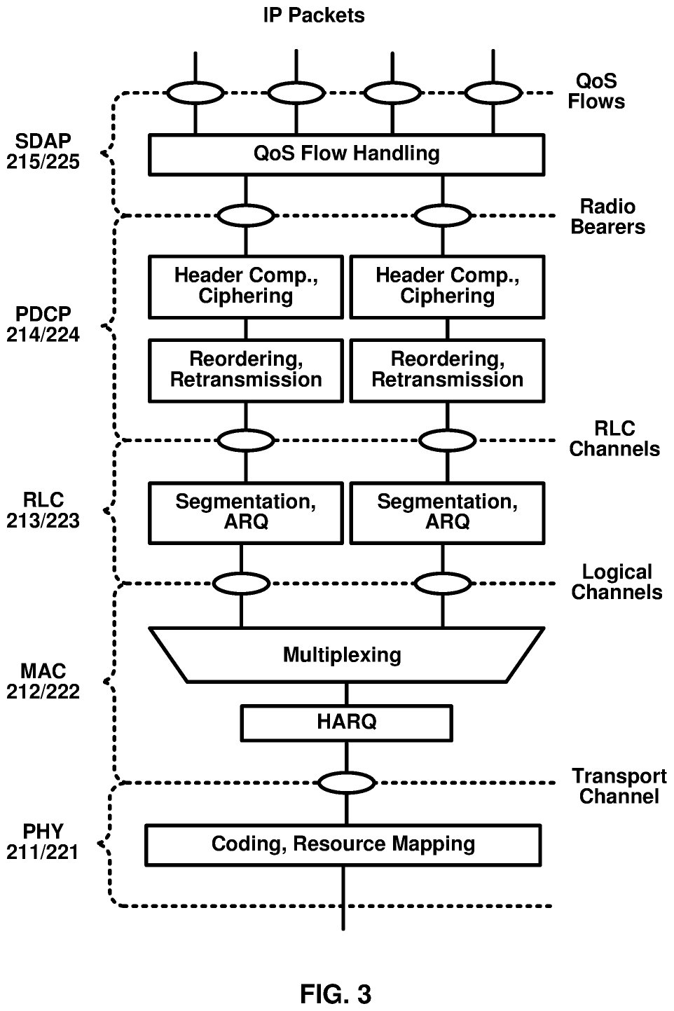

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

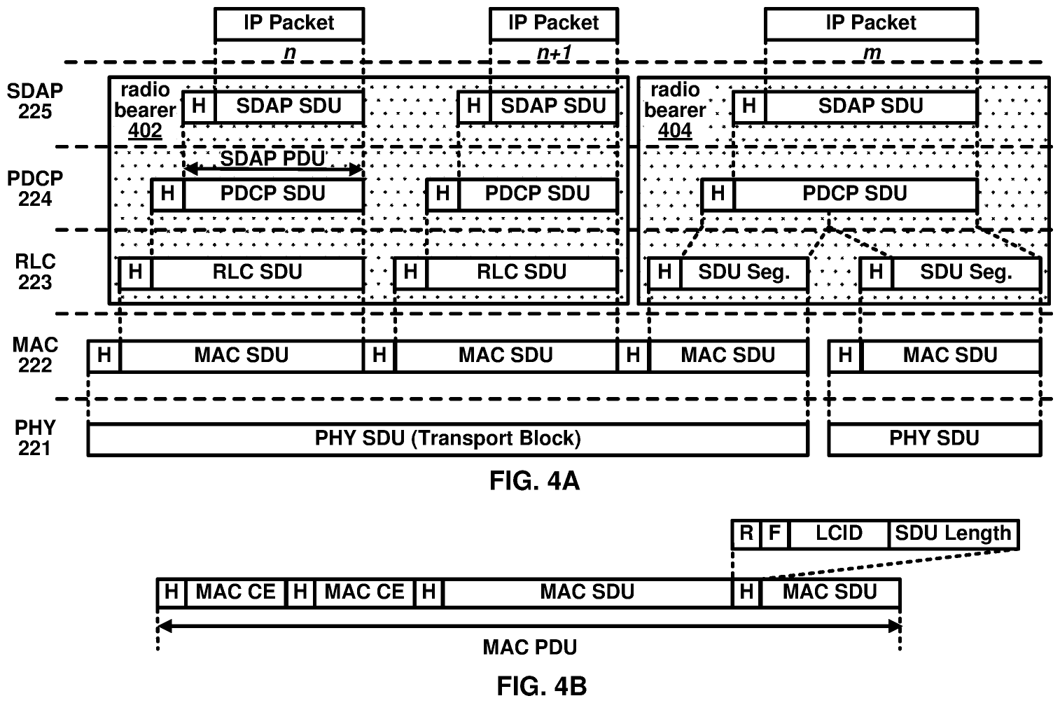

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

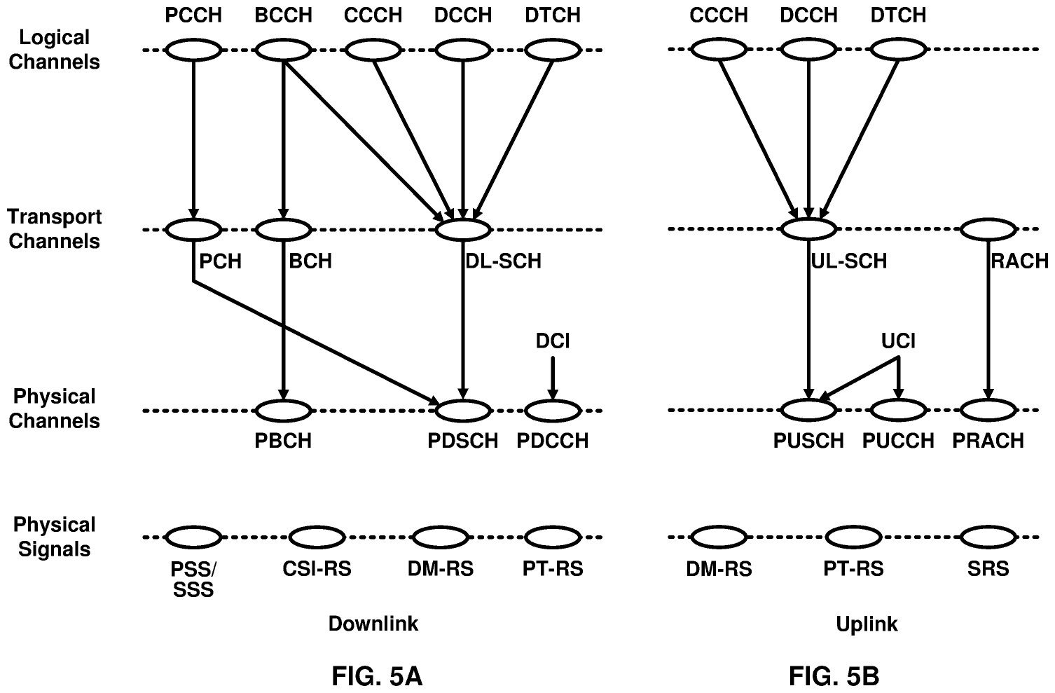

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

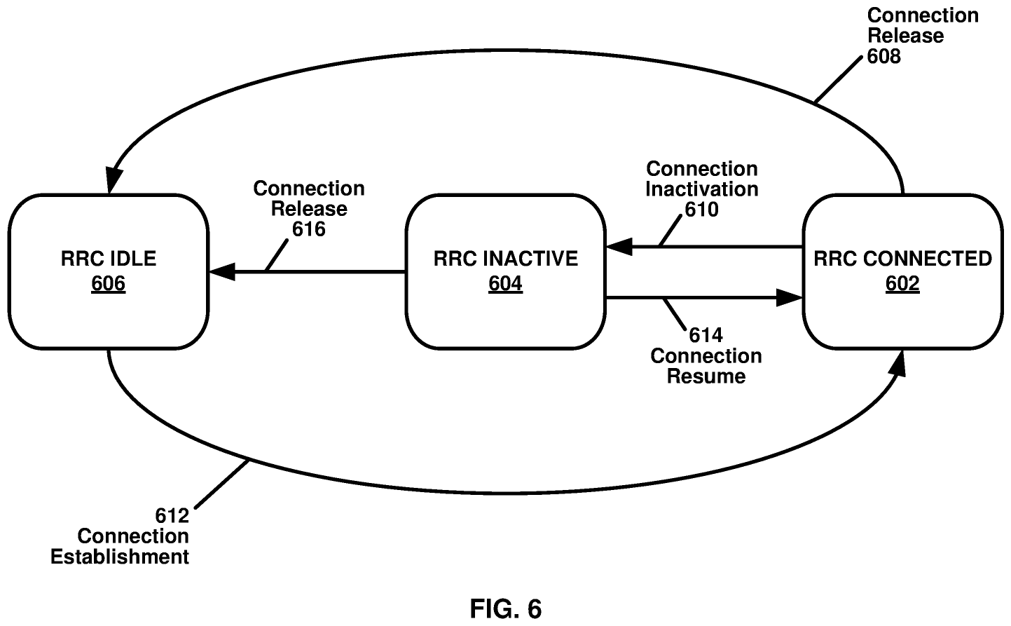

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

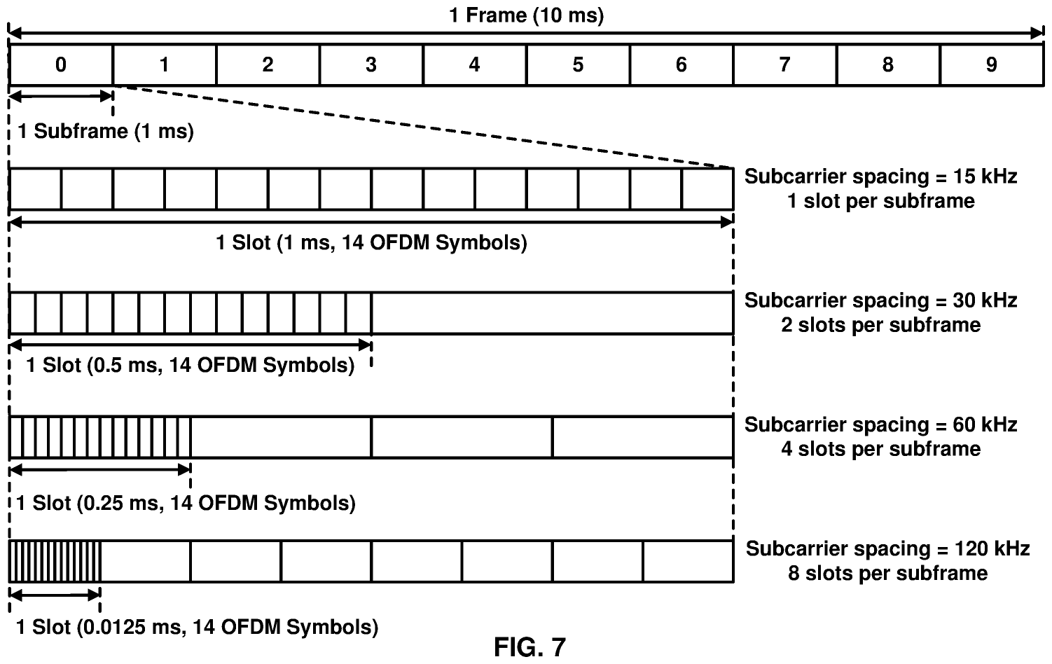

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 kHz/2.3 μs; 60 kHz/1.2 μs; 120 kHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

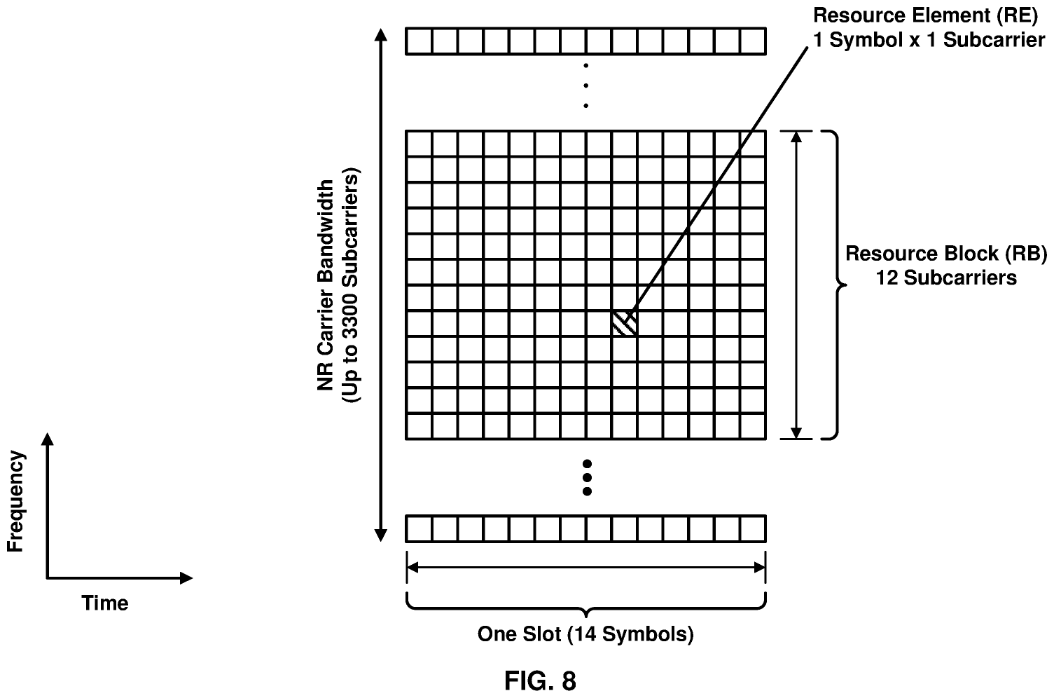

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

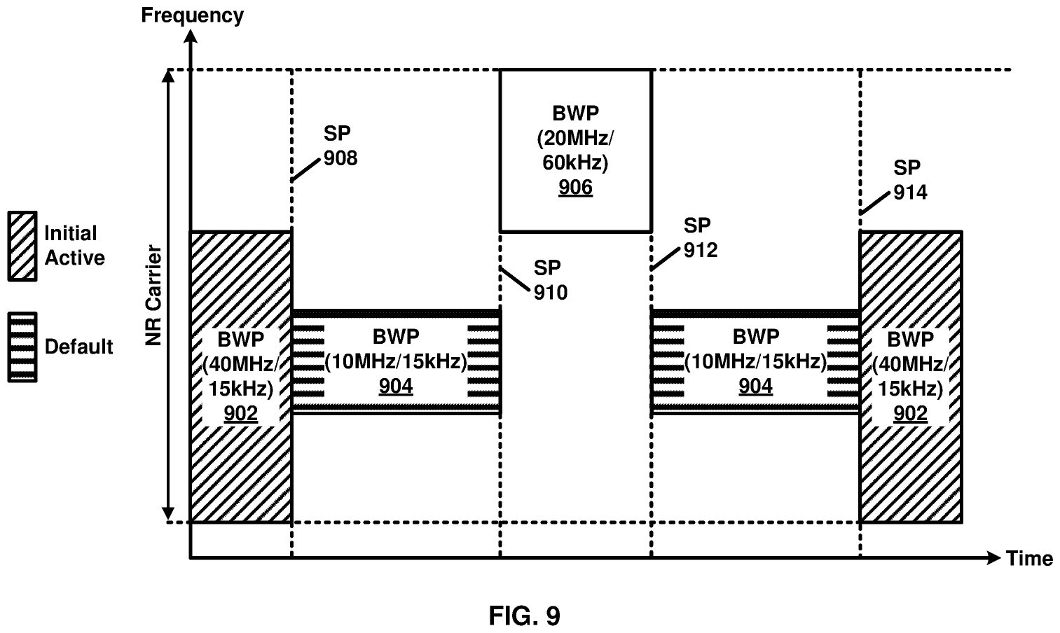

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response receiving a DCI indicating BWP 906 as the active BWP. The UE may switch at a switching point 912 from active BWP 906 to BWP 904 in response to an expiry of a BWP inactivity timer and/or in response receiving a DCI indicating BWP 904 as the active BWP. The UE may switch at a switching point 914 from active BWP 904 to BWP 902 in response receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

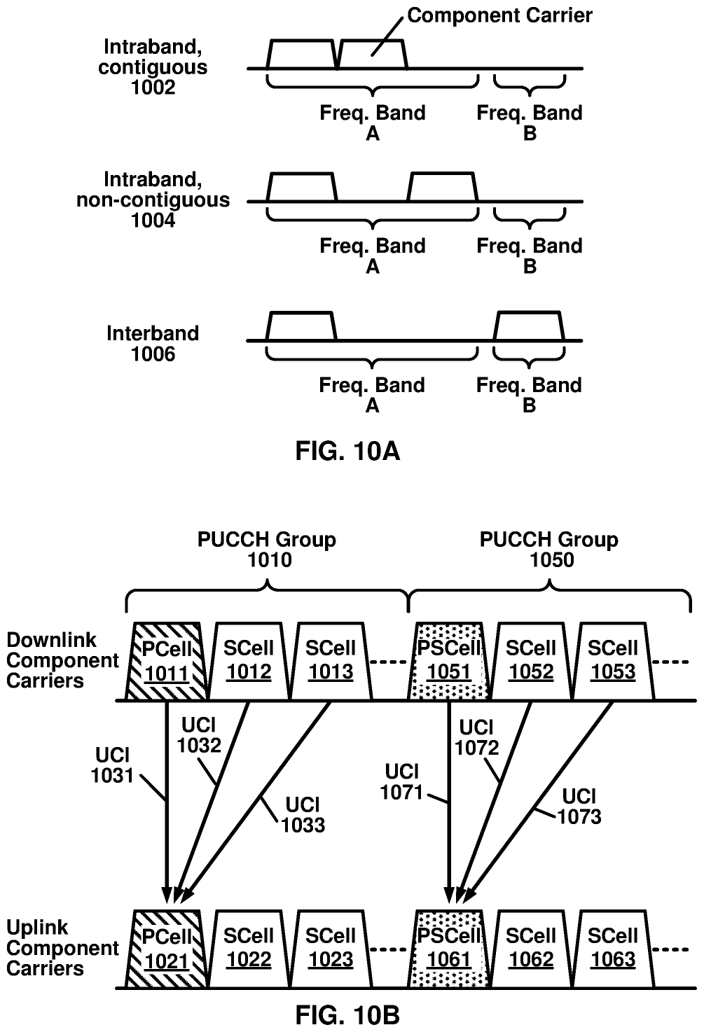

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary Scell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

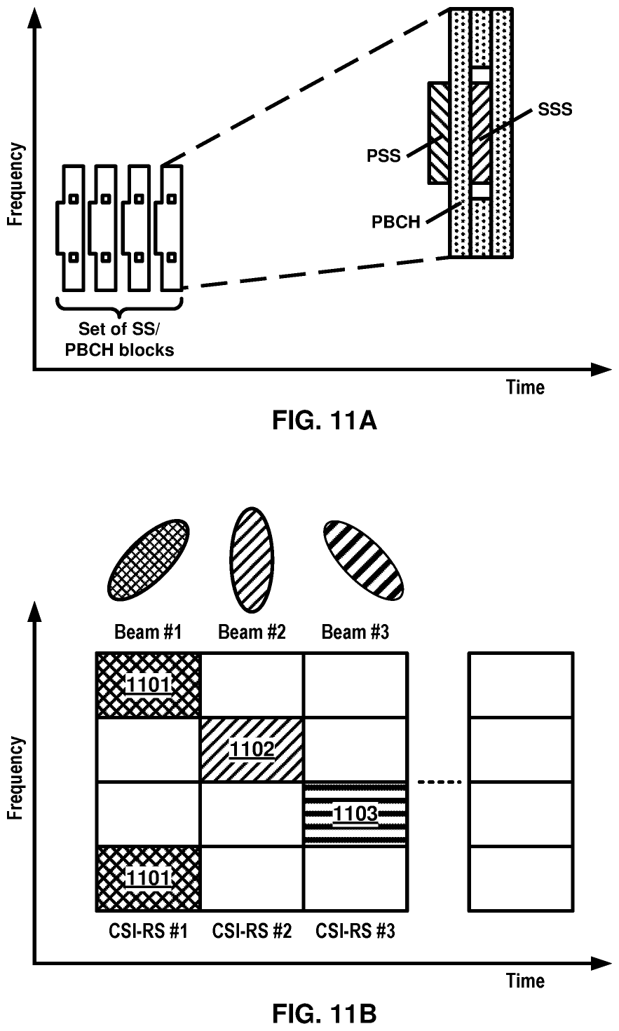

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in a SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (ICI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

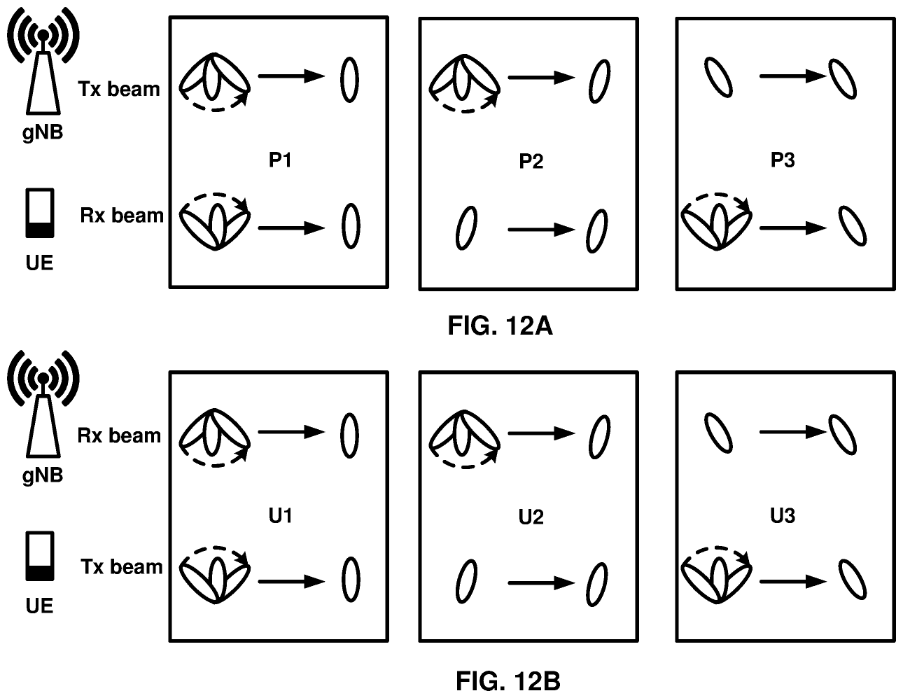

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counter-clockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counter-clockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counter-clockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

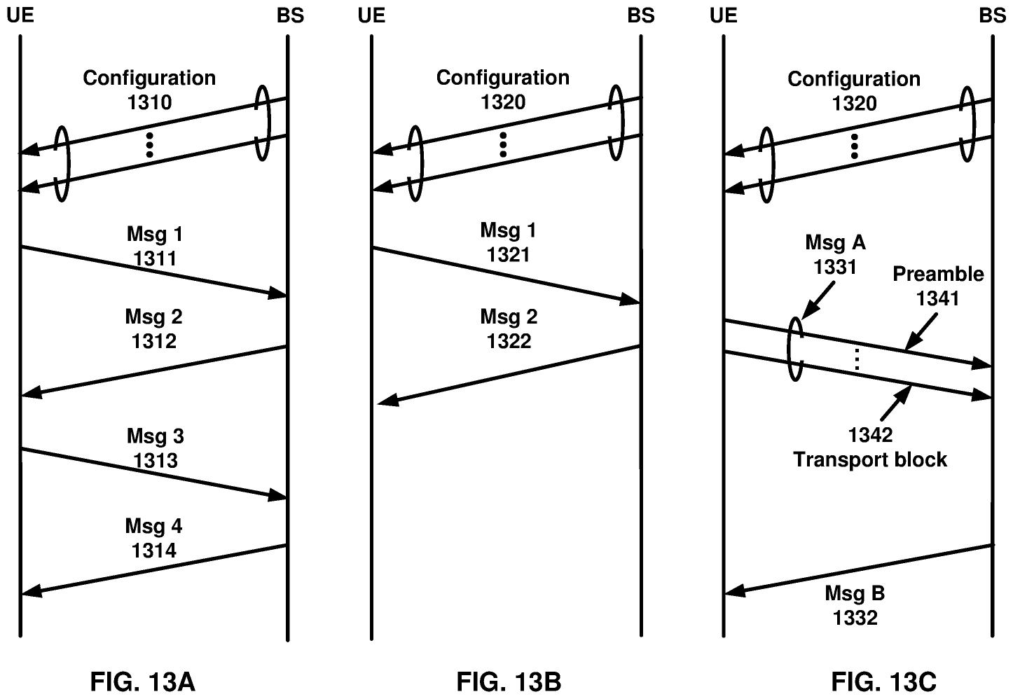

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

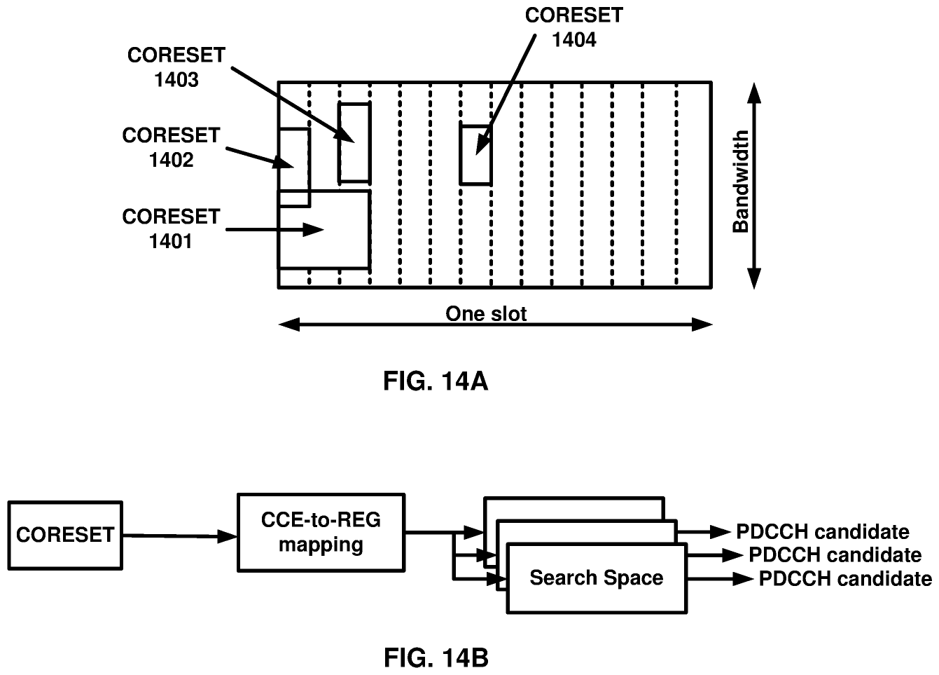

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUCCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

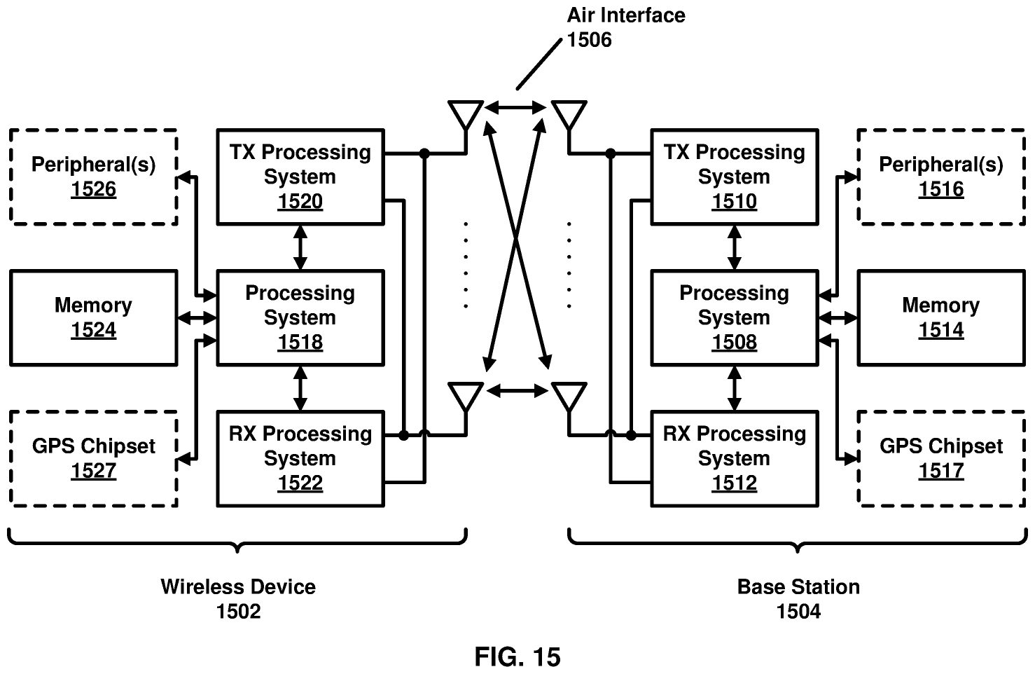

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

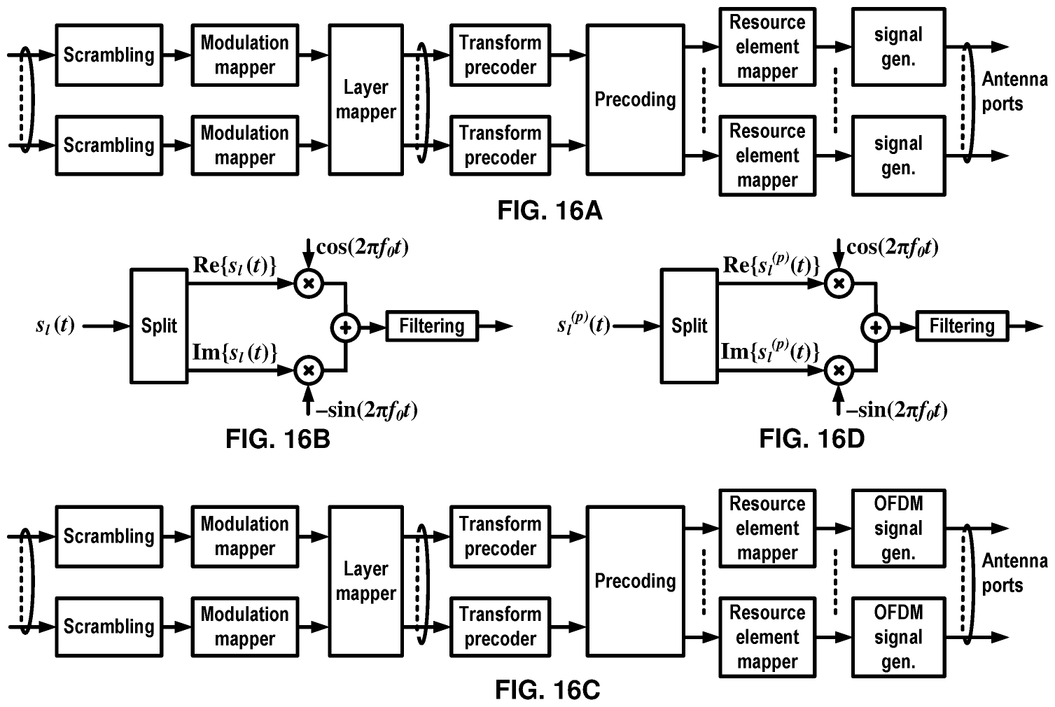

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, an CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual-connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

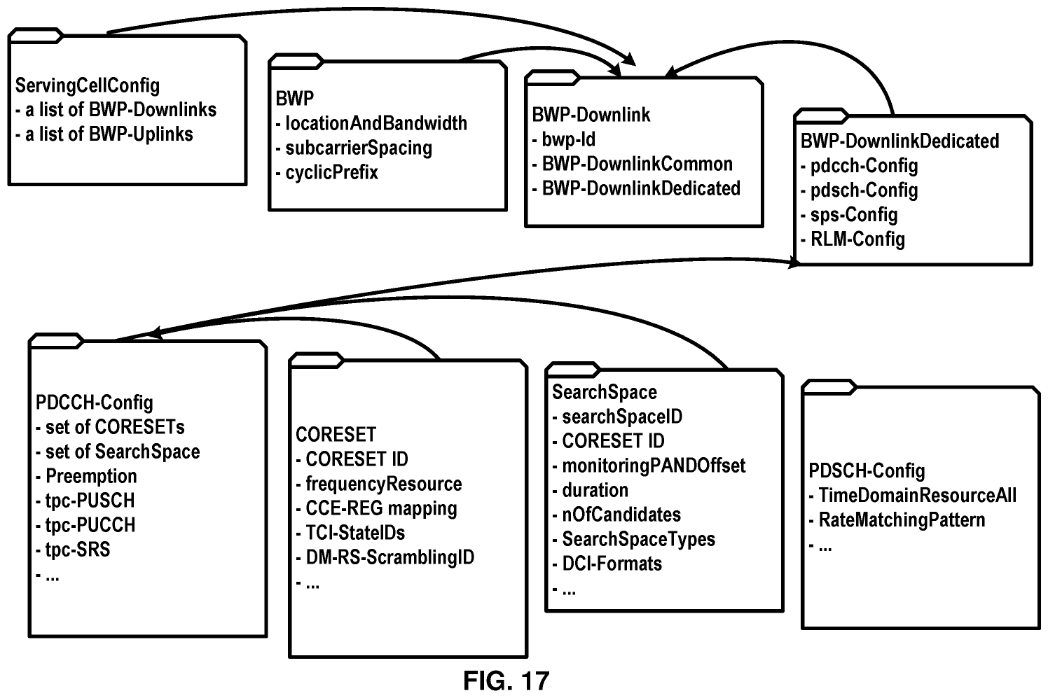

FIG. 17 illustrates example configuration parameters for a wireless device to receive control and/or data from a base station. A wireless device may receive one or more radio resource control (RRC) messages comprising configuration parameters of a cell. The configuration parameters may comprise one or more parameters of a serving cell configuration (e.g., ServingCellConfig). The one or more parameters of the serving cell configuration may comprise one or more downlink bandwidth parts (e.g., a list of BWP-Downlinks). The one or more parameters of the serving cell configuration may comprise one or more uplink bandwidth parts (e.g., a list of BWP-Uplinks). A downlink bandwidth part (e.g., BWP-Downlink) and/or an uplink bandwidth part (e.g., BWP-Uplink) may comprise a bandwidth part index (e.g., bwp-Id), configuration parameters of a cell-common downlink bandwidth part (e.g., BWP-DownlinkCommon), and/or a UE-specific downlink bandwidth part (e.g., BWP-DownlinkDedicated). For example, the bandwidth part index (bwp-Id) may indicate a bandwidth part configuration. For example, an index of the bandwidth part is the bandwidth part index. The bandwidth part configuration may comprise a location and bandwidth information (locationAndBandwidth). The locationAndBandwidth may indicate a starting resource block (RB) of the bandwidth part and a bandwidth of the bandwidth part, based on a reference point (e.g., a pointA of a carrier/cell for the bandwidth part). The bandwidth part configuration may comprise a subcarrier spacing (e.g., subcarrierSpacing) and a cyclic prefix (e.g., cyclicPrefix). For example, the subcarrier spacing may be one of 15 kHz, 30 kHz, 60 kHz, 120 kHz, 240 kHz, 480 kHz, and 960 kHz. For example, the cyclic prefix may be one of a normal cyclic prefix and an extended cyclic prefix.

Configuration parameters of the cell-specific downlink bandwidth (e.g., BWP-DownlinkCommon) may indicate/comprise genericParameters, pdcch-ConfigCommon, and/or pdsch-ConfigCommon. For example, pdcch-ConfigCommon may comprise cell-specific parameters for receiving downlink control information (DCIs) via the cell-specific downlink bandwidth part (e.g., an initial BWP). For example, pdsch-ConfigCommon may comprise cell-specific parameters for receiving PDSCHs of transport blocks (TBs) via the cell-specific downlink bandwidth part. Configuration parameters of the UE-specific downlink bandwidth part (e.g., BWP-DownlinkDedicated) may comprise pdcch-Config, pdsch-Config, sps-Config, and/or radioLinkMonitoringConfig (e.g., RLM-Config). The configuration parameters may comprise sps-ConfigList and/or beamFailureRecoverySCellConfig. For example, beamFailureRecoverySCellConfig may comprise reference signal parameters for beam failure recovery for secondary cells. For example, pdcch-Config may comprise parameters for receiving DCIs for the UE-specific downlink bandwidth part. For example, pdsch-Config may comprise parameters for receiving PDSCHs of TBs for the UE-specific downlink bandwidth part. For example, sps-Config may comprise parameters for receiving semi-persistent scheduling PDSCHs. The base station may configure a SPS for a BWP or a list of SPS for the BWP. For example, radioLinkMonitoringConfig may comprise parameters for radio link monitoring.

Configuration parameters of pdcch-Config may indicate/comprise at least one of a set of coresets, a set of search spaces, a downlink preemption (e.g., downlinkPreemption), a transmission power control (TPC) for PUSCH (e.g. tpc-PUSCH), a TPC for PUCCH and/or a TPC for SRS. The configuration parameters may comprise a list of search space switching groups (e.g., searchsSpaceSwitchingGroup), a search space switching timer (e.g., searchSpaceSwitchingTimer), an uplink cancellation, and/or a monitoring capability configuration (e.g., monitoringCapabilityConfig). The base station may configure the list of search space switching groups, where the wireless device may switch from a first search space group to a second search space group based on the search space switching timer or a rule, an indication, or an event. The base station may configure up to K (e.g., K=3) coresets for a BWP of a cell. The downlink preemption may indicate whether to monitor for a downlink preemption indication for the cell. The monitoring capability config may indicate whether a monitoring capability of the wireless device would be configured for the cell, where the capability is based on a basic capability or an advanced capability. The base station may configure up to M (e.g., M=10) search spaces for the BWP of the cell. The tpc-PUCCH, tpc-PUSCH, or tpc-SRS may enable and/or configure reception of TPC commands for PUCCH, PUSCH or SRS respectively. The uplink cancellation may indicate to monitor uplink cancellation for the cell.

Configuration parameters of pdcch-ConfigCommon may comprise a control resource set zero (e.g., controlResourceSetZero), a common control resource set (e.g., commonControlResourceSet), a search space zero (e.g., searchSpaceZero), a list of common search space (e.g., commonSearchSpaceList), a search space for SIB1 (e.g., searchSpaceSIB1), a search space for other SIBs (e.g., searchSpaceOtherSystemInformation), a search space for paging (e.g., pagingSearchSpace), a search space for random access (e.g., ra-SearchSpace), and/or a first PDCCH monitoring occasion. The control resource set zero may comprise parameters for a first coreset with an index value zero. The coreset zero may be configured for an initial bandwidth part of the cell. The wireless device may use the control resource set zero in a BWP of the cell, wherein the BWP is not the initial BWP of the cell based on one or more conditions. For example, a numerology of the BWP may be same as the numerology of the initial BWP. For example, the BWP may comprise the initial BWP. For example, the BWP may comprise the control resource set zero. The common control resource set may be an additional common coreset that may be used for a common search space (CSS) or a UE-specific search space (USS). The base station may configure a bandwidth of the common control resource set where the bandwidth is smaller than or equal to a bandwidth of the control resource set zero. The base station may configure the common control resource set such that it is contained within the control resource set zero (e.g., CORESET #0). The list of common search space may comprise one or more CSSs. The list of common search space may not comprise a search space with index zero (e.g., SS #0). The first PDCCH monitoring occasion may indicate monitoring occasion for paging occasion. The base station may configure a search space for monitoring DCIs for paging (e.g., pagingSearchSpace), for RAR monitoring (e.g., ra-SearchSpace), for SIB1 (e.g., searchSpaceSIB1) and/or for other SIBs than SIB1 (e.g., searchSpaceOtherSystemInformation). The search space with index zero (e.g., searchSpaceZero, SS #0) may be configured for the initial BWP of the cell. Similar to the coreset/CORESET #0, the SS #0 may be used in the BWP of the cell based on the one or more conditions.

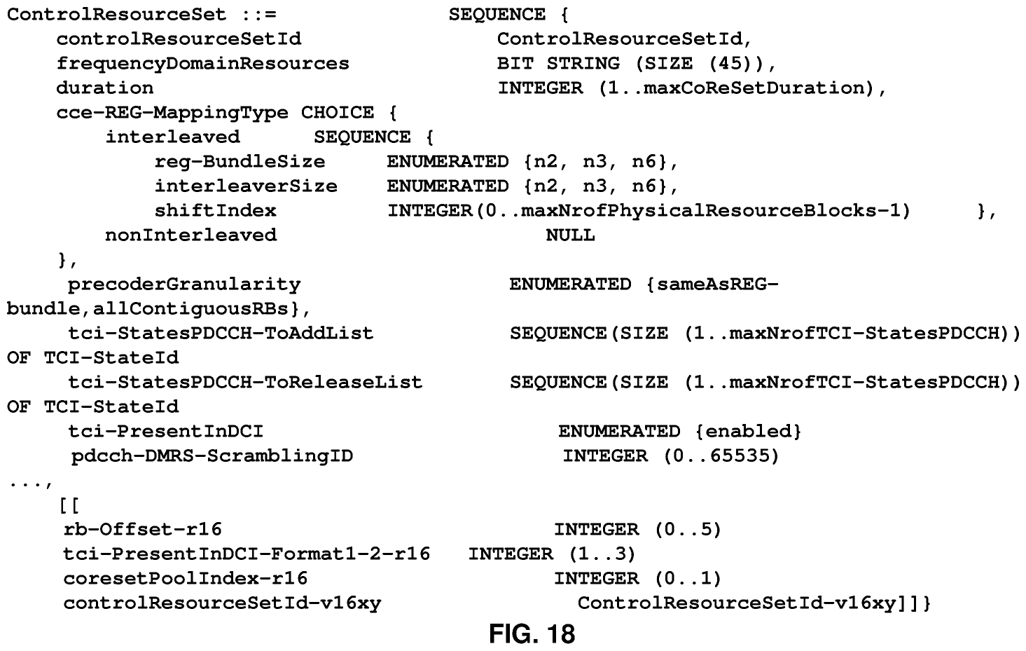

FIG. 18 illustrates configuration parameters of a coreset. A ControlResourceSet (coreset) may comprise a coreset index (e.g., ControlResourceSetId), frequency domain resources (e.g., frequencyDomainResources), a duration of the coreset (e.g., a number of OFDM symbols between [1, maxCoReSetDuration], where maxCoReSetDuration=3) and a control channel element (CCE) to resource element group (REG) mapping type (e.g., between interleaved and nonInterleaved). When the CCE-REG mapping type is configured as interleaved, the base station may also configure a bundle size of REG (e.g., reg-BundleSize) and an interleaver size (e.g., interleaverSize). The coreset may also comprise a precoder granularity (e.g., between same as REG bundle (e.g., sameAsREG-bundle) and across all contiguous RBs (e.g., allContiguousRBs)). For example, when the precoder granularity is configured as ‘same as REG bundle’, the wireless device may assume that a same precoder is used across REGs in a bundle. For example, when the precoder granularity is configured as ‘across all contiguous RBs’, the wireless device may assume that a same precoder is used across RBs in contiguous RBs of the coreset. The coreset may comprise a list of TCI states, wherein the coreset is not a coreset #0. The coreset may comprise a parameter of a TCI presence in DCI. The wireless device may expect a DCI format comprises a TCI indication in a DCI based on the DCI format scheduled via a search space associated with the coreset if the coreset is configured with the TCI presence in DCI. For example, the DCI format may be a DCI format 1_1 and/or a DCI format 0_1. The coreset may optionally comprise one or more of a DMRS scrambling identity, a coreset pool index, an enhanced coreset index (e.g., ControlResourceSetId-v16xy), a TCI present in DCI for a DCI format 1_2, and an RB offset. For example, when the enhanced coreset index is present in the coreset configuration, the wireless device may ignore the coreset index. The enhanced coreset index may indicate a value between [0, . . . , 15] whereas the coreset index may indicate a value between [0, . . . , 11].

A coreset may be associated with a search space. For example, the wireless device may determine search space candidates and/or monitoring occasions of the search space based on configuration of the associated search space and the coreset. A search space is associated with a coreset. For example, the wireless device may determine search space candidates and/or monitoring occasions of the search space based on configuration of the search space and the associated coreset. Parameters of the search space may comprise an index of the coreset when the search space is associated with the coreset or the coreset is associated with the search space.

A search space may comprise an index of the search space (e.g., searchSpaceId), an index for associated coreset (e.g., controlResourceSetId), a monitoring periodicity and offset (e.g., periodicity in terms of a number of slots and an offset in terms of a number of slots, between [1, 2560] slots for periodicity, an offset between [0, . . . , P−1] where the P is the periodicity). The search space may comprise a duration, wherein the wireless device may monitor the search space in a consecutive slots starting from the monitoring occasion based on the duration. The base station may not configure the duration for a search space scheduling a DCI format 2_0. A maximum duration value may be the periodicity−1 (e.g., repeated in each slot within an interval/periodicity). The search space may comprise a monitoring symbols within a slot (e.g., a bitmap of size of OFDM symbols in a slot (e.g., 12 for extended cyclic prefix (CP), 14 for normal CP)). The search space may comprise a set of a number of candidates of each aggregation level (e.g., a first candidate number for an aggregation level L=1, a second candidate number of an aggregation level L=2, and so on). The search space may comprise a search space type (e.g., between CSS and USS). Each CSS or USS may comprise one or more DCI formats monitored in the search space. For example, for CSS, one or more of a DCI format 0_0/1_0, a DCI format 2_0, a DCI format 2_1, a DCI format 2_2 and a DCI format 2_3 may be configured. For USS, the base station may configure a list of search space group index (if configured). For USS, the base station may configure a frequency monitoring occasion/location for a wideband operation of unlicensed spectrum or licensed spectrum. In the specification, DCI format 0_0/1_0 may be interchangeably used with DCI format 0-0/1-0 or fallback DCI format. DCI format 0_1/1_1 may be interchangeably used with DCI format 0-1/1-1 or non-fallback DCI format. DCI format 0_2/1_2 may be interchangeably used with DCI format 0-2/1-2 or non-fallback DCI format.

Configuration parameters of the pdsch-Config may comprise parameters for receiving transport blocks. For example, the configuration parameters may comprise a data scrambling identify for PDSCH, a DM-RS mapping type (e.g., between mapping type A and mapping type B), a list of transmission configuration indicator (TCI) states, a parameter of (virtual RB) VRB-to-(physical RB) PRB interleaves, resource allocation type (e.g., resource allocation type 0, resource allocation type 1 or a dynamic switch between two), a list of time domain allocation, a aggregation factor, a list of rate matching patterns, a RBG (resource block group) size, a MCS table (e.g., between QAM 256 and a QAM64LowSE, between high MCSs or low MCSs), a maximum codeword (e.g., between 1 or 2), parameter(s) related to a PRB bundling, maximum MIMO layer, a minimum scheduling offset related to a power saving technique, and/or one or more parameters related to a DCI format 1_2 (e.g., a compact DCI or small sized DCI format).

In an example, the base station may configure a coreset with a plurality of TCI states. The base station may indicate a TCI of the plurality of TCI states for the coreset as an active TCI state via a MAC CE command or a DCI command. For example, a MAC CE may comprise a serving cell index, a coreset index, and a TCI state index. For example, a serving cell index (e.g., Serving Cell ID) may indicate an index of a serving cell, where the MAC CE applies. A coreset index (e.g., CORESET ID) may indicate a index of a coreset where the MAC CE applies. A TCI state index (e.g., TCI State ID) may indicate a TCI state identified by TCI-StateId. For example, when the coreset is CORESET #0, the TCI state ID may indicate one TCI state of first 64 TCI states configured for pdsch-Config of a BWP of the serving cell. The BWP of the serving cell may be an active BWP of the cell. When the coreset is not the CORESET #0 (e.g., CORESET ID is not zero), the TCI state ID may indicate a TCI state of the plurality of TCI states configured for the coreset in pdcch-Config.

In an example, a base station and a wireless device may use a plurality of downlink control information (DCI) formats to communicate control information to schedule downlink data and/or uplink data and/or to deliver control information. For example, a DCI format 0_0 may be used to schedule an uplink resource for a PUSCH over a cell. A DCI format 0_1 may be used to schedule one or more PUSCHs in one cell or may be used to indicate downlink feedback information for configured grant PUSCH (CG-DFI). A DCI format 0_2 may be used to schedule a resource for a PUSCH in one cell. Similarly, for downlink scheduling, a DCI format 1_0 may schedule a resource for a PDSCH in one cell. A DCI format 1_1 may be used to schedule a PDSCH in one cell or trigger one shot HARQ-ACK feedback. A DCI format 1_2 may be used to schedule a resource for a PDSCH in one cell. There are one or more DCI formats carrying non-scheduling information. For example, a DCI format 2_0 may be used to indicate a slot formation information for one or more slots of one or more cells. A DCI format 2_2 may be used to indicate one or more transmit power control commands for PUCCH and PUSCH. A DCI format 2_3 may be used to indicate one or more transmit power control for SRS. A DCI format 2_4 may be used to indicate an uplink cancellation information. A DCI format 2_5 may be used to indicate a preemption information. A DCI format 2_6 may be used to indicate a power saving state outside of DRX active time. A DCI format 3_0 or 3_1 may be used to schedule NR sidelink resource or LTE sidelink resource in one cell.

In an example, a DCI format 0_0 and a DCI format 1_0 may be referred as a fallback DCI format for scheduling uplink and downlink respectively. In an example, a DCI format 0_1 and a DCI format 1_1 may be referred as a non-fallback DCI format scheduling uplink and downlink respectively. In an example, a DCI format 0_2 and a DCI format 1_2 may be referred as a compact DCI format for scheduling uplink and downlink respectively. A base station may configure one or more DCI formats for scheduling downlink and/or uplink resources. For example, a DCI format 0_0, 0_1 and 0_2 may be used to schedule uplink resource(s) for one or more PUSCHs. A DCI format 1_0, 1_1 and 1_2 may be used to schedule downlink resource(s) for one or more PDSCHs. A DCI format 2_0, 2_1, 2_2, 2_3, 2_4, 2_5 and 2_6 may be used for a group-common DCI transmission. Each format of DCI format 2_x may be used for different information. For example, the DCI format 2_4 may be used to indicate uplink resources for a group of wireless devices. In response to receiving a DCI based on the DCI format 2_4, a wireless device may cancel any uplink resource, scheduled prior to the receiving, when the uplink resource may be overlapped with the indicated uplink resources.

A DCI format may comprise one or more DCI fields. A DCI field may have a DCI size. A wireless device may determine one or more bitfield sizes of one or more DCI fields of the DCI format based on one or more radio resource control (RRC) configuration parameters by a base station. For example, the one or more RRC configuration parameters may be transmitted via master information block (MIB). For example, the one or more RRC configuration parameters may be transmitted via system information blocks (SIBs). For example, the one or more RRC configuration parameters may be transmitted via one or more a wireless device specific messages. For example, the wireless device may determine one or more DCI sizes of one or more DCI fields of a DCI format 0_0 based on the one or more RRC configuration parameters transmitted via the MIB and/or the SIBs. The wireless device may be able to determine the one or more DCI sizes of the DCI format 0_0 without receiving any the wireless device specific message. Similarly, the wireless device may determine one or more DCI sizes of one or more second DCI fields of a DCI format 1_0 based on the one or more RRC configuration parameters transmitted via the MIB and/or the SIBs.

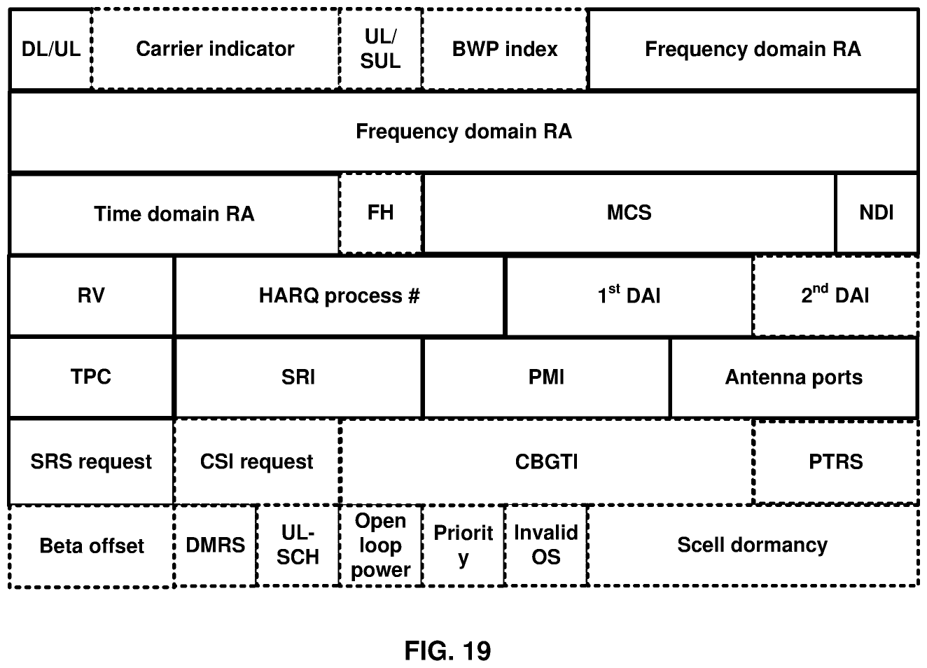

For example, the wireless device may determine one or more first DCI sizes of one or more first DCI fields of a DCI format 0_2 based on one or more RRC configuration parameters transmitted via the MIB and/or the SIBs and/or the wireless device specific RRC message(s). The wireless device may determine one or more bitfield sizes of the one or more first DCI fields based on the one or more RRC configuration parameters. For example, FIG. 19 may illustrate the one or more first DCI fields of the DCI format 0_2. In FIG. 19, there are one or more second DCI fields that may present in the DCI format 0_2 regardless of the wireless device specific RRC message(s). For example, the one or more second DCI fields may comprise at least one of DL/UL indicator, frequency domain resource allocation, MCS, NDI, and TPC fields. For example, the one or more first DCI fields may comprise the one or more second DCI fields and one or more third DCI fields. A DCI field of the one or more third DCI fields may be present or may not be present based on one or more configuration parameters transmitted by the base station. For example, the one or more third DCI fields may comprise at least one of a BWP index, RV, HARQ process #, PMI, antenna ports, and/or beta offset.

For example, the DCI format 0_2 may comprise a 1-bit DL/UL indicator where the bit is configured with zero (‘0’) to indicate an uplink grant for the DCI format 0_2. DCI field(s) shown in dotted boxes may not be present or a size of the DCI field(s) may be configured as zero. For example, a carrier indicator may be present when the DCI format 0_2 is used to schedule a cell based on cross-carrier scheduling. The carrier indicator may indicate a cell index of a scheduled cell by the cross-carrier scheduling. For example, UL/SUL indicator (shown UL/SUL in FIG. 19) may indicate whether a DCI based on the DCI format 0_2 schedules a resource for an uplink carrier or a supplemental uplink. The UL/SUL indicator field may be present when the wireless device is configured with a supplemental uplink for a scheduled cell of the DCI. Otherwise, the UL/SUL indicator field is not present.

A field of BWP index may indicate a bandwidth part indicator. The base station may transmit configuration parameters indicating one or more uplink BWPs for the scheduled cell. The wireless device may determine a bit size of the field of BWP index based on a number of the one or more uplink BWPs. For example, 1 bit may be used. The number of the one or more uplink BWPs (excluding an initial UL BWP) is two. The field of BWP index may be used to indicate an uplink BWP switching. The wireless device may switch to a first BWP in response to receiving the DCI indicating an index of the first BWP. The first BWP is different from an active uplink BWP (active before receiving the DCI).

A DCI field of frequency domain resource allocation (frequency domain RA in FIG. 19) may indicate uplink resource(s) of the scheduled cell. For example, the base station may transmit configuration parameters indicating a resource allocation type 0. With the resource allocation type 0, a bitmap over one or more resource block groups (RBGs) may schedule the uplink resource(s). With a resource allocation type 1, a starting PRB index and a length of the scheduled uplink resource(s) may be indicated. In an example, a length may be a multiple of K1 resource blocks. For example, the configuration parameters may comprise a resource allocation type1 granularity for the DCI format 0_2 (e.g., K1). A default value of the K1 may be one (‘1’). The base station may transmit configuration parameters indicating a dynamic change between the resource allocation type 0 and the resource allocation type 1 (e.g., ‘dynamicswitch’). The wireless device may determine a field size of the frequency domain RA field based on the configured resource allocation type and a bandwidth of an active UL BWP of the scheduled cell. The wireless device may further determine the field size of the frequency domain RA field based on the K1 value, when the resource allocation type 1 may be used/configured. For example, when the resource allocation type 0 is configured, the bitmap may indicate each of the one or more RBGs covering the bandwidth of the active UL BWP. A size of the bitmap may be determined based on a number of the one or more RBGs of the active UL BWP. For example, the wireless device may determine the size of the frequency domain RA field based on the resource allocation type 1 based on the bandwidth of the active uplink BWP (e.g., ceil (log 2(BW/K1(BW/K1+1)/2) and the resource allocation type1 granularity. E.g., the BW is the bandwidth of the active uplink BWP. E.g., the K1 is the resource allocation type1 granularity.).

The wireless device may determine a resource allocation indicator value (RIV) table, where an entry of the table may comprise a starting PRB index and a length value. The wireless device may determine the RIV table based on the resource allocation type1 granularity. For example, when the dynamic change between the resource allocation type 0 and the resource allocation type 1 is used, a larger size between a first size based on the resource allocation type 0 (e.g., the bitmap size) and a second size based on the resource allocation type 1 (e.g., the RIV table size) with additional 1 bit indication to indicate either the resource allocation type 0 or the resource allocation type 1. For example, the frequency domain RA field may indicate a frequency hopping offset. The base station may use K (e.g., 1 bit for two offset values, 2 bits for up to four offset values) bit(s) to indicate the frequency hopping offset from one or more configured offset values, based on the resource allocation type 1. The base station may use ceil(log 2(BW/K1(BW/K1+1)/2)−K bits to indicate the uplink resource(s) based on the resource allocation type 1, when frequency hopping is enabled. Otherwise, the base station/wireless device may use ceil(log 2(BW/K1(BW/K1+1)/2) bits to indicate the uplink resource(s) based on the resource allocation type 1.

In an example, a base station may transmit one or more messages comprising configuration parameters of a BWP of a cell. The configuration parameters may indicate/comprise a resource allocation type for one or more PUSCHs scheduled by one or more DCIs, based on a first RNTI. The resource allocation type may be a resource allocation type 0 or a resource allocation type 1 or a dynamic switching between the resource allocation type 0 and the resource allocation type 1. For example, the first RNTI is a C-RNTI. The configuration parameters may indicate/comprise a configured grant configuration or a SPS configuration. The configuration parameters may indicate a resource allocation type for the configured grant configuration or the SPS configuration. The resource allocation type may be a resource allocation type 0 or a resource allocation type 1 or a dynamic switching between the resource allocation type 0 and the resource allocation type 1.

A DCI field of time domain resource allocation (time domain RA shown in FIG. 19) may indicate time domain resource of one or more slots of the scheduled cell. The base station may transmit configuration parameters indicating one or more time domain resource allocation lists of a time domain resource allocation table for an uplink BWP of the scheduled cell. The wireless device may determine a bit size of the time domain RA field based on a number of the one or more time domain resource allocation lists of the time domain resource allocation table. The base station may indicate a frequency hopping flag by a FH flag (shown as FH in FIG. 19). For example, the FH flag may present when the base station may enable a frequency hopping of the scheduled cell or the active UL BWP of the scheduled cell. A DCI field of modulation and coding scheme (MCS) (shown as MCS in FIG. 19) may indicate a coding rate and a modulation scheme for the scheduled uplink data. In an example, a bit size of the MCS field may be predetermined as a constant (e.g., 5 bits). A new data indicator (NDI) field may indicate whether the DCI schedules the uplink resource(s) for a new/initial transmission or a retransmission. A bit size of the NDI may be fixed as a constant value (e.g., 1 bit). A redundancy version (RV) field may indicate one or more RV values (e.g., a RV value may be 0, 2, 3, or 1) for one or more PUSCHs scheduled over the one or more slots of the scheduled cells. For example, the DCI may schedule a single PUSCH via one slot, a RV value is indicated. For example, the DCI may schedule two PUSCHs via two slots, two RV values may be indicated. A number of PUSCHs scheduled by a DCI may be indicated in a time domain resource allocation list of the one or more time domain resource allocation lists. The configuration parameters may indicate/comprise a bit size of the RV field. For example, the bit size may be 0, 1 or 2 bits for a single PUSCH. When the bit size is configured as zero (‘0’), the wireless device may apply a RV=0 for any uplink resource scheduled by a DCI based on the DCI format 0_2.

A DCI field of hybrid automatic repeat request (HARQ) process number (HARQ process #in FIG. 19) may indicate an index of a HARQ process used for the one or more PUSCHs. The wireless device may determine one or more HARQ processes for the one or more PUSCHs based on the index of the HARQ process. The wireless device may determine the index for a first HARQ process of a first PUSCH of the one or more PUSCHs and select a next index as a second HARQ process of a second PUSCH of the one or more PUSCHs and so on. The configuration parameters may indicate/comprise a bit size for the HARQ process #field. For example, the bit size may be 0, 1, 2, 3 or 4 bits for a single PUSCH. The wireless device may assume that a HARQ process index=0 in case the bit size is configured as zero. The wireless device may assume that a HARQ process index in a range of [0, 1] when the bit size is configured as one. The wireless device may assume that a HARQ process index in a range of [0, . . . , 3] when the bit size is configured as two. The wireless device may assume that a HARQ process index in a range of [0, . . . , 7] when the bit size is configured as three. For the 4 bits of bit size, the wireless device may use a HARQ process in a range of [0, . . . , 15].

The DCI format 0_2 may have a first downlink assignment index (1st DAI) and/or a second DAI (2nd DAI). The configuration parameters may indicate/comprise a parameter to indicate whether to use DAI for the DCI format 0_2 (e.g., DownlinkassignmentIndex-ForDCIFormat0_2). The first DAI may be used to indicate a first size of bits of first HARQ-ACK codebook group. The second DAI may be present when the base station may transmit configuration parameters indicating a plurality of HARQ-ACK codebook groups. When there is no HARQ-ACK codebook group configured, the wireless device may assume the first HARQ-ACK codebook group only. The second DAI may indicate a second size of bits of second HARQ-ACK codebook group. The first DAI may be 1 bit when a semi-static HARQ-ACK codebook generation mechanism is used. The first DAI may be 2 bits or 4 bits when a dynamic HARQ-ACK codebook generation mechanism is used.

A field of transmission power control (TPC shown in FIG. 19) may indicate a power offset value to adjust transmission power of the one or more scheduled PUSCHs. A field of sounding reference signal (SRS) resource indicator (SRI) may indicate an index of one or more configured SRS resources of an SRS resource set. A field of precoding information and number of layers (shown as PMI in FIG. 19) may indicate a precoding and a MIMO layer information for the one or more scheduled PUSCHs. A field of antenna ports may indicate DMRS pattern(s) for the one or more scheduled PUSCHs. A field of SRS request may indicate to trigger a SRS transmission of a SRS resource or skip SRS transmission. A field of CSI request may indicate to trigger a CSI feedback based on a CSI-RS configuration or skip CSI feedback. A field of phase tracking reference signal (PTRS)-demodulation reference signal (DMRS) association (shown as PTRS in FIG. 19) may indicate an association between one or more ports of PTRS and one or more ports of DM-RS. The one or more ports may be indicated in the field of antenna ports. A field of beta_offset indicator (beta offset in FIG. 19) may indicate a code rate for transmission of uplink control information (UCI) via a PUSCH of the one or more scheduled PUSCHs. A field of DM-RS sequence initialization (shown as DMRS in FIG. 19) may present based on a configuration of transform precoding. A field of UL-SCH indicator (UL-SCH) may indicate whether a UCI may be transmitted via a PUSCH of the one or more scheduled PUSCHs or not. A field of open loop power control parameter set indication (open loop power in FIG. 19) may indicate a set of power control configuration parameters. The wireless device is configured with one or more sets of power control configuration parameters. A field of priority indicator (priority) may indicate a priority value of the one or more scheduled PUSCHs. A field of invalid symbol pattern indicator (invalid OS) may indicate one or more unavailable/not-available OFDM symbols to be used for the one or more scheduled PUSCHs.

Note that additional DCI field(s), although not shown in FIG. 19, may be present for the DCI format 0_2. For example, a downlink feedback information (DFI) field indicating for one or more configured grant resources may present for an unlicensed/shared spectrum cell. For example, the unlicensed/shared spectrum cell is a scheduled cell. When the DCI format 0_2 is used for indicating downlink feedback information for the one or more configured grant resources, other DCI fields may be used to indicate a HARQ-ACK bitmap for the one or more configured grant resources and TPC commands for a scheduled PUSCH. Remaining bits may be reserved and filled with zeros (‘0’s).

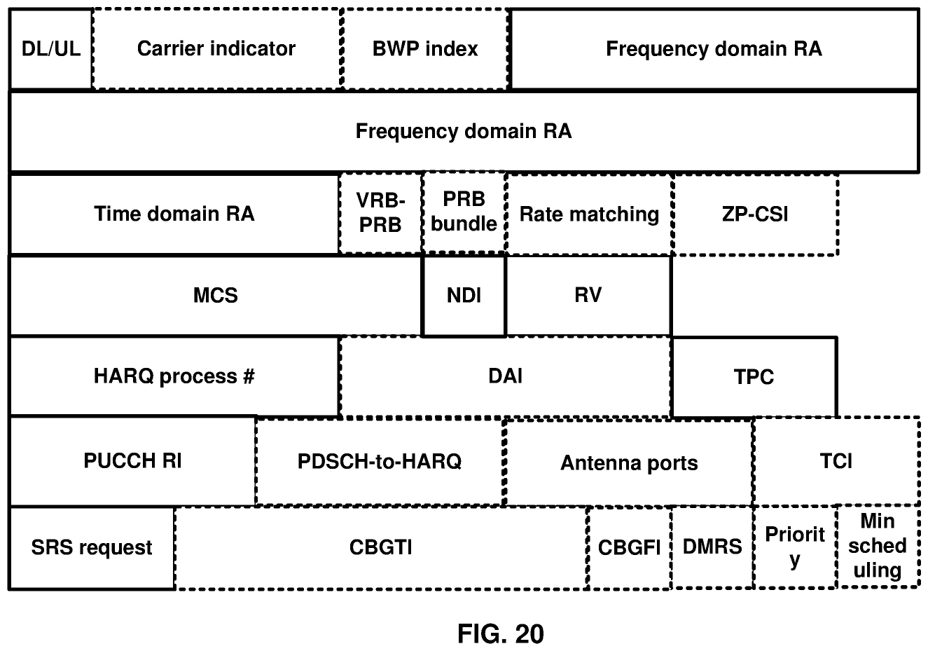

FIG. 20 shows an example of a DCI format 1_2. The DCI format 1_2 may schedule a downlink resource for a scheduled downlink cell. The DCI format 1_2 may comprise one or more DCI fields such as an identifier for DCI formats (DL/UL), a carrier indicator, bandwidth part indicator (BWP index), a frequency domain resource assignment (frequency domain RA), a time domain resource assignment (time domain RA), a virtual resource block to physical resource block mapping (VRB-PRB), Physical resource block (PRB) bundling size indicator (PRB bundle), rate matching indicator (rate matching), zero power CSI-RS (ZP-CSI), a MCS, a NDI, a RV, a HARQ process number, a downlink assignment index (DAI), a TPC command for a PUCCH, a PUCCH resource indicator (PUCCH-RI), a PDSCH-to-HARQ feedback timing indicator (PDSCH-to-HARQ in FIG. 20), an antenna ports, a transmission configuration indication (TCI), a SRS request, DMRS sequence initialization (DMRS), and a priority indicator (priority).

The base station may transmit one or more messages indicating configuration parameters for the DCI format 1_2. Similar to the DCI format 0_2 of FIG. 19, one or more DCI fields shown in dotted lined boxes may be present or may not be present based on the configuration parameters. The configuration parameters may indicate/comprise one or more DCI bit sizes and/or related configuration parameters/values for the one or more DCI fields.

For example, the VRB-PRB field may indicate whether a mapping is based on a virtual RB or a physical RB. For example, the PRB bundle may indicate a size of PRB bundle when a dynamic PRB bundling is enabled. For example, the rate matching may indicate one or more rate matching resources where the scheduled data may be mapped around based on the rate matching. For example, the ZP-CSI field may indicate a number of aperiodic ZP CSI-RS resource sets configured by the base station. For example, the DCI format 1_2 may also include MCS, NDI and RV for a second transport block, in response to a max number of codewords scheduled by DCI may be configured as two. The DCI format 1_2 may not include MCS, NDI and RV field for the second transport block. For example, the DAI field may indicate a size of bits of HARQ-ACK codebook. The TPC field may indicate a power offset for the scheduled PUCCH. The wireless device may transmit the scheduled PUCCH comprising HARQ-ACK bit(s) of the scheduled downlink data by the DCI. The PUCCH-RI may indicate a PUCCH resource of one or more PUCCH resources configured by the base station. The PDSCH-to-HARQ field may indicate a timing offset between an end of a scheduled PDSCH by the DCI and a starting of the scheduled PUCCH. The field of antenna ports may indicate DMRS patterns for the scheduled PDSCH. The TCI field may indicate a TCI code point of one or more active TCI code points/active TCI states. The base station may transmit configuration parameters indicating one or more TCI states for the scheduled cell. The base station may active one or more second TCI states of the one or more TCI states via one or more MAC CEs/DCIs. The wireless device may map an active TCI code point of the one or more active TCI code points to an active TCI of the one or more second TCI states.

In an example, a wireless device may receive a DCI indicating an activation, a release, or a retransmission for one or more configured grant configurations or one or more semi-persistent scheduling configurations. The DCI may be cyclic redundancy check (CRC) scrambled with a first radio network temporary identifier (RNTI). The wireless device may receive a second DCI indicating one or more resources for scheduling downlink and/or uplink data. The second DCI may be CRC scrambled with a second RNTI. For example, the second RNTI may be a cell RNTI (C-RNTI) and/or MCS-C-RNTI. For example, the first RNTI may be configured scheduling RNTI (CS-RNTI) for an uplink configured grant configuration. The first RNTI may be semi-persistent scheduling RNTI (SPS-RNTI). The DCI and the second DCI may be based on a DCI format. For example, the DCI and the second DCI may be based on a DCI format 0_2 for uplink (e.g., uplink grant and/or configured grant (CG)). For example, the DCI and the second DCI may be based on a DCI format 1_2 for downlink (e.g., downlink scheduling and/or semi-persistent scheduling (SPS)).

For example, the wireless device may determine whether the DCI indicates the activation, the release or the retransmission for the one or more CG configurations or for the one or more SPS configurations based on determining one or more values of one or more DCI fields of the DCI format used for the DCI. For example, the wireless device may determine the DCI indicates the activation in response to receiving the DCI with a HARQ process #(HARQ process number) field of the DCI format indicating zero(s) (e.g., ‘0, . . . , 0’) and a RV (redundancy version) field of the DCI indicating zero(s). The wireless device may first determine whether a NDI field of the DCI may indicate a new data or not. In response to receiving the DCI with the NDI field of the new data, the wireless device may further determine the HARQ process number field and the redundancy version field of the DCI. In response to determining the HARQ process number field being set to a predetermined value (e.g., zero(s)) and the redundancy version field being set to a predetermined value (e.g., zero(s)), the wireless device may determine the DCI may indicate the activation or the release of at least one CG configuration or at least one SPS configuration. For example, the wireless device may further check/determine a MCS (modulation and coding scheme) field of the DCI and/or a FDRA (frequency domain resource assignment) field of the DCI to differentiate between the activation and the release. In response to the MCS field being set to a second predetermined value (e.g., one(s), ‘1, . . . , 1’) and the FDRA field being set to a third predetermined value (e.g., zero(s) for resource allocation type 0 or a resource allocation type 2 with mu=1, one(s) for resource allocation type 1 or the resource allocation type 2 with mu=0), the wireless device may determine the DCI indicates the release for the at least one CG configuration or the at least one SPS configuration. In response to the MCS field being set to different value from the second predetermined value and/or the FDRA field being set to the third predetermined value, the wireless device may determine the DCI may indicate the activation for the at least one CG configuration or the at least one SPS configuration.

For example, a DCI format 0_0/0_1/0_2, CRC scrambled with the first RNTI, may be used to indicate an activation, a release and/or retransmission for a configured grant (CG) based on setting one or more DCI fields with one or more predetermined values. For example, a DCI format 1_0/1_2, CRC scrambled with a third RNTI (e.g., SPS-RNTI), may be used to indicate an activation, a release and/or retransmission for a semi-persistent scheduling (SPS) on setting the one or more DCI fields with one or more predetermined values.

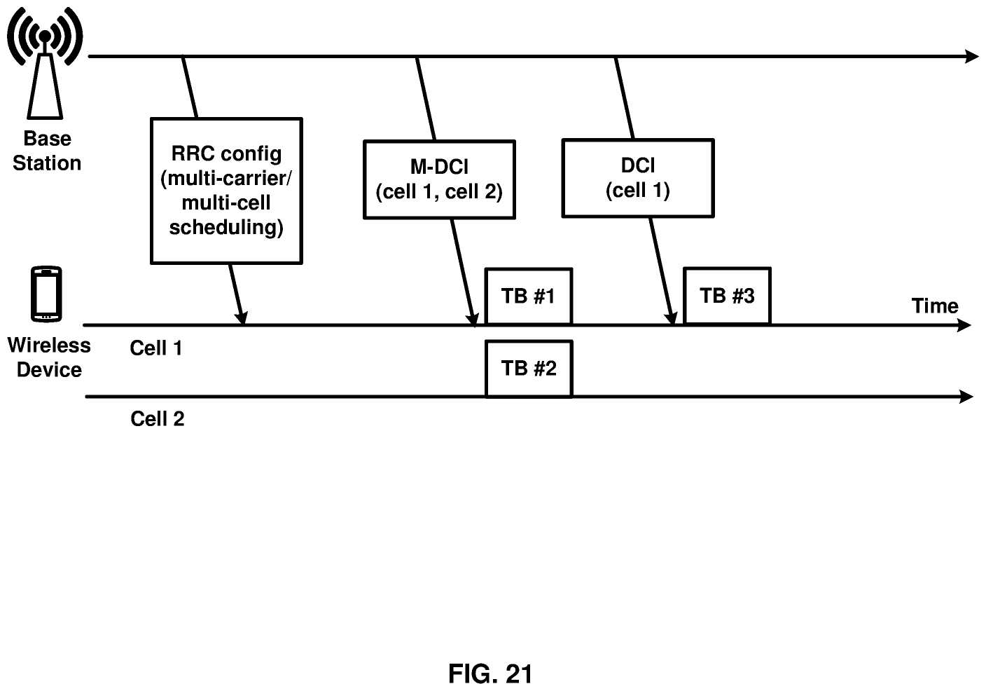

FIG. 21 illustrates an example of embodiments of a multi-carrier or multi-cell scheduling. When a wireless device is configured with a multi-carrier or multi-cell scheduling for a plurality of serving cells of configured serving cells, the wireless device may receive a DCI (e.g., a multi-cell DCI, denoted as M-DCI) that indicates resource assignment(s) and/or CSI/SRS requests for at least one cell of the plurality of serving cells. The DCI may indicate resource assignments for the plurality of serving cells. The DCI may indicate a CSI request for one or more cells of the plurality of serving cells. The DCI may indicate an SRS request for one or more second cells of the plurality of serving cells. The DCI may schedule one or more transport blocks for one or more third cells of the plurality of serving cells. The DCI may schedule downlink data for the plurality of serving cells. The DCI may schedule uplink data for the plurality of serving cells.

Based on the DCI, the wireless device may receive a first transport block (e.g., TB #1) via a first downlink carrier or a first cell (e.g., cell 1). The wireless device may receive a second transport block (e.g., TB #2) via a second downlink carrier or a second cell (e.g., cell 2). When the DCI may schedule uplink data, the wireless device may transmit a first TB via a first uplink carrier and may transmit a second TB via a second uplink carrier based on the DCI. The base station may transmit one or more radio resource control (RRC) messages indicating/comprising configuration parameters for a multi-carrier/multi-cell scheduling. The configuration parameters may comprise/indicate a plurality of serving cells scheduled by a DCI. The configuration parameters may indicate to enable or disable the multi-carrier/multi-cell scheduling. The configuration parameters may indicate a scheduling cell for the multi-carrier/multi-cell scheduling for the plurality of serving cells. For example, FIG. 21 illustrates an example of the configuration parameters indicating a first downlink carrier/cell (e.g. cell 1) and a second downlink carrier/cell (e.g., cell 2). The configuration parameters may indicate/comprise a scheduling cell (e.g., cell 1 in FIG. 21) for the multi-carrier/multi-cell scheduling. For example, the scheduling cell may be same to one cell of the plurality of serving cells. For example, the scheduling cell may be different from any cell of the plurality of serving cells.

For example, the first carrier/cell may be associated with a first transmission and reception point (TRP) or a first coreset pool/group or a first group or a first TCI group. The second carrier/cell may be associated with a second TRP or a second coreset pool/group or a second group or a second TCI group. The first cell may be same to the second cell (e.g., a first physical cell identifier of the first cell may be same as a second physical cell identifier of the second cell). The first cell may be different from the second cell (e.g., a first physical cell identifier of the first cell may be different from a second physical cell identifier of the second cell).

In an example, the configuration parameters may indicate a multi-carrier scheduling or a multi-carrier repetition scheduling. A DCI, based on the multi-carrier repetition scheduling, may comprise resource assignments of a plurality of cells for a number of repetitions of a TB over the plurality of cells. A DCI, based on the multi-carrier scheduling, may comprise resource assignments of a plurality of cells for a plurality of transport blocks (TBs) over the plurality of cells. FIG. 21 shows a first transmission of an RRC signaling for configuring the multi-carrier/cell scheduling to the wireless device. A multi-carrier or a multi-cell DCI (M-DCI) may represent a DCI based on the multi-carrier scheduling or the multi-carrier repetition scheduling. For example, the one or more configuration parameters may comprise one or more control resource set (coreset)s and/or one or more search spaces. The DCI of the multi-carrier scheduling may be transmitted via the one or more coresets and/or the one or more search spaces. The one or more configuration parameters may comprise a RNTI that may be used for the DCI of the multi-carrier scheduling. The RNTI may be different from a C-RNTI.

The base station may transmit one or more MAC CEs/one or more DCIs to activate the multi-carrier scheduling. For example, the one or more MAC CEs may comprise a MAC CE activating and/or deactivating one or more secondary cells. The base station may transmit one or more DCIs. The one or more DCIs may indicate a BWP switching from a first BWP to a second BWP of a cell. The first BWP is an active BWP of the cell. The first BWP may not comprise one or more coresets of the multi-carrier scheduling. The second BWP may comprise one or more second coresets of the multi-carrier scheduling. For example, the one or more MAC CEs may comprise indication(s) of activating and/or deactivating a multi-carrier scheduling of a cell for one or more cells. For example, the one or more DCIs may comprise an indication to activate or deactivate the multi-carrier scheduling of the cell of the one or more cells.

The wireless device may activate the multi-carrier scheduling in response to receiving the one or more RRC messages. The one or more MAC CEs/the one or more DCIs may be optional. The base station may reconfigure to deactivate or activate the multi-carrier scheduling of a cell via RRC signaling. In response to activating the multi-carrier scheduling, the base station may transmit a DCI, based on the multi-carrier scheduling, comprising resource assignments for the first downlink/uplink carrier/cell (e.g., cell 2) and for the second downlink/uplink carrier/cell (e.g., cell 3). FIG. 21 illustrates a second transmission from the base station to the wireless device for the DCI scheduling a first TB for the first cell and a second TB for the second cell. The DCI may be cyclic redundancy check (CRC) scrambled with the RNTI. The DCI may be transmitted via the one or more coresets and/or the one or more search spaces. The DCI may indicate a plurality of downlink/uplink resources for a repetition of the first TB via the first downlink/uplink carrier/cell. The DCI may indicate one downlink/uplink resource for a repetition of the second TB via the second downlink/uplink carrier/cell. The configuration parameters may comprise/indicate a first number of repetition via the first cell. The configuration parameters may comprise/indicate a second number of repetition via the second cell. The base station may transmit the first TB based on the first number of repetitions via the first cell. The base station may transmit the second TB based on the second number of repetitions via the second cell. When a multi-carrier/cell repetition is configured/used, the first TB may be same as the second TB. FIG. 21 illustrates that a box of TB #1 corresponds to a PDSCH. In FIG. 21, the base station transmits a first PDSCH (a fist box via the cell 1) comprising the first TB via the first cell (cell 1) and a second PDSCH (a second box via cell 2) comprising the second TB via the second cell (cell 2). For example, the first PDSCH may transmit a first RV of the first TB with a first HARQ process ID. The second PDSCH may transmit a second RV of the second TB with a second HARQ process ID.

For example, the DCI may comprise a RV field indicating an index of the first RV. For example, the second RV may be determined based on the first RV and one or more configuration parameters. The configuration parameters may comprise/indicate a RV offset. The second RV may be determined as the index of (the first RV+the RV offset) mod K. The K is a number of RVs (e.g., K=4). An index of RV may be determined as an order in the RV sequence. For example, an index of RV 3 is 3, and an index of RV 1 is 4. Similarly, the DCI may comprise a HARQ process ID field indicating an index of the first HARQ process ID. The wireless device may determine the second HARQ process ID based on the first RV and one or more configuration parameters. The configuration parameters may comprise/indicate a HARQ process ID offset or a list of HARQ process IDs of the first cell and the second cell.

For example, the DCI may comprise a first RV field and a second RV field. The wireless device may determine the first RV based on the first RV field. The wireless device may determine the second RV based on the second RV field. The DCI may comprise a plurality of RV fields. A RV field of the plurality of RV fields may correspond to a cell of the plurality of serving cells. For example, the DCI may comprise a RV field for a TB scheduled via a cell of the plurality of serving cells. Similarly, the DCI may comprise a plurality of HARQ process ID fields for the plurality of serving cells. Each HARQ process ID field of the plurality of HARQ process ID fields may correspond to each cell of the plurality of serving cells.

In an example, the DCI may comprise a first NDI bit for the first cell of the plurality of serving cells. The DCI may comprise a second NDI bit for the second cell of the plurality of serving cells. The DCI may comprise a plurality of NDI bits for the plurality of serving cells. Each NDI bit of the plurality of NDI bits may correspond to each cell of the plurality of serving cells. The DCI may comprise a plurality of NDI bits for a cell of the plurality of cells in response to the DCI schedules a multi-slot (e.g., multi-TTI) scheduling. The wireless device may receive, based on the DCI, a plurality of resources of a plurality of slots for one or more transport blocks based on the multi-slot/multi-TTI scheduling.

For example, the DCI may comprise a first frequency domain resource assignment field and a second frequency domain resource assignment field. The first frequency domain resource assignment field may indicate first resource(s) of the first cell/carrier in frequency domain. The second frequency domain resource assignment field may indicate a second resource of the second cell/carrier in frequency domain. For example, the DCI may comprise a first frequency domain resource assignment (RA) field. The first frequency domain RA field may indicate an entry of one or more frequency domain resource allocation lists. The entry may comprise a first field indicating first resource(s) of the first cell/carrier and a second field indicating second resource(s) of the second cell/carrier. An entry of the one or more frequency domain resource allocation lists may comprise a plurality of fields/sub-entries. A field/sub-entry may correspond to an uplink carrier. Embodiments may allow a low overhead DCI signaling while maintaining flexibility in assigning frequency domain resources over a plurality of cells.

For example, the DCI may comprise a first time domain resource assignment field and a second time frequency domain resource assignment field. The first time domain resource assignment field may indicate first resource(s) of the first cell/carrier in time domain. The second time domain resource assignment field may indicate a second resource of the second cell/carrier in time domain. For example, the DCI may comprise a first time domain resource assignment (RA) field. The first time domain RA field may indicate an entry of one or more time domain resource allocation lists. The entry may comprise a first field indicating first resource(s) of the first cell/carrier and a second field indicating second resource(s) of the second cell/carrier. An entry of the one or more time domain resource allocation lists may comprise a plurality of fields/sub-entries. A field/sub-entry may correspond to an uplink carrier. Embodiments may allow a low overhead DCI signaling while maintaining flexibility in assigning time domain resources over a plurality of cells.

In FIG. 21, the base station transmits a third message (DCI) scheduling resource(s) for the first cell (Cell 1). The wireless device may receive one or more M-DCIs scheduling a plurality of resources for a plurality of scheduled cells via a cell. The wireless device may receive one or more DCIs scheduling resource for a scheduled cell via the cell. For example, the plurality of scheduled cells of the one or more M-DCIs may comprise the scheduled cell of the one or more DCIs.

In an example, a physical downlink control channel (PDCCH) may comprise one or more control-channel elements (CCEs). For example, the PDCCH may comprise one CCE that may correspond to an aggregation level (AL)=1. For example, the PDCCH may comprise two CCEs that may correspond to an AL of two (AL=2). For example, the PDCCH may comprise four CCEs that may correspond to an AL of four (AL=4). For example, the PDCCH may comprise eight CCEs that may correspond to an AL of eight (AL=8). For example, the PDCCH may comprise sixteen CCEs that may correspond to an AL of sixteen (AL=16).

In an example, a PDCCH may be carried over one or more control resource sets (coresets). A coreset may comprise N_rb_coreset resource blocks (RBs) in the frequency domain and N_symbol_coreset symbols in the time domain. For example, the N_rb_coreset may be multiple of 6 RBs (e.g., 6, 12, 18, . . . , ). For example, N_symbol_coreset may be 1, 2 or 3. A CCE may comprise M (e.g., M=6) resource-element groups (REGs). For example, one REG may comprise one RB during one OFDM symbol. REGs within the coreset may be ordered/numbered in increasing order in a time-first manner, starting with 0 for a first OFDM symbol and a lowest number (e.g., a lowest frequency) RB in the coreset. The wireless device may increase the numbering in the first OFDM symbol by increasing a frequency location or a RB index. The wireless device may move to a next symbol in response to all RBs of the first symbol may have been indexed. The wireless device may map one or more REG indices for one or more 6 RBs of N_rb_coreset RBs within N_symbol_coreset OFDM symbols of the coreset.

In an example, a wireless device may receive configuration parameters from a base station. The configuration parameters may indicate/comprise one or more coresets. One coreset may be associated with one CCE-to-REG mapping. For example, a single coreset may have a single CCE mapping to physical RBs/resources of the single coreset. For example, a CCE-to-REG of a coreset may be interleaved or non-interleaved. For example, a REG bundle may comprise L consecutive REGs (e.g., iL, iL+1, . . . , iL+L−1). For example, L may be a REG bundle size (e.g., L=2 or 6 for N_symbol_coreset=1 and L=N_symbol_coreset or 6 when N_symbol_coreset is 2 or 3). A index of a REG bundle (e.g., i), may be in a range of [0, 1, . . . N_reg_coreset/L−1]. For example, N_reg_coreset may be defined as N_rb_coreset*N_symbol_coreset (e.g., a total number of REGs in the single coreset). For example, a j-th indexed CCE may comprise one or more REG bundles of {f(6j/L), f(6j/L+1), f(6j/L+6/L−1)}. For example, f(x) may be an interleaver function. In an example, f(x) may be x (e.g., j-th CCE may comprise 6j/L, 6j/L+1, . . . , and 6j/L+6/L−1), when the CCE-to-REG mapping may be non-interleaved. When the CCE-to-REG mapping may be interleaved, L may be defined as one of {2, 6} when N_symbol_coreset is 1 or may be defined as one of {N_symbol_coreset, 6} when N_symbol_coreset is 2 or 3. When the CCE-to-REG mapping may be interleaved, the function f(x) may be defined as (rC+c+n_shift) mod (N_reg_coreset/L), wherein x=cR+r, r=0, 1, . . . , R−1, c=0, 1, . . . , C−1, C=N_reg_coresetl(L*R), and R is one of {2, 3, 6}.

For example, the configuration parameters may indicate/comprise a frequencyDomainResources that may define N_rb_coreset. The configuration parameters may indicate/comprise duration that may define N_symbol_coreset. The configuration parameters may indicate/comprise cce-REG-MappingType that may be selected between interleaved or non-interleaved mapping. The configuration parameters may indicate/comprise reg-BundleSize that may define a value for L for the interleaved mapping. For the non-interleaved mapping, L=6 may be predetermined. The configuration parameters may indicate/comprise shfitIndex that may determine n_shift as one of {0, 1, . . . , 274}. The wireless device may determine/assume a same precoding for REGs within a REG bundle when precorder granularity (e.g., a precoderGranularity indicated/configured by the configuration parameters) is configured as sameAsREG-bundle. The wireless device may determine/assume a same precoding for all REGs within a set of contiguous RBs of a coreset when the precoderGranularity is configured as allContiguousRBs.

For a first coreset (e.g., CORESET #0) may be defined/configured with L=6, R=2, n_shift=cell ID, and precoderGranularity=sameAsREG-bundle.

In an example, a wireless device may be, via RRC signaling, configured with a first cell group comprising one or more serving cells. The wireless device may be, via RRC signaling, configured with a second cell group comprising one or more second serving cells. The wireless device may perform a hybrid automatic repeat request (HARQ) feedback procedure for the first cell group independently from a second HARQ feedback procedure for the second cell group. A cell group may be a master cell group or a secondary cell group. A cell group may be a first PUCCH cell group comprising a primary cell. A cell group may be a second PUCCH cell group not comprising the primary cell. A cell group may comprise one or more serving cells among a plurality of serving cells configured to the wireless device. A cell group may also represent one or more serving cells associated with a first service or a first link (e.g., sidelink, multicast, broadcast, MBSM, D2D, V2X, V2P, V2I, V2N, and/or the like). A cell group may represent one or more second serving cells associated with a second service or a second link (e.g., downlink/uplink, cellular communication, location service, and/or the like). The wireless device may be configured with, via RRC signaling, a first set of PUCCH resources for the first cell group. The wireless device may be configured with, via RRC signaling, a second set of PUCCH resources for the second cell group. The wireless device may determine a first PUCCH for the first cell group based on the HARQ feedback procedure. The wireless device may determine a second PUCCH for the second cell group based on the second HARQ feedback procedure. For example, the first PUCCH and the second PUCCH may overlap in time and/or frequency domain. The wireless device may determine the first PUCCH or the second PUCCH based on a priority of the first PUCCH and a second priority of the second PUCCH. For example, the wireless device may determine the first PUCCH or the second PUCCH based on a priority of the first PUCCH and a threshold for the first PUCCH. A base station may configure the threshold for the first cell group via RRC signaling.

In an example, a wireless device may be provided with a coreset pool index for one or more coresets of an active bandwidth part of a serving cell. The wireless device may determine a coreset pool index of a coreset as zero in response to the coreset pool index has not been provided for the coreset. The coreset pool index may be zero or one. The base station may transmit one or more RRC messages indicating configuration parameters. The configuration parameters may indicate/comprise a ACKNACKFeedbackMode between SeparateFeedback or JointFeedback. For example, when ACKNACKFeedbackMode is indicated as SeparateFeedback, the wireless device may determine first HARQ feedback bits corresponding to a first corset pool index (or coresets of the first coreset pool index). The wireless device may determine second HARQ feedback bits, independently from the first HARQ feedback bits, corresponding to a second corset pool index (or coresets of the second coreset pool index). When ACKNACKFeedbackMode is indicated as JointFeedback, the wireless device may generate/determine HARQ feedback bits for both coreset pool indexes jointly. When ACKNACKFeedbackMode is indicated as SeparateFeedback, the wireless device may perform a first HARQ feedback process for the first coreset pool independently from a second HARQ feedback process for the second coreset pool.

In an example, a wireless device may determine a priority index of a PUSCH or a PUCCH transmission. For example, the wireless device may determine the priority index of the PUSCH based on a DCI scheduling uplink resource(s) for the PUSCH. The DCI may comprise or indicate the priority index. In response to the DCI does not comprise a priority index field, the wireless device may determine the priority index of the PUSCH is zero (0). The wireless device may determine a priority index of a PUCCH transmission based on one or more priorities of corresponding PDSCH(s) and/or SPS PDSCH(s) or SPS PDSCH release(s) that the PUCCH transmission carries HARQ feedback bits for the corresponding PDSCH(s) and/or SPS PDSCH(s) or SPS PDSCH release(s). In an example, the base station may transmit one or more RRC messages comprising configuration parameters. The configuration parameters may indicate a harq-CodebookID for a SPS configuration, wherein the harq-CodebookID may be used to determine a priority value of a SPS PDSCH or a SPS PDSCH release based on the SPS configuration. The wireless device may receive a second DCI scheduling a PDSCH of the corresponding PDSCH(s). The wireless device may determine a priority of the PDSCH based on the second DCI. For example, the second DCI may comprise/indicate a priority index field indicating the priority. For example, the wireless device may determine the priority as zero (0) in response to the second DCI does not comprise/indicate the priority for the PDSCH.

In an example, a base station may schedule a PUSCH with a first priority that may be used to piggyback/carry HARQ feedback bits with a second priority. The first priority and the second priority may be different or same. The wireless device may determine a prioritization of an overlapping PUSCH with a first priority and a PUCCH with a second priority based on a rule. For example, the rule is that the wireless device may determine or resolve conflict/overlapping between one or more PUCCHs and one or more PUSCHs with a same priority. For example, based on the determining the conflict/overlapping, the wireless device may have a first PUCCH with a high priority (e.g., larger priority index) and either a PUSCH or a second PUCCH with a low priority (e.g., lower priority index) where the first PUCCH overlaps with either the PUSCH or the second PUCCH. The wireless device may determine to transmit the first PUCCH and may cancel either the PUSCH or the second PUCCH before a first symbol overlapping with the first PUCCH transmission. The wireless device may expect that a transmission of the first PUCCH may not start before Tproc+d1 after a last symbol of a first PDCCH reception. The first PDCCH is a DCI scheduling the first PUCCH. For example, Tproc is a processing delay and d1 is an processing offset. For example, based on the determining the conflict/overlapping, the wireless device may have a PUSCH with a larger priority index scheduled by a first DCI format via a first PDCCH repetition and a PUCCH of a smaller priority index. The wireless device may determine to transmit the PUSCH and may cancel the PUCCH. The PUSCH and the PUCCH may overlap in time. The wireless device may cancel a transmission of the PUCCH before a first symbol overlapping with a transmission of the PUSCH. The wireless device may expect that the transmission of the PUSCH may not start before Tproc+d1 after a last symbol of the first PDCCH reception. For example, d1 may be determined based on a UE capability.

When a wireless device may detect a first DCI format (or a first DCI) scheduling a PUCCH with a larger priority index or a PUSCH transmission with a larger priority index that may overlap with a second PUCCH with a smaller priority index or a second PUSCH with a smaller priority index, the wireless device may not expect to receive a second DCI format (or a second DCI), after receiving the first DCI format (or the first DCI), scheduling resource(s) mapped to/fully overlapped to the second PUSCH or the second PUCCH. The base station may not reschedule or reclaim the resource(s) of the second PUSCH or the second PUCCH that are cancelled by a prioritization.

In an example, a wireless device may receive a first DCI format (or a first DCI) in a first PDCCH reception scheduling a first PUCCH or a first PUSCH with a higher priority index. The wireless device may receive a second DCI format (or a second DCI) in a second PDCCH reception scheduling a second PUCCH or a second PUSCH with a smaller priority index. The first PUCCH or the first PUSCH may overlap with the second PUCCH or the second PUSCH. The wireless device may determine Tproc based on a numerology of a smaller subcarrier spacing between a first numerology of the first PDCCH and a second numerology of the second PDCCH and a third numerology of the first PUCCH or the first PUSCH and a fourth numerology of the second PUCCH or the second PUSCH.

In an example, a base station may not schedule a first PUCCH or a first PUSCH with a smaller priority index that may overlap with a second PUCCH with a larger priority index with a HARQ feedback bits corresponding to a SPS PDSCH reception only. The base station may not schedule a first PUCCH with a smaller priority index that may overlap in time with a PUSCH with a larger priority index and comprises SP-CSI report(s) without a corresponding scheduling DCI/PDCCH.

In an example, when a wireless device multiplex UCI(s) with a first priority to a PUCCH or a PUSCH, the wireless device may assume that a priority of the PUCCH or the PUSCH may have a same priority to the first priority. A base station may schedule to multiplex the UCI(s) with the first priority to the PUCCH or the PUSCH with the same priority (e.g., the first priority). In an example, when a wireless device may be scheduled with a PUSCH without UL-SCH (e.g., data) and the PUSCH may overlap with a PUCCH comprising a positive SR, the wireless device may drop/cancel a transmission of the PUSCH. In an example, a wireless device may multiplex HARQ feedback bits in a PUSCH transmission via a configured grant resource that comprises a CG-UCI based on a cg-CG-UCI-Multiplexing configuration parameter. For example, the wireless device may multiple the HARQ feedback bits to the PUSCH with the CG-UCI when the cg-CG-UCI-Multiplexing is provided or indicated or enabled. Otherwise, the wireless device may not multiplex. The wireless device may multiplex the HARQ feedback bits to another transmission of a second PUSCH or a PUCCH.

In an example, a base station may transmit one or more RRC messages comprising configuration parameters. The configuration parameters may comprise/indicate pdsch-HARQ-ACK-Codebook-List. The pdsch-HARQ-ACK-Codebook-List may indicate whether the wireless device needs to generate one HARQ codebook or two HARQ codebook. When the wireless device generates one HARQ codebook, the wireless device may multiplex in a single HARQ codebook of HARQ feedback bits associated with a same priority index. When the wireless device generates two HARQ codebooks, the wireless device may generate a first HARQ codebook for a PUCCH of a first priority index (e.g., priority index 0). The wireless device may generate a second HARQ codebook for a second PUCCH of a second priority index (e.g., priority index 1). For each HARQ codebook, the configuration parameters may indicate PUCCH-Config, UCI-OnPUSCH, and/or PDSCH-codeBlockGroupTransmission.

In an example, a wireless device may generate a positive acknowledgement (ACK) when the wireless device detects a DCI format that may schedule a transport block or indicates a SPS release and the wireless device detects the transport block or the SPS release successfully. Otherwise, the wireless device may generate a negative acknowledgement (NACK). For example, a value 0 may indicate an ACK. A value 1 may indicate an NACK.

In an example, the configuration parameters may indicate PDSCH-CodeBlockGroupTransmission for a serving cell to enable a code block group (CBG) based HARQ feedback. The wireless device may generate N bits of HARQ feedback bits for a transport block when the CBG based HARQ feedback is enabled. For example, N is a number of HARQ feedback bits (e.g., number of CBGs) for a transport block. The wireless device may determine M number of code blocks per each CBG based on a total number of code blocks of the transport block. The wireless device may generate an ACK for a CBG in response to the wireless device correctly receive all code blocks of the CBG. Otherwise, the wireless device may generate an NACK for the CBG. When a wireless device receives two transport blocks by a DCI or a DCI format, the wireless device may generate one or more HARQ feedback bits for a first transport block of the two transport blocks first and then generate one or more second HARQ feedback bits for a second transport block of the two transport blocks. In general, the wireless device may generate HARQ feedback bits for one or more CBGs of a transport block first and then generate next HARQ feedback bits for one or more next transport block and so on.

In an example, a base station may transmit one or more RRC messages comprising/indicating configuration parameters. The configuration parameters may indicate a semi-static HARQ feedback mode (e.g., pdsch-HARQ-ACK-Codebook=semi-static) or a dynamic HARQ feedback mode (e.g., pdsch-HARQ-ACK-Codebook=dynamic).

In an example, a wireless device may be configured with dynamic HARQ feedback mode or dynamic/Type-2 HARQ-ACK codebook determination. Based on the dynamic HARQ feedback mode, the wireless device may multiplex of one or more HARQ-ACK feedback bits based on a PDSCH scheduled by a DCI format that does not include/comprise a counter DAI field. In an example, a wireless device may determine monitoring occasions for receiving DCI(s) of PDCCH(s) with one or more DCI formats scheduling PDSCH or SPS PDSCH release via an active downlink BWP of a serving cell. The wireless device may determine one or more HARQ-ACK/HARQ feedback bits in a same PUCCH in a slot n based on (1) a value of a PDSCH-to-HARQ feedback timing indicator field of a DCI format scheduling a PDSCH reception or a SPS PDSCH release; and (2) a slot offsets or timing offsets between a PDCCH/DCI and a PDSCH (e.g., K0) provided by a time domain resource assignment filed in a DCI format scheduling a PDSCH or a SPS PDSCH release; and (3) a number of slot aggregations for the PDSCH or the SPS PDSCH release.

For example, a wireless device may determine a set of PDCCH monitoring occasions for one or more DCI format that may schedule a PDSCH reception or a SPS PDSCH release. The set of PDCCH monitoring occasions may comprise one or more monitoring occasions based on one or more search spaces of an active DL BWPs of configured serving cells. The one or more monitoring occasions may be indexed in an ascending order of a start time of a search space associated or determining a PDCCH monitoring occasion. A cardinality of the set of PDCCH monitoring occasions may be defined as a total number M of the one or more monitoring occasions. A value of a counter DAI field in one or more DCI formats may represent an accumulative number of {serving cell, PDCCH monitoring occasion}-pair(s) where PDSCH reception or SPS PDSCH release associated with the one or more DCI formats up to a current PDCCH monitoring occasion. A counter DAI value may be updated for each PDCCH monitoring occasion to indicate accumulative number of PDSCH receptions and/or SPS PDSCH release up to the each PDCCH monitoring occasion. When a wireless device may support more than a PDSCH reception per each PDCCH monitoring occasion (e.g., PDSCH-Numerber-perMOperCell is larger than 1), the wireless device may order one or more PDSCH reception starting time for a same {serving cell, PDCCH monitoring occasion} pair. The wireless device may then order PDCCH monitoring occasion or PDSCH receptions based on a serving cell index. The wireless device may then order PDCCH monitoring occasion index (based on a starting time of PDCCH monitoring occasion). When a wireless device is provided with ACKNACKFeedbackMode=JointFeedback, a first coreset pool index may be ordered first than a second coreset pool index for a same serving cell.

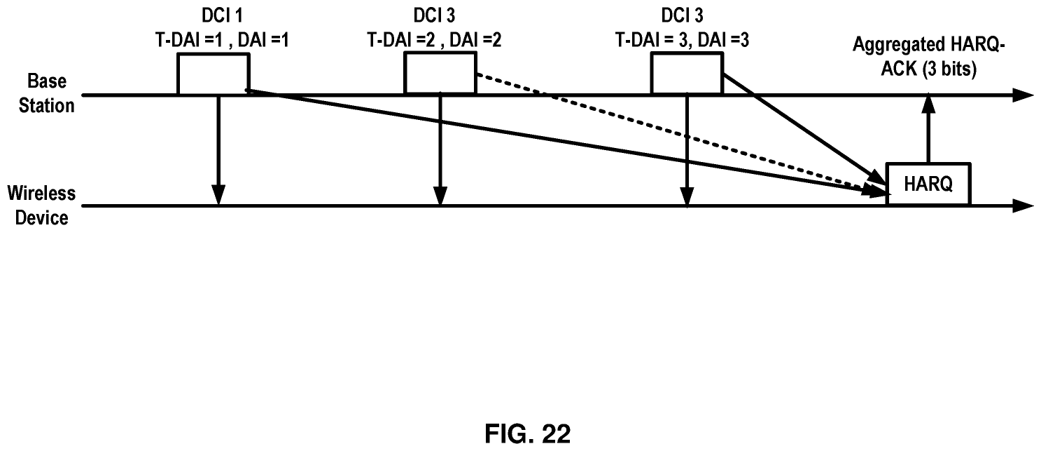

In an example, a value of a total DAI may denote/represent a total number of {serving, PDCCH monitoring occasion}-pair(s) up to a current PDCCH monitoring occasion across one or more serving cells. FIG. 22 illustrates an example of a counter-DAI (C-DAI or DAI) and a total DAI (T-DAI) when a wireless device is configured with a single serving cell. For example, the wireless device may determine a first monitoring occasion (a left box), a second monitoring occasion (a middle box) and a third monitoring occasion (a right box) in FIG. 22. The wireless device may be scheduled/received DCI(s) based on one or more DCI formats via monitoring occasions (e.g., the first monitoring occasion, the second monitoring occasion, the third monitoring occasion). For example, the wireless device may receive a first DCI (DCI 1) via the first monitoring occasion where the first DCI indicates a DAI=1 and a T-DAI=1. The wireless device may receive a third DCI (DCI 3) via the third monitoring occasion where the third DCI indicates a DAI=3 and a T-DAI=3. The first DCI and the third DCI may indicate a same PUCCH resource for HARQ feedback. The wireless device may generate a first HARQ feedback bit for a PDSCH or a SPS PDSCH release scheduled by the first DCI. The wireless device may generate a third HARQ feedback bit for a second PDSCH or a second SPS PDSCH release by the third DCI. The wireless device may not receive successfully a second DCI via the second monitoring occasion. The wireless device may determine a missed DCI (e.g. the second DCI) based on a DAI value of the third DCI. The wireless device may generate NACK for a third PDSCH or a third SPS PDSCH release based on the second DCI as the wireless device may not receive the third PDSCH or the third SPS PDSCH release. The wireless device may generate HARQ feedback bits for 3 bits, a first bit corresponding to the first DCI, a second bit for the second DCI and a third bit for the third DCI. The wireless device may transmit the HARQ feedback bits via the PUCCH.

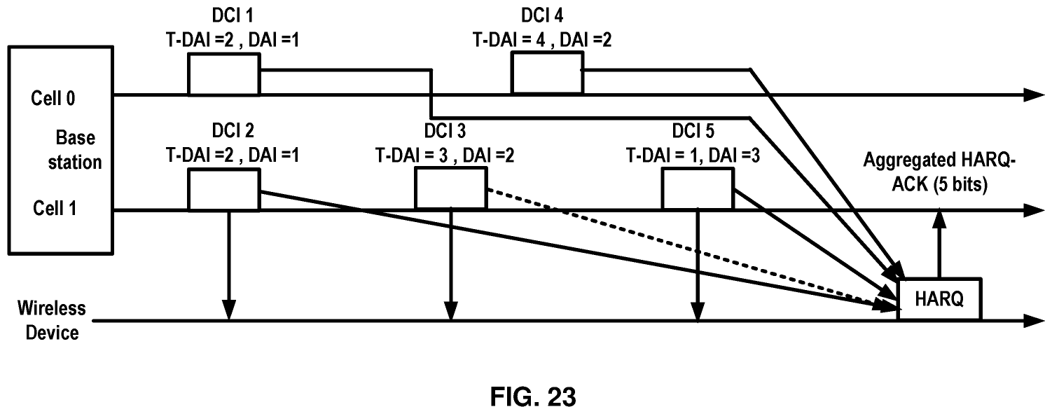

FIG. 23 illustrates an example of HARQ feedback determination when a wireless device is configured with a plurality of serving cells. For example, the wireless device may be configured with a first cell (Cell 0) and a second cell (Cell 1). For example, the wireless device may receive a first DCI via the first cell (DCI 1) that may indicate a DAI=1 and a T-DAI=2. The T-DAI may comprise all PDSCHs and/or SPS PDSCH release(s) scheduled via a same PDCCH monitoring occasion. A first monitoring occasion of the first cell may overlap and may have a same starting time to a first monitoring occasion of the second cell. A base station may set the T-DAI of the first DCI being two. The base station may set a T-DAI of a second DCI (DCI 2) via the second cell. A DAI value of the second DCI may be set to 1 as there is only one PDSCH or SPS PDSCH release scheduled by the second DCI for the second cell. The wireless device may not receive successfully a third DCI (DCI3) that may indicate a T-DAI=3 and DAI=2. The wireless device may receive a fourth DCI (DCI4) with a T-DAI=4 and DAI=2. The wireless device may receive a fifth DCI (DCI5) with a T-DAI=1 and DAI=3. A value of a T-DAI may be wrapped around when it reaches a maximum value or a threshold (e.g., a maximum value=4 based on 2 bits of T-DAI field, a maximum value=2\hat{ }K or 2\hat{ }K−1 where K is a number of bits used for a T-DAI field in a DCI format). The wireless device may determine HARQ-ACK bits as follows.

For example, for each PDCCH monitoring occasion (e.g., a first PDCCH monitoring occasion is a first time when the wireless device may monitor a first monitoring occasion via the first cell and a first monitoring occasion via the second cell), the wireless device may determine a number of HARQ-ACK feedback bits for each serving cell based on a cell index (e.g., determine the first cell and then determine the second cell when an index of the first cell is lower than an index of the second cell). For example, the wireless device may determine a number of HARQ-ACK bits for a serving cell based on a DAI field of the each PDCCH monitoring occasion. For example, the wireless device may determine a bit index among HARQ-ACK bits to put ACK or NACK for a transport block or a SPS PDSCH release scheduled by a DCI for the serving cell, where the wireless device may receive the DCI via the each PDCCH monitoring occasion. The wireless device may determine a first HARQ-ACK bit for a transport block of the first cell at the first PDCCH monitoring occasion. The wireless device may determine a second HARQ-ACK bit for a transport block of the second cell at the first PDCCH monitoring occasion. The wireless device may move to a next PDCCH monitoring occasion which occurs after the first monitoring occasion but occur before other monitoring occasions. In FIG. 23, the wireless device may determine a second monitoring occasion via the first cell as the wireless device may not detect any DCI via a second monitoring occasion via the second cell. The wireless device may determine a third HARQ ACK bit corresponding to a PDSCH or a SPS PDSCH release scheduled via the fourth DCI (DCI 4). The wireless device may move to a next PDCCH monitoring occasion, where the wireless device receives a DCI with a DAI value. For example, the wireless device may determine a third monitoring occasion via the second cell as the next PDCCH monitoring occasion. The wireless device may determine a fourth HARQ ACK bit corresponding to a PDSCH or a SPS PDSCH scheduled by the fifth DCI (DCI5).

The wireless device may determine a total DAI value being five, whereas the wireless device may have received four DCIs scheduling PDSCHs and/or SPS PDSCH release(s). The wireless device may determine NACK for a missed DCI between the second DCI and the fourth DCI. The wireless device may generate aggregated HARQ-ACK feedback by ascending order of a start time of a PDCCH monitoring occasion (e.g., the first DCI, the second DCI [symbol] (the third DCI [symbol] ) the fourth DCI [symbol] the fifth DCI) and for each PDCCH monitoring occasion based on a cell index (e.g., the first cell [symbol] the second cell in the first monitoring occasion). If the wireless device may be configured with a plurality of coreset pool indexes for a serving cell, the wireless device may further order based on a coreset pool index (e.g., a first coreset pool [symbol] a second coreset pool). When a wireless device may be configured with a plurality of transport blocks for any serving cell, the wireless device may determine two ACK and/or NACK bits for each PDCCH monitoring occasion of a serving cell. The wireless device may transmit 5 bits of HARQ ACK feedback corresponding to DCI1, DCI2, DCI3, DCI4 and DCI5.

In an example, a base station may transmit one or more RRC messages comprising/indicating configuration parameters. The configuration parameters may indicate/comprise a HARQ feedback mode/type/mechanism between Type-1 HARQ-ACK codebook determination (e.g., semi-static HARQ-ACK codebook generation type/mode/mechanism) and Type-2 HARQ-ACK codebook determination (e.g., dynamic HARQ-ACK codebook generation type/mode/mechanism). The configuration parameter may indicate/comprise the HARQ feedback mode/type/mechanism as a Type-3 HARQ-ACK codebook determination that is an advanced dynamic HARQ-ACK codebook generation type/mode/mechanism. The configuration parameters may indicate/comprise one or more time domain resource allocation entries that may be referred via one or more scheduling DCIs indicating downlink resources for PDSCH(s) and/or SPS PDSCH release(s). An entry of the one or more time domain resource allocation entries may include/comprise a scheduling offset (e.g., k0) between an ending time of a scheduling DCI and a start time of a corresponding PDSCH. The entry may comprise a number of repetitions for one or more PDSCHs scheduled by the scheduling DCI. The entry may comprise a starting OFDM symbol in a scheduled slot. The entry may also comprise a length of a PDSCH of the one or more PDSCHs.

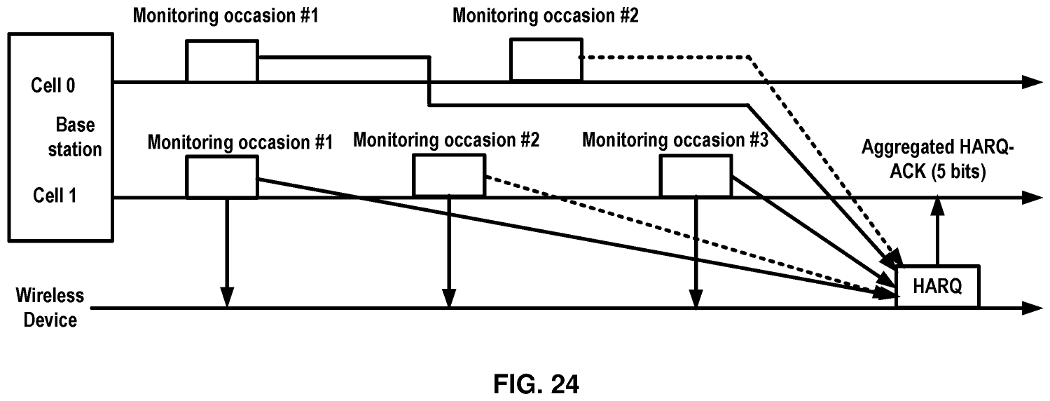

For example, the wireless device may determine HARQ-ACK information for a corresponding PDSCH or SPS PDSCH release in a HARQ-ACK codebook that the wireless device may transmits in a slot n based on one or more PDSCH-to-HARQ feedback timing indicator field. For example, the wireless device may report NACK values for HARQ-ACK information bit(s) in a HARQ-ACK codebook that the wireless device transmits in the slot n that are not indicated by a value of a PDSCH-to-HARQ feedback timing indicator field in a corresponding DCI. The wireless device may determine one or more HARQ-ACK information bit(s) based on one or more monitoring occasions and one or more values of scheduling offset. For example, a scheduling offset may represent a gap between a DCI to a corresponding PDSCH scheduled by the DCI. FIG. 24 illustrates an example embodiment. The wireless device may be configured with a first cell (Cell 0) and a second cell (Cell 1). The wireless device may have two monitoring occasions via the first cell that may map to a PUCCH resource (e.g., HARQ). The wireless device may have three monitoring occasions via the second cell that may map to the PUCCH resource. For example, if a wireless device may expect to receive at most one PDSCH scheduled via a monitoring occasion, the wireless device may determine one HARQ-ACK information bit for a corresponding DCI.

FIG. 24 illustrates that the wireless device may determine 5 bits of HARQ-ACK bits based on a plurality of monitoring occasion. The plurality of monitoring occasions may comprise the two monitoring occasions via the first cell and the three monitoring occasions via the second cell. The wireless device may determine an order of HARQ-ACK bits based on a cell index (e.g., the first cell [symbol] the second cell) and a start time of a monitoring occasion within a cell (e.g., monitoring occasion #1 [symbol] monitoring occasion #2). For example, a HARQ-ACK codebook via the PUCCH resource may indicate 5 bits where a first bit corresponds to a first monitoring occasion (Monitoring occasion #1) of the first cell, a second bit corresponds to a second monitoring occasion (Monitoring occasion #2) of the first cell, a third bit corresponds to a first monitoring occasion (Monitoring occasion #1) of the second cell, a fourth bit corresponds to a second monitoring occasion (Monitoring occasion #2) of the second cell, and a fifth bit corresponds to a third monitoring occasion (Monitoring occasion #3) of the second cell.

In an example, two downlink resource allocation schemes, type 0 and type 1, are supported. A wireless device may determine a frequency domain resource based on a DCI based on a fallback DCI format such as DCI format 0_1 based on a resource allocation type 1. A base station may transmit configuration parameters indicating a dynamic switch between the type 0 and the type 1 resource allocation via an indication in a DCI. The configuration parameters may comprise ‘dynamicswitch’ to enable dynamic switching between the type 0 and the type 1 via the DCI. The dynamic switching may be supported for a DCI based on a non-fallback DCI format such as DCI format 1_1 or DCI format 1_2. The configuration parameters may comprise/indicate either the type 0 or the type 1 as a resource allocation type via an RRC signaling. The wireless device may determine a frequency domain resource based on a DCI based on the resource allocation configured via the RRC signaling, in response to ‘dynamicswitch’ being not configured. The wireless device may determine a frequency domain resource based on a frequency domain resource assignment field of a DCI based on an active downlink BWP of a cell. The cell is a scheduled cell. The DCI may indicate a BWP index. The wireless device may determine the frequency domain resource based on one or more configuration parameters of an indicated BWP by the BWP index. For a PDSCH scheduled with a DCI based on a fallback DCI format (e.g., DCI format 1_0) via any common search space, a RB numbering, to determine a frequency domain resource, may start from a lowest RB of a coreset. For example, the DCI has been received via the coreset. In other cases, the RB numbering may start from a lowest RB of an active BWP of the scheduled cell.

For example, a resource allocation type 0 may use a bitmap to indicate a frequency domain resource. The bitmap may indicate one or more resource block groups (RBGs) that may allocate the frequency domain resource. One RBG may represent a set of consecutive virtual resource blocks defined by a rgb-Size. For example, the rbg-Size may be indicated as a parameter of a PDSCH-Config under a servingCellConfig. For example, the rbg-Size may be determined based on a parameter of ‘Configuration 1’ or ‘Configuration 2’ and a bandwidth of an active BWP of a scheduled cell. For example, when the bandwidth of the active BWP is between 1 to 36 RBs, ‘Configuration 1’ indicates the rbg-Size of 2 and ‘Configuration 2’ indicates the rbg-Size of 4. For example, when the bandwidth of the active BWP is between 37 to 72 RBs, ‘Configuration 1’ indicates the rbg-Size of 4 and ‘Configuration 2’ indicates the rbg-Size of 8. For example, when the bandwidth of the active BWP is between 73 to 144 RBs, ‘Configuration 1’ indicates the rbg-Size of 8 and ‘Configuration 2’ indicates the rbg-Size of 16. For example, when the bandwidth of the active BWP is between 145 to 275 (or 550) RBs, ‘Configuration 1’ indicates the rbg-Size of 16 and ‘Configuration 2’ indicates the rbg-Size of 16. A number of RBGs (N_RBG) for a downlink BWP may present. A DCI field size of a frequency domain resource allocation based on the resource allocation type 0 would be ceil (N_RBG+(N_start_BWP mode P))/P) where a size of a first RBG is P−N_start_BWP mode P, a size of a last RBG is (N_start_BWP+bandwidth) mode P wherein is (N_start_BWP+bandwidth) mode P is greater than zero, a size of other RBGs are P, and P is the rbg-Size. The bitmap of N_RBG bits with one bitmap bit per a corresponding RBG, such that the corresponding RBG may be scheduled. The one or more RBGs may be indexed in an order of increasing frequency, and indexing may start from a lowest frequency of the active BWP. The order of the bitmap may be determined such that RBG #0 to RBG #N_RBG−1 may be mapped to most significant bit to least significant bit of the bitmap. The wireless device may assume an RBG is allocated in response to a corresponding bit of the bitmap being allocated/assigned as 1. The wireless device may assume a second RBG is not allocated in response to a corresponding bit of the bitmap being allocated/assigned as 0.

When a virtual RB to a physical RB mapping is enabled, the wireless device may determine one or more physical RBGs based on the indicated bitmap for the virtual RBGs. Otherwise, the indicated bitmap may determine the one or more physical RBGs.

For example, a resource allocation type 1, a frequency domain resource allocation may indicate a set of contiguously allocated non-interleaved or interleaved virtual resource blocks within an active bandwidth part of a scheduled cell. For example, a DCI may be scheduled via a USS. The frequency domain resource allocation field based on the resource allocation type 1 may use a resource allocation value (RIV). The RIV may indicate a starting virtual RB (RB_start) and a length in terms of contiguously allocated virtual RBs (L_rbs). The RIV value may be determined as the RIV=bandwidth (L_rbs−1)+RB_start when (L_rbs−1) is smaller than or equal to floor (bandwidth/2), or the RIV=bandwidth (bandwidth−L_rbs+1)+(bandwidth−1−RB_start) otherwise. The bandwidth may represent a bandwidth of the active BWP.

A base station may enable a PRB bundling. A wireless device may assume a same precoding over a number RBs of the PRB bundle (e.g., two PRBs, four PRBs or the bandwidth). The base station may schedule the PRB bundle or not, and may not schedule partial PRB bundle to the wireless device.

Similar to downlink, for an uplink transmission, a few resource allocation types are supported. For the uplink transmission, a resource allocation type 0, resource allocation type 1 or resource allocation type 2 may be supported. The resource allocation type 0 may be used in response to a transform precoding being disabled. The resource allocation type 1 or the resource allocation type 2 may be used in response to the transform precoding being enabled or being disabled. For the uplink transmission, a ‘dynamicswitch’ may be configured. In response to the ‘dynamicswitch’, the wireless device may switch between the resource allocation type 0 and the resource allocation type 1 based on a DCI. The base station may configure a resource allocation type via an RRC signaling in response to the ‘dynamicswitch’ being not configured/enabled. The resource allocation type 2 may be used in response to an interlaced PUSCH being enabled. The wireless device may apply the resource allocation type 1 for a DCI based on a fallback DCI format such as a DCI format 0_0. The interlaced PUSCH is disabled for the fallback DCI format. When the interlaced PUSCH is enabled, the wireless device may apply the resource allocation type 2 for the DCI. The wireless device may determine a frequency domain resource based on a frequency domain resource allocation field of a DCI based on an active uplink BWP of a scheduled cell. The DCI may not comprise a BWP index. The wireless device may determine the frequency domain resource based on an indicated BWP by a BWP index when the DCI comprises the BWP index.

In an example, a resource allocation type 0 for an uplink transmission may use a bitmap indicating one or more RBGs within an active UL BWP of a scheduled cell. One RBG may represent a set of consecutive virtual resource blocks defined by a rbg-Size. The rbg-Size may be indicated as a parameter of a PYSCH-Config under a servingCellConfig. For example, the rbg-Size may be determined based on a parameter of ‘Configuration 1’ or ‘Configuration 2’ and a bandwidth of an active UL BWP of a scheduled cell. For example, when the bandwidth of the active UL BWP is between 1 to 36 RBs, ‘Configuration 1’ indicates the rbg-Size of 2 and ‘Configuration 2’ indicates the rbg-Size of 4. For example, when the bandwidth of the active UL BWP is between 37 to 72 RBs, ‘Configuration 1’ indicates the rbg-Size of 4 and ‘Configuration 2’ indicates the rbg-Size of 8. For example, when the bandwidth of the active UL BWP is between 73 to 144 RBs, ‘Configuration 1’ indicates the rbg-Size of 8 and ‘Configuration 2’ indicates the rbg-Size of 16. For example, when the bandwidth of the active UL BWP is between 145 to 275 (or 550) RBs, ‘Configuration 1’ indicates the rbg-Size of 16 and ‘Configuration 2’ indicates the rbg-Size of 16. A number of RBGs (N_RBG) for a uplink BWP may present. Determination of a bit of the bitmap of the uplink resource allocation type 1 is same as that of the downlink resource allocation type 1. In frequency range 1 (e.g., below 7 GHz), almost contiguous allocation may be supported. In frequency range 2 (e.g., above 7 GHz and below 52.6 GHz), contiguous resource allocation may be supported.

The resource allocation type 0 for an uplink transmission may follow similar procedure to the resource allocation type 0 for an downlink transmission.

The resource allocation type 2 may be used to indicate an interlaced resource allocation, wherein M is a number of interlaces. For example, a frequency domain resource allocation field may comprise a RIV. For the RIV between 0 and M (M+1)/2 (e.g., 0<=RIV<M(M+1)/2), the RIV may indicate a starting interlace index m_0 and a number of contiguous interlace indices L (L>=1). For example, when (L−1)<=floor (M/2), the RIV may define M (L−1)+m_0. Otherwise, the RIV may define M (M−L+1)+(M−1−m_0). For the RIV larger than or equal to M(M+1)/2 (e.g., RIV>=M(M+1)/2), the RIV may indicate a starting interlace index m_0 and a set of values I based on one or more set of values. For example, an entry may represent {RIV−M(M+1)/2, m_0, I}. For example, the one or more set of values may comprise {0, 0, {0, 5}}, {1, 0, {0, 1, 5, 6}}, {2, 1, {0, 5}}, {3, 1, {0, 1, 3, 5, 6, 7, 8}}, {4, 2, {0, 5}}, {5, 2, {0, 1, 2, 5, 6, 7}}, {6, 3, {0, 5}}, and/or {7, 4, {0, 5}}.

Resource allocation type and mechanism based on a DCI may be also applied to a configured grant configuration or semi-persistent scheduling configuration.

In an example, a base station may transmit a DCI. The DCI may comprise a time domain resource allocation field. A value of the time domain resource allocation field (e.g., m) may indicate a row index m+1 of a time domain resource allocation lists/a time domain resource allocation table. The base station may transmit configuration parameters indicating one or more time domain resource allocation tables. For example, a first time domain resource allocation table may be used for a fallback DCI format scheduled via a CSS. For example, a second time domain resource allocation table may be used for a fallback DCI format and/or a non-fallback DCI format via a USS. The wireless device may determine a time domain resource allocation table from the one or more time domain resource allocation tables for the DCI in response to receiving the DCI. The configuration parameters may comprise one or more time domain resource allocation entries for a time domain resource allocation table. One time domain resource allocation entry may comprise a starting and a length indicator value (SLIV), a PUSCH mapping type, and K2 value. The K2 may represent a scheduling offset between a scheduling DCI of a PUSCH and a starting slot index of the PUSCH. The one time domain resource allocation (TDRA) entry may comprise a repetition number (numberOfRepetitions). The one TDRA entry may comprise a starting symbol (startSymbol) and a length addition to the SLIV. For a PUSCH, scheduled by a non-fallback DCI format such as DCI format 0_1, a base station may transmit, to a wireless device, configuration parameters indicating PUSCHRepTypeIndicaor-ForDCIFormat0_1 to ‘puschRepTypeB’ indicating a repetition type B. In response to being configured with ‘puschRepTypeB’, the wireless device may determine a resource based on a procedure for the repetition type B and a time domain resource allocation field of a DCI based on the DCI format 0_1. Similarly, the configuration parameters may comprise PUSCHRepTypeIndicator-ForDCIformat0_2 to ‘puschRepTypeB’ to apply the repetition type B for a second DCI based on a DCI format 0_2. When the base station may not configure PUSCHRepTypeIndicaor-ForDCIFormat0_1 indicating ‘puschRepTypeB’, the wireless device may determine a time domain resource based on a DCI based on a repetition type A.

For example, when the repetition type A is configured/enabled, the wireless device may determine a starting symbol S in a starting slot and a number of consecutive symbols L from the starting symbol S based on a SLIV value. For example, the SLIV value may define SLIV=14*(L−1)+S when (L−1) is smaller than or equal to 7 (half slot based on a normal CP). The SLF value may define SLIV=14*(14−L+1)±(14−1−S) when (L−1) is larger than 7. For example, L would be greater than 0, and may be smaller than or equal to 14−S. In an uplink BWP with an extended CP, 12 OFDM symbols may be assumed for a slot. A SLIV value may be determined by 12*(L−1)+S or 12*(12−L+1)+(14−1−S) respectively based on L−1 being smaller than/equal to 6 or larger than 6. For the repetition type A, the configuration parameters may comprise/indicate a TypeA or Type B for a PUSCH mapping type. For example, the base station may determine a first OFDM symbol comprising a DM-RS based on a fixed location (e.g., a first symbol of a slot) when the TypeA is configured for the PUSCH mapping type. For example, the base station may determine a first OFDM symbol comprising a DM-RS based on a starting OFDM symbol of the PUSCH in response to the typeB being configured for the PUSCH mapping type.

For example, when the repetition type B is configured/enabled, the wireless device may determine a starting OFDM symbol S in a starting slot, and a number of consecutive OFDM symbols L based on a row of a time domain resource allocation table. For example, the row of the time domain resource allocation table may comprise startSymbol for the starting OFDM symbol S and length for the number of consecutive OFDM symbols L. For the repetition type B, the wireless device may assume that the TypeB is configured for the PUSCH mapping type. For example, when a TypeA is configured for a PUSCH mapping type, a staring OFDM symbol S, a length L, and S+L may represent one or more values. For example, {S, L, S+L} may be {0, {4, . . . , 14}, {4, . . . , 14}} for a normal CP, and {0, {4, . . . , 12}, {4, . . . , 12}} for an extended CP. When a TypeB is configured for the PUSCH mapping type, {S, L, S+L} may be {{0, . . . , 13}, {1, . . . , 14}, {1, . . . , 14} for a repetition type A, {1, . . . , 27} for a repetition type B} for the normal CP, and {{0, . . . , 11}, {1, . . . , 12}, {1, . . . , 12}} for the extended CP.

For a repetition type A, a wireless device may determine a repetition number K based on a row of a time domain resource allocation table. The row may comprise a number of repetitions. The wireless device may determine based on an RRC parameter, ‘pusch-AggregationFactor’ when the row may not comprise the number of repetitions. The wireless device may determine a single transmission based on the row may not comprise the number of repetitions nor the ‘pusch-AggregationFactor’ is not configured. The wireless device may determine the single transmission for a PUSCH scheduled by a fallback DCI such as a DCI format 0_0.

For a repetition type A with a repetition number K being larger than 1, a wireless device may apply a starting OFDM symbol S and a length Lin a slot across K consecutive slots based on a single transmission layer. The wireless device may repeat a TB across the K consecutive slots applying same OFDM symbols in each slot. A redundancy version (RV) applied on a i-th transmission of the K consecutive slots may be determined based on a repetition type. For example, when a RV value indicated by a DCI is 0, a second RV value for i-th transmission occasion (when a repetition type A is configured) or i-th actual repetition (when a repetition type B is configured) may be determined as 0 for i mod 4=0, 2 for i mod 4=1, 3 for i mod 4=2, 4 for i mod 4=3. When the RV value is 2, the second RV value may be determined as 2 for i mod 4=0, 3 for i mod 4=1, 1 for i mod 4=2, 0 for i mod 4=3. When the RV value is 3, the second RV value may be determined as 3 for i mod 4=0, 1 for i mod 4=1, 0 for i mod 4=2, 0 for i mod 4=2. When the RV value is 1, the second RV value may be determined as 1 for i mod 4=0, 0 for i mod 4=1, 2 for i mod 4=2, 3 for i mod 4=3.

For a repetition type A, a PUSCH transmission of a slot over a plurality of slots may be omitted when the slot may not have a sufficient number of uplink OFDM symbols for the PUSCH transmission. For a repetition type B, a wireless device may determine one or more slots for a number of nominal repetition number N. For a i-th nominal repetition, wherein i is 0, . . . , N−1, wherein N may be configured by a base station via an RRC signaling or a time domain resource allocation of a DCI. The wireless device may determine a slot. The i-th nominal repetition may start, wherein a slot index would be Ks+floor ((S+iL)/N_slot_symbol), and a starting symbol in the slot may be given by mod (S+iL, N_slot_symbol). The N_slot_symbol may be 14 with a normal CP and 12 with an extended CP. The S may represent a starting OFDM symbol indicated by a time domain resource allocation field of a DCI and L may represent a length indicated by the time domain resource allocation field of the DCI. The wireless device may determine a second slot wherein the i-th nominal repetition may end wherein a second slot index of the second slot may be determined as Ks+floor ((S+(i+1)*L−1)/N_slot_symbol), and an ending symbol in the second slot may be determined as mod (S+(i+1)*L−1, N_slot_symbol). The Ks may be determined as a starting slot indicated by the time domain resource allocation field of the DCI.

When the wireless device is configured with the repetition type B, the wireless device may determine invalid OFDM symbol for PUSCH repetitions based on a tdd-UL-DL-ConfigurationCommon/a tdd-UL-DL-ConfigurationDedicated and/or an InvalidSymbolPattern indicated by an RRC signaling. For example, the wireless device may determine a downlink symbol based on the tdd-UL-DL-ConfigurationCommon or the tdd-UL-DL-ConfigurationDedicated as an invalid OFDM symbol for the repetition type B. The base station may transmit the InvalidSymbolPattern, a bitmap of OFDM symbols over one slot or two slots. A bit of the bitmap may indicate ‘1’ to invalidate a corresponding OFDM symbol. The base station may further configure periodicityAndPattern. A bit of the periodicityAndPattern may correspond to a unit equal to a duration of the bitmap of the InvalidSymbolPattern. The wireless device may determine invalid OFDM symbol(s) based on the InvalidSymbolPattern and the periodicityAndPattern. For example, when a PUSCH is scheduled/activated by a non-fallback DCI format such as a DCI format 0_1/0_2 and InvalidSymbolPatternIndicator-ForDCIFormat0_1/0_2 is configured, a invalid symbol pattern indicator field may indicate 1, the wireless device may apply an invalid symbol pattern (e.g., InvalidSymbolPattern). Otherwise, the wireless device may not apply the invalid symbol pattern. When the InvalidSymbolPatternIndicator-ForDCIFormat0_1/0_2 is not configured, the wireless device may not apply the invalid symbol pattern. The wireless device may determine remaining OFDM symbols. The remaining OFDM symbols may not comprise invalid OFDM symbol(s), the wireless device may consider the remaining OFDM symbols as valid OFDM symbols. When there is a sufficient number of valid OFDM symbols in a slot to transmit a PUSCH based on a scheduling DCI, the wireless device may determine an actual repetition of a slot wherein the slot may have consecutive sufficient valid consecutive OFDM symbols. The wireless device may skip the actual repetition based on a slot formation indication. The wireless device may apply a redundancy version based on the actual repetition.

In an example, a row of a time domain resource allocation may comprise one or more resource assignments for one or more contiguous PUSCHs. A K2 of the row may indicate a first PSCH of the one or more contiguous PUSCHs. Each PUSCH of the one or more contiguous PUSCHs may be indicated/scheduled with a separate SLIV value and a PUSCH mapping type.

A similar mechanism may be used to schedule a time domain resource for a downlink data.

In an example, a carrier or a cell (e.g., an uplink carrier/cell or a downlink carrier/cell) may comprise a plurality of resource blocks (RBs). A resource block may comprise a set of subcarriers (e.g., 1 RB=12 subcarriers). The carrier may be configured with one or more uplink BWPs. An uplink BWP may comprise a plurality of consecutive RBs and a numerology. A wireless device may transmit a TB via the carrier, whereas the wireless device may transmit a part of TB (e.g., a modulation symbol) via a subcarrier.

In an example, a wireless device may transmit a first PUSCH of a TB via a first uplink carrier/cell and a second PUSCH of the TB via the second uplink carrier/cell simultaneously based on the first uplink carrier may operate in a first frequency range and the second uplink (UL) carrier may operate in a second frequency range. For example, a wireless device may receive a first PDSCH of a TB via a first downlink (DL) carrier/cell and a second PDSCH of the TB via the second downlink carrier/cell simultaneously based on the first downlink carrier may operate in a first frequency range and the second downlink carrier may operate in a second frequency range. For example, the first frequency range may be different from the second frequency range. The first frequency range may belong to a frequency range 1, a frequency range 2 or a frequency range 3. The second frequency range may belong to the frequency range 1, the frequency range 2 or the frequency range 3.

For example, the first UL carrier may be a non-supplemental uplink carrier of a cell and the second UL carrier may be a supplemental uplink carrier of the cell. For example, the first uplink carrier is associated with a first uplink panel and/or a first transmission and reception point (TRP) (e.g., a first coreset pool, a first coreset group) of the cell, and the second uplink carrier is associated with a second uplink panel and/or a second TRP (e.g., a second coreset pool, a second coreset group) of the cell. The first UL carrier may be associated with a first cell. The second UL carrier may be associated with a second cell. The first cell and the second cell may be different. For example, the first DL carrier may be a non-supplemental downlink carrier of a cell and the second DL carrier may be a supplemental downlink carrier of the cell. For example, the first downlink carrier is associated with a first uplink panel and/or a first transmission and reception point (TRP) (e.g., a first coreset pool, a first coreset group) of the cell, and the second downlink carrier is associated with a second uplink panel and/or a second TRP (e.g., a second coreset pool, a second coreset group) of the cell. The first DL carrier may be associated with a first cell. The second DL carrier may be associated with a second cell. The first cell and the second cell may be different.

In an example, a wireless device may transmit one or more HARQ-ACK feedback bits via a PUCCH in a slot n. The one or more HARQ-ACK feedback bits may correspond to one or more PDSCHs and/or one or more SPS PDSCH releases received via one or more slots. For example, the one or more slots may have offset/gap values from the slot n, wherein a offset/gap value of the offset/gap values may be indicated as a PDSCH-to-HARQ feedback timing indicator by a DCI scheduling a PDSCH of the one or more PDSCHs or releasing a SPS PDSCH release of the one or more SPS PDSCH releases. For example, the one or more slots may comprise slot n−1, slot n−2, . . . , slot n−k, where k is a maximum offset value or a maximum value used for the PDSCH-to-HARQ feedback timing indicator. The DCI may also indicate/comprise a current downlink assignment index (C-DAI or DAI) that may represent an accumulative number of transport blocks or an accumulative number of receptions of PDSCH(s) and/or an accumulative number of SPS PDSCH release(s) up to a monitoring occasion of a cell. For example, the DCI may be received via the monitoring occasion of the cell. The DCI may also indicate total DAI (T-DAI) that may represent a total number of transport blocks or a total number of receptions of PDSCH(s) and/or a total number of SPS PDSCH release(s) up to a PDCCH monitoring occasion across one or more serving cells.

In an example, a PDCCH monitoring occasion may comprise one or more monitoring occasions. For example, a first monitoring occasion of the one or more monitoring occasion may have a same starting time to a second monitoring occasion of the one or more monitoring occasion. For each PDCCH monitoring occasion, a base station may indicate a total number of HARQ-ACK feedback bits via a value of the T-DAI via a DCI. The wireless device may determine the HARQ-ACK feedback bits based on the C-DAI/T-DAI when the wireless device is configured with a dynamic (or Type-2) HARQ-ACK codebook determination.

In an example, a wireless device may have a plurality of PDCCH monitoring occasions that may map to a transmission of a PUCCH in a slot n. The wireless device may determine a first number of HARQ-ACK feedback bits in a first PDCCH monitoring occasion of the plurality of PDCCH monitoring occasions. The wireless device may determine a second number of HARQ-ACK feedback bits in a second monitoring occasion of the plurality of PDCCH monitoring occasions. The wireless device may determine a k-th number of HARQ-ACK feedback bits in a k-th PDCCH monitoring occasion of the plurality of PDCCH monitoring occasions. For example, each PDCCH monitoring occasion may comprise one or more monitoring occasions across one or more serving cells. For each monitoring occasion of the one or more monitoring occasions, the wireless device may check/determine whether the wireless device has received a DCI comprising/indicating C-DAI/DAI and/or T-DAI. In response to the DCI, the wireless device may determine one or more HARQ-ACK feedback bits corresponding to a PDSCH scheduled by the DCI or a SPS PDSCH release indicated by the DCI.

In an example, a wireless device may receive a DCI (e.g., a multi-cell DCI, M-DCI) indicating a plurality of resources for one or more PDSCHs for a plurality of cells and/or one or more SPS PDSCH releases for the plurality of cells. When the wireless device receives one or more M-DCIs corresponding to a PUCCH resource or a HARQ-ACK feedback resource and receives one or more DCIs corresponding to the PUCCH resource or the HARQ-ACK feedback resource, existing mechanisms of HARQ-ACK codebook determination in each PDCCH monitoring occasion may lead ambiguous HARQ-ACK codebook determination. In existing technologies, the base station may determine a value of a total DAI field of a DCI where the value of the total DAI indicates a total number of PDCCH monitoring occasions across one or more serving cells. For example, the wireless device may receive a DCI via a PDCCH monitoring occasion scheduling PDSCH reception(s) or SPS PDSCH release.

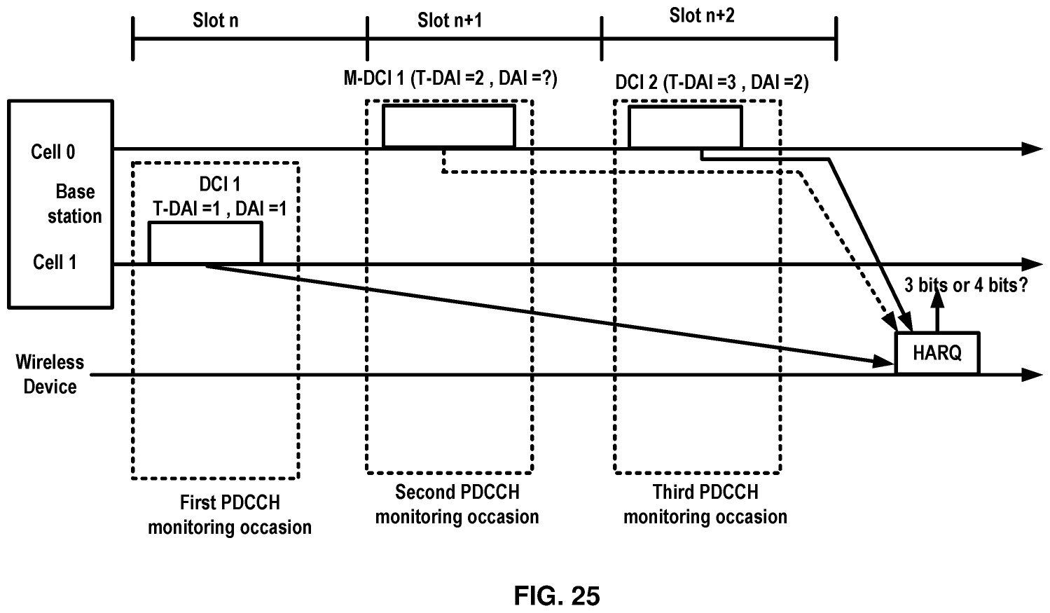

FIG. 25 illustrates an example. For example, the wireless device may receive a first DCI (DCI 1) via a first monitoring occasion of a second cell (Cell 1) in slot n. The wireless device may monitor for a M-DCI via a first monitoring occasion of a first cell in slot n+1. The wireless device may not successfully receive the M-DCI (M-DCI 1) transmitted by the base station at the slot n+1. The wireless device may receive a second DCI (DCI 2) via a second monitoring occasion of the first cell (Cell 0) in slot n+2. The first DCI (DCI 1) may indicate a C-DAI=1 and T-DAI=1. Based on the existing mechanisms, the M-DCI (M-DCI 1) may indicate a T-DAI=2. For example, up to the first monitoring occasion of the first cell, the base station determines two PDCCH monitoring occasions (e.g., the first monitoring occasion of the second cell and the first monitoring occasion of the first cell) comprising DCIs scheduling PDSCHs/SPS PDSCH releases. As shown in FIG. 25, the base station and/or the wireless device may determine the first PDCCH monitoring occasion comprising the first monitoring occasion of the second cell, a second PDCCH monitoring occasion comprising the first monitoring occasion of the first cell, and a third PDCCH monitoring occasion comprising the second monitoring occasion of the first cell. Based on a set of PDCCH monitoring occasions and/or monitoring occasions across the one or more serving cells, the wireless device and/or the base station may determine a total DAI value of a DCI or a M-DCI.

Existing mechanisms may not clearly determine whether a C-DAI or DAI value of the M-DCI is set to 1 or 2. For example, the M-DCI may schedule a first PDSCH for the first cell. Based on the first cell, the C-DAI/DAI value of the M-DCI is 1. For example, the M-DCI may schedule a second PDSCH for the second cell. Based on the second cell, the C-DAI/DAI value of the M-DCI is 2. There is an ambiguity in terms of determining a C-DAI/DAI value for a M-DCI. The second DCI (DCI 2) may indicate a C-DAI/DAI value of 2 as there are two PDSCHs scheduled for the first cell. The second DCI may indicate a T-DAI value of 2 based on existing mechanisms.

When the wireless device receives the first DCI and the second DCI and misses the M-DCI, the wireless device may determine that three bits of HARQ-ACK bits are generated for the PUCCH/HARQ based on a total DAI value of the second DCI. When the wireless device may receives the first DCI and the second DCI and also receives the M-DCI, the wireless device may determine that four bits of HARQ-ACK bits are generated as the M-DCI schedules two PDSCHs for the first cell and the second cell. Based on cases and based on which DCIs that the wireless device receives and/or misses, the wireless device may generate different numbers and/or different bits of HARQ-ACK codebook mapped to the PUCCH/HARQ-ACK feedback resource. Existing mechanisms may lead ambiguity in determining a HARQ-ACK codebook with a multi-cell DCI operation.

According to an example embodiment, a base station and/or a wireless device may determine a C-DAI/DAI value of each multi-cell DCI based on a number of schedulable cells by the each multi-cell DCI. The C-DAI/DAI value may be incremented based on a first cell. This may reduce ambiguity when the wireless device may miss one or more DCIs. The base station and/or the wireless device may determine a T-DAI value of the each multi-cell DCI based on the number of schedulable cells by the each multi-cell DCI. Based on the C-DAI/DAI and the T-DAI, the wireless device may generate a HARQ-ACK codebook. The HARQ-ACK codebook may comprise one or more first HARQ-ACK bits corresponding to one or more multi-cell DCIs and one or more second HARQ-ACK bits corresponding to one or more single-cell DCIs. Embodiments reduces ambiguity in terms of a HARQ-ACK codebook determination. For example, it may allow to generate an aligned number of HARQ-ACK bits between a base station and a wireless device. For example, it may allow to generate an aligned order of HARQ-ACK feedback bits between the base station and the wireless device. Embodiments reduces complexity of the wireless device by allowing multiplexing of HARQ-ACK feedbacks for multi-cell scheduling and HARQ-ACK feedbacks for single-cell scheduling. Embodiments allows flexible configuration of scheduled cells by a multi-cell DCI. Embodiments allows efficient HARQ-ACK codebook determination when a maxNrofCodeWordsScheduledByDCI is 1 for serving cells for the HARQ-ACK codebook determination.

In an example, a wireless device may receive a multi-cell DCI comprising/indicating resources for two cells. The wireless device may receive the multi-cell DCI via a first cell. The two cells may comprise a second cell and a third cell. The wireless device may determine a C-DAI/DAI value of the multi-cell DCI based on the second cell. The wireless device may determine the second cell as a primary scheduled cell. The wireless device may determine the C-DAI/DAI based on the primary scheduled cell. A base station and/or the wireless device may increment 1 for each DCI for a total DAI. In an example, the base station may transmit one or more RRC messages indicating configuration parameters. The configuration parameters may indicate a maximum codeword number as 2 (e.g., maxNrofCodeWordsScheduledByDCI=2). The base station and/or the wireless device may determine that a multi-cell DCI schedules at most one transport block/codeword for the second cell and at most one transport block/codeword for the third cell. The base station and/or the wireless device may determine that a single-cell DCI schedules at most two transport blocks/codewords for a cell, where the wireless device may perform a HARQ-ACK codebook determination for a PUCCH resource and may generate HARQ-ACK codebook for the cell and the second cell together.

The wireless device may determine two HARQ-ACK feedback bits corresponding to a multi-cell DCI scheduling two cells similar manner as the wireless device determines two HARQ-ACK feedback bits corresponding to a single-cell DCI scheduling two transport blocks/codewords. For example, a first HARQ-ACK bit of two HARQ-ACK feedback bits of the multi-cell DCI may correspond to a first scheduled cell or a primary scheduled cell (e.g., the second cell). A second HARQ-ACK bit of two HARQ-ACK feedback bits of the multi-cell DCI may correspond to a second scheduled cell or non-primary scheduled cell (e.g., the third cell). For example, a first HARQ-ACK bit of two HARQ-ACK feedback bits of the single-cell DCI may correspond to a first transport block scheduled by the single-cell DCI. A second HARQ-ACK bit of two HARQ-ACK feedback bits of the single-cell DCI may correspond to a second transport block scheduled by the single-cell DCI. This may reduce flexible number of schedulable cells by a multi-cell DCI (e.g., up to two cells are allowed). This may be used when maxNrofCodeWordsScheduledByDCI is configured to be larger than 1 for any cell for the HARQ-ACK codebook determination. Yet, this may simplify the wireless device implementation and may allow efficient coexistence between a multi-cell scheduling and a single-cell scheduling. This allows multiplexing of first HARQ-ACK bits for multi-cell DCIs and second HARQ-ACK bits for single-cell DCIs with reduced wireless device complexity and overhead. For example, this reduces a number of HARQ-ACK bits by allocating a second HARQ-ACK bit for a second transport block (e.g., in case a single cell DCI) or a second scheduled cell or a non-primary scheduled cell (e.g., in case a multi-cell DCI).

In an example, a base station may transmit a M-DCI with a total DAI field. The total DAI field may indicate a value of total accumulated PDCCH monitoring occasions across one or more serving cells and additional K. For example, the base station and/or a wireless device may determine the K based on a number of serving cells schedulable by a M-DCI and a number of accumulated PDCCH monitoring occasions of one or more M-DCIs. For example, for a PUCCH/HARQ-ACK feedback resource, the base station may have one M-DCI scheduled via a monitoring occasion of a cell (e.g., a PDCCH monitoring occasion comprises the monitoring occasion of the cell) and the one M-DCI may comprise resource assignments for N serving cells (e.g., N=2), the base station may increment N for a total DAI of the one M-DCI from a last DCI mapped to the same PUCCH/HARQ-ACK feedback resource. For example, additional K may be N−1 in this case. When the base station may schedule two M-DCIs for the N serving cells mapped to a PUCCH/HARQ-ACK feedback resource, the base station and/or wireless device may determine K=2*(N−1). The base station and/or the wireless device may determine a value for a C-DAI/DAI field based on a first cell.

For example, the first cell is a cell, of N serving cells schedulable by a M-DCI, with a lowest cell index among the N serving cells. A cell index of the first cell is a lowest among cell indexes of the N serving cells. For example, the first cell is a scheduling cell of the M-DCI. The wireless device may receive the M-DCI via the first cell. For example, the first cell is a primary cell. For example, the first cell is a primary cell of a second cell group or a PUCCH cell. For example, a first subcarrier spacing/numerology of the first cell is a largest (or smallest) subcarrier spacing/numerologies among the N serving cells. For example, the wireless device may determine the first cell based on one or more conditions/combinations of cell index, numerology, and/or a scheduling cell. For example, when there are a plurality of cells of the N serving cells with a lowest (or largest) subcarrier spacing/numerology, the wireless device may determine the first cell of the plurality of cells with a lower/lowest cell index.

The wireless device may determine a HARQ-ACK codebook in an order first based on a starting time of a PDCCH monitoring occasion for a DCI, and then a serving cell index among DCIs scheduled for one or more serving cells via a same PDCCH monitoring occasion. For example, the wireless device may determine the PUCCH/HARQ-ACK feedback resource corresponding to the M-DCI based on a PDSCH or a SPS PDSCH release scheduled for the first cell and a PDSCH-to-HARQ feedback timing indicator. For example, the PDSCH-to-HARQ feedback timing indicator may indicate a offset between a last slot, based on a numerology of the first cell, of the PDSCH or the SPS PDSCH release (or a transport block scheduled by the PDSCH or a last PDCCH indicating the SPS PDSCH release) and a start slot, based on a numerology of a PUCCH cell of the PUCCH/HARQ-ACK feedback resource, of the PUCCH/HARQ-ACK. For the multi-cell DCI, the wireless device may determine or apply a scheduling offset for a PDSCH or a offset for a PUCCH resource based on the first cell, where the first cell is one of the plurality of scheduled cells.

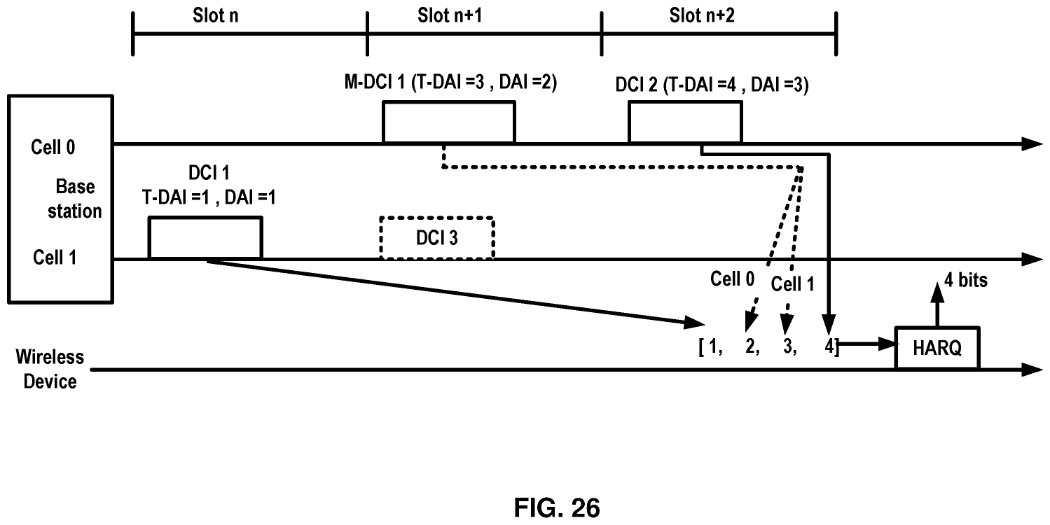

FIG. 26 illustrates an example of embodiments. For example, a base station transmits a first multi-cell DCI (M-DCI 1) via a first cell. The base station transmits a first DCI via a second cell. For example, the first multi-cell DCI may comprise/indicate resource assignments for the first cell and the second cell. The first multi-cell DCI may schedule a first PDSCH of a first TB for the first cell and a second PDSCH of a second TB for the second cell. The first DCI may comprise resource assignment(s) for the first cell. The first DCI may schedule a PDSCH of a third TB for the first cell. The base station transmits a second DCI (DCI 2) via the first cell. The second DCI may comprise/indicate resource(s) for the first cell. As shown in FIG. 26, the first DCI indicates a T-DAI=1 and a C-DAI/DAI=1. The first DCI indicates that a total accumulated number of PDCCH monitoring occasions as 1. For example, there is a PDCCH monitoring occasion up to a monitoring occasion for the first DCI. The first multi-cell may indicate a T-DAI=3 and a C-DAI/DAI=1. For example, the base station and/or the wireless device may increment a value of a total DAI from the first DCI to the first multi-cell DCI by 2 (e.g., 1+1). For example, the increment may comprise one corresponding to a new PDCCH monitoring occasion or a new DCI (e.g., the first multi-cell DCI). Additionally, the increment may further comprise K=N−1 (N=2 of a number of scheduling cells).

The base station and/or the wireless device may increment N for the C-DAI/DAI value from a previous DCI scheduling reception of PDSCH(s) and/or SPS PDSCH release(s) for the first cell to a multi-cell DCI (e.g., the first multi-cell DCI). For example, N is the number of schedulable cells. The C-DAI/DAI value of the first multi-cell DCI may indicate 2 as the multi-cell DCI is a first DCI of a PDCCH monitoring occasion for the first cell and may schedule two cells. The base station and/or the wireless device may determine the value of the C-DAI/DAI based on a scheduling cell (e.g., the first cell) or a lowest indexed scheduled cell of a plurality of scheduled cells by a multi-cell DCI (e.g., a first index of the first cell is lower than a second index of the second cell). The second DCI may indicate a T-DAI=4 and a C-DAI/DAI=3. Based on the first multi-cell DCI, the first DCI and the second DCI, the wireless device may determine four HARQ-ACK feedback bits. For example, a first bit of the HARQ-ACK feedback bits may correspond to a first PDCCH monitoring occasion (e.g., the first DCI). A second bit and a third bit of the HARQ-ACK feedback bits may correspond to a second PDCCH monitoring occasion (e.g., the first multi-cell DCI). For the first multi-cell DCI, N bits of HARQ-ACK feedback bits (e.g., N is a number of schedulable cells) may be generated. A fourth bit of the HARQ-ACK feedback bits may correspond to a third PDCCH monitoring (e.g., the second DCI). For example, as shown in FIG. 26, the wireless device may determine the HARQ-ACK feedback bits in an order of early PDCCH monitoring occasion to later PDCCH monitoring occasion based on start time and then order of serving cells based on cell index.

For example, the base station may transmit a third DCI via a second monitoring occasion of the second cell (shown in dotted box), where the second monitoring occasion of the second cell has a same starting time to the first monitoring of the first cell. The wireless device may determine five bits of HARQ-ACK feedback bits where a second and a third HARQ-ACK bits correspond to the first multi-cell DCI. A fourth HARQ-ACK bit may correspond to the third DCI. A fifth HARQ-ACK bit may correspond to the second DCI. A first PDSCH for the second cell scheduled by the first multi-cell DCI may occur before or after a second PDSCH for the second cell scheduled by the third DCI.

For example, when the wireless device misses the first multi-cell DCI in FIG. 26, the wireless device may skip generating one or more HARQ-ACK bits corresponding to the first multi-cell DCI. The wireless device may generate 1 HARQ-ACK bit corresponding to the first DCI and then generate 1 HARQ-ACK bit corresponding to the second DCI. The wireless device may generate two NACK bits corresponding to the first cell as the C-DAI/DAI value of the second DCI is 3. When the wireless device misses the multi-cell DCI, the wireless device may not differentiate whether the wireless device misses a multi-cell DCI or two single-cell DCIs scheduling resources for the first cell. The wireless device may generate two NACKs correspondingly.

In an example, a base station may transmit one or more RRC messages indicating/comprising configuration parameters. The configuration parameters may indicate a number of maximum transport block or codewords for a cell that is larger than one (e.g., maxNrofCodeWordsScheduledByDCI=2 for the cell). When at least one cell of one or more cells for a PUCCH/HARQ feedback resource is configured with maxNrofCodeWordsScheduledByDCI=2, the wireless device may determine two HARQ-ACK information bits for each corresponding DCI of a cell via a PDCCH monitoring occasion. For example, if the first cell in FIG. 26 (e.g., Cell 0) is configured with maxNrofCodeWordsScheduledByDCI=2, the wireless device may determine 8 bits of HARQ-ACK information bits instead of 4 bits. For example, first two bits of the 8 bits of HARQ-ACK information bits may correspond to the first DCI (DCI 1). Next four bits of the 8 bits of HARQ-ACK information bits (e.g., 3rd, 4th bits) may correspond to the first multi-cell DCI (M-DCI 1). Last two bits may correspond to the second DCI (DCI 2).

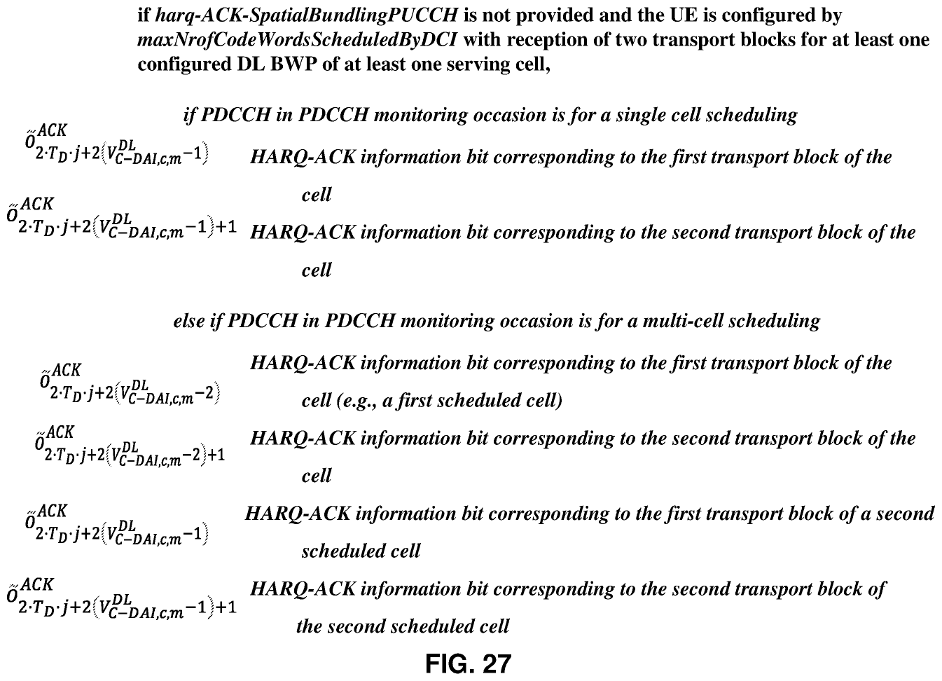

FIG. 27 illustrates a pseudo code of an example embodiment. In an example, a wireless device may determine monitoring occasions for receiving DCI(s) of PDCCH(s) with one or more DCI formats scheduling PDSCH or SPS PDSCH release via an active downlink BWP of a serving cell. The wireless device may determine one or more HARQ-ACK/HARQ feedback bits in a same PUCCH in a slot n based on (1) a value of a PDSCH-to-HARQ feedback timing indicator field of a DCI format scheduling a PDSCH reception or a SPS PDSCH release; and (2) a slot offsets or timing offsets between a PDCCH/DCI and a PDSCH (e.g., K0) provided by a time domain resource assignment filed in a DCI format scheduling a PDSCH or a SPS PDSCH release; and (3) a number of slot aggregations for the PDSCH or the SPS PDSCH release.

For example, a wireless device may determine a set of PDCCH monitoring occasions for one or more DCI format that may schedule a PDSCH reception or a SPS PDSCH release. The set of PDCCH monitoring occasions may comprise one or more monitoring occasions based on one or more search spaces of an active DL BWPs of configured serving cells. The one or more monitoring occasions may be indexed in an ascending order of a start time of a search space associated or determining a PDCCH monitoring occasion. A cardinality of the set of PDCCH monitoring occasions may be defined as a total number M of the one or more monitoring occasions.

A value of a counter DAI (C-DAI, DAI) field of the one or more DCI formats for a cell may indicate/denote an accumulative number of {a serving cell, a PDCCH monitoring occasion}+sum (i=0, i<K) number of scheduled cells (i) for the cell. For example, the wireless device may receive PDSCH or SPS PDSCH release associated with the one or more DCI formats via each of {the serving cell, the PDCCH monitoring occasion}. The accumulative number may be up to a current PDCCH monitoring occasion or a current monitoring occasion or a current DCI. For example, the sum of a number of scheduled cells may represent a summation/a total numbers of a number of scheduled/schedulable cells by each monitoring occasion and/or each PDCCH monitoring occasion by the current PDCCH monitoring occasion or the current monitoring occasion or by the current DCI. For example, when the wireless device may have two single cell DCIs and two multi-cell DCIs comprising/indicating resource assignments for two cells up to the current PDCCH monitoring occasion/monitoring occasion and a second multi-cell DCI is a current DCI of the current PDCCH monitoring occasion/monitoring occasion, the wireless device may determine that a C-DAI/DAI value of the second multi-cell DCI as 5 (five monitoring occasions)+0+0+1+1 (two single cell DCIs and two multi-cell DCIs). The C-DAI/DAI value may be 7 in this case (or 3 based on modulo 4 if maximum C-DAI/DAI value is 4). Similarly, for a total DAI value of a DCI, the wireless device may determine the T-DAI value of the DCI based on a total number of {a serving cell, a PDCCH monitoring occasion}+sum (i=0, i<K) number of scheduled cells (i) across one or more serving cells.

For example, if the wireless device may be configured with a plurality of coreset pools and ACKNACKFeedbackMode=Separate, the wireless device may perform a HARQ-ACK determination for each coreset pool. When the wireless device is configured with the plurality of coreset pools and ACKNACKFeedbackMode=Joint, the wireless device may determine a total DAI of a DCI by summing a first total DAI value associated with a first coreset pool/a first coreset pool index and a second total DAI value associated with a second coreset pool/a second coreset pool index. The wireless device may assume a same value of a T-DAI in one or more DCI formats/DCIs monitored via a same PDCCH monitoring occasion m.

In an example, a wireless device may determine M bits of HARQ-ACK information bits for a PUCCH transmission in a slot n or a UCI of a HARQ-ACK feedback in the slot n. For example, the wireless device may determine M as a sum (C-DAI (c, m)*P) for each cell c+ missing ones based on a last T-DAI value. For example, m may represent a last PDCCH monitoring occasion for the cell c, where the wireless device may receive a DCI indicating a PDSCH reception. The wireless device may determine missing ones based on the last T-DAI value, where the wireless device may determine a DCI received via a last PDCCH monitoring occasion and determine the last T-DAI value based on a value of a T-DAI of the DCI. The wireless device may sum counter-DAI values of one or more serving cells mapped to a same PUCCH/HARQ feedback resource and may determine one or more missing DCIs based on a last T-DAI value. For example, P denotes a number of HARQ-ACK bits for each DCI or each monitoring occasion or each PDCCH monitoring occasion for a cell. When a maximum number of transport block/codewords is 1 for the one or more serving cells, the wireless device may determine P=1. When the maximum number of transport block/codewords is 2 for any cell of the one or more serving cells, the wireless device may determine P=2.

For example, the wireless device may determine one or two HARQ-ACK bits for a PDSCH or a SPS PDSCH release corresponding to a DCI via a PDCCH monitoring occasion m for a cell c. For example, when there is a PDSCH on the cell c associated with a PDCCH in the PDCCH monitoring occasion m, or there is a PDCCH indicating a SPS PDSCH release on the cell c via the PDCCH monitoring occasion m, the wireless device may determine at least one HARQ-ACK bits corresponding to the PDCCH monitoring occasion. For example, the wireless device is not configured with HARQ-ACK spatial bundling (e.g., harq-ACK-SpatialBundlingPUCCH is not provided) and the wireless device is configured with maxNrofCodeWordsScheduledByDCI with reception of two transport blocks for at least one configured downlink bandwidth part of at least one cell of the one or more serving cells, the wireless device may determine two HARQ-ACK bits corresponding to a DCI via a PDCCH monitoring occasion of a cell in response to the DCI is a single cell scheduling DCI. For example, the wireless device may determine up to four HARQ-ACK bits corresponding to a multi-cell DCI via a PDCCH monitoring occasion of a cell in response to the multi-cell DCI is a multi-cell scheduling DCI, and comprises resources for a plurality of scheduled cells.

For example, for a PDCCH monitoring occasion, a wireless device may perform a pseudo code for each serving cell of one or more serving cells. For a cell c, if a wireless device may monitor a DCI via a PDCCH monitored via the PDCCH monitoring occasion, where the DCI may schedule at least one PDSCH and/or a SPS PDSCH release, the wireless device may determine one or more HARQ-ACK information bits corresponding to the DCI. For example, when the DCI via the PDCCH monitored via the PDCCH monitoring occasion is based on a DCI format configured for a single cell scheduling or the DCI is scrambled with a first RNTI for a single cell scheduling (e.g., if PDCCH in PDCCH monitoring occasion is for a single cell scheduling), the wireless device may determine up to two bits of HARQ-ACK information bits based on a maximum number of transport blocks/codewords. For example, when the maxNrofCodeWordsScheduledByDCI is two, the wireless device may determine two HARQ-ACK bits, where a first bit corresponds to a first transport block of a PDSCH scheduled by the DCI and a second bit corresponds to a second transport block of the PDSCH scheduled by the DCI. For example, when the DCI via the PDCCH monitored via the PDCCH monitoring occasion is based on a second DCI format configured for a multi-cell scheduling or the DCI is scrambled with a second RNTI for a multi-cell scheduling (e.g., if PDCCH in PDCCH monitoring occasion is for a multi-cell scheduling), the wireless device may determine N HARQ-ACK information bits or 2*N HARQ-ACK information bits based on maxNrofCodeWordsScheduledByDCI. For example N is a number of schedulable cells by the DCI. FIG. 27 illustrates a case of N=2. For example, maxNrofCodeWordsScheduledByDCI is 2 in FIG. 27. The wireless device may determine four HARQ-ACK information bits where first two HARQ-ACK bits correspond to a first cell of a plurality of schedulable cells and last two HARQ-ACK bits correspond to a second cell of the plurality of schedulable cells.

In FIG. 27, k-th and k+1-th (e.g., k=2*(C−DAI−1) HARQ-ACK bit may correspond to the first transport block of the cell c and the second transport bock of the cell c, where k is determined based on a C-DAI/DAI value of the DCI, when the DCI is a single cell scheduling DCI. m-th, m+1-th, . . . k-th, and k+1-th (e.g., m=2*(C-DAI−N), k=2*(C-DAI−1) may correspond to, where N is a number of schedulable cells. m-th and m+1-th HARQ-ACK bits may correspond to two transport blocks of the cell. m+2-th and m+3-th HARQ-ACK bits may correspond to two transport blocks of a second cell of the plurality of schedulable cells. FIG. 27 illustrates an example of two schedulable cells by a multi-cell DCI.

In an example, a wireless device may be configured, via RRC signaling, with a Type-2 (e.g., dynamic) HARQ-ACK codebook determination based on DAI values of one or more DCIs. The wireless device may be configured, via RRC signaling, with a maximum number of transport blocks/codewords being larger than 1 (e.g., maxNrofCodeWordsScheduledByDCI=2) for at least one downlink BWP of at least one serving cell of one or more configured serving cells to the wireless device. A base station may transmit one or more RRC messages indicating/comprising configuration parameters. The configuration parameters may indicate/comprise a multi-cell scheduling. For example, the configuration parameters may indicate/comprise a plurality of schedulable/scheduled cells by a multi-cell DCI. The configuration parameters may indicate/comprise a scheduling cell and one or more search spaces of the scheduling cell for monitoring one or more DCI formats for the multi-cell scheduling. For example, when the wireless device receives a DCI based on the one or more DCI formats for the multi-cell scheduling, the wireless device may receive maximum two transport blocks or maximum number of transport blocks/codewords that is same as a maximum value configured for a downlink bandwidth part of a cell based on maxNrofCodeWordsScheduledByDCI.

For example, the wireless device may receive maximum two transport blocks via the plurality of schedulable/scheduled cells by the one or more DCI formats for the multi-cell scheduling. For example, the base station may limit a number of the plurality of schedulable/scheduled cells being equal to or smaller than the maximum value configured for a downlink bandwidth part of a cell based on maxNrofCodeWordsScheduledByDCI. For example, the configuration parameters may indicate/comprise up to two schedulable/scheduled cells. For example, the configuration parameters may indicate a first cell and a second cell for the plurality of schedulable/scheduled cells. In an example, the wireless device may receive a first DCI, of a first DCI format of a single cell scheduling, comprising resource(s) for a first cell. The wireless device may receive a second DCI, of a second DCI format of the one or more DCI formats of a multi-cell scheduling, comprising resources for the first cell and the second cell. The base station and/or the wireless device may determine a C-DAI/DAI value of the first DCI and the second DCI based on one or more PDCCH monitoring occasion for the first cell, where the wireless device may monitor the first DCI format and/or the second DCI format. For example, the first DCI may schedule one transport block or two transport blocks for the first cell. For example, the second DCI may schedule one transport block for the first cell and/or one transport block for the second cell. In determining a HARQ-ACK information bit for the one transport block for the second cell, the wireless device may apply a HARQ-ACK codebook determination mechanism for the second transport block for the first cell. For example, the wireless device may map an ACK or NACK corresponding to the one transport block for the second cell in a HARQ-ACK bit corresponding to the second transport block for the first cell, if the second DCI is scheduled based on the first DCI format scheduling a single cell.

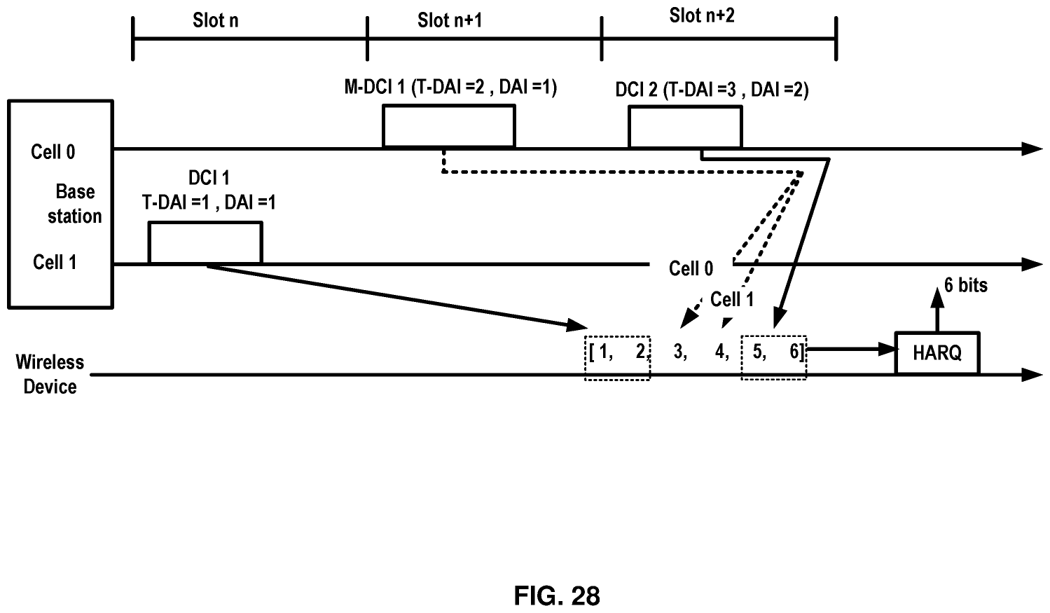

FIG. 28 illustrates an example embodiment. For example, the base station may transmit one or more RRC messages indicating/comprising configuration parameters for a first cell and/or a second cell. For example, the configuration parameters may indicate a maxNrofCodeWordsScheduledByDCI being equal to 2 for one or more downlink BWPs of the first cell. Based on the maxNrofCodeWordsScheduledByDCI=2 on at least one downlink BWP of the first cell, the wireless device may determine two HARQ-ACK information bits for each DCI scheduling PDSCH reception(s) and/or SPS PDCH release(s). The wireless device may determine a HARQ-ACK information bit for a first transport block scheduled by the each DCI and a second HARQ-ACK information bit for a second transport block scheduled by the each DCI. For example, when there is no second transport block scheduled by the each DCI, or the each DCI indicates a SPS PDSCH release, the wireless device may determine a NACK for the second HARQ-ACK information bit. In FIG. 28, the wireless device receives a first DCI via a first monitoring occasion of the second cell. The first DCI indicates a C-DAI/DAI=1 and a T-DAI=1 as the first DCI schedules a first PDSCH or a first SPS PDSCH release. The wireless device may determine two HARQ-ACK information bits for a first transport block and a second transport block scheduled by the first DCI. For example, the two HARQ-ACK information bits map to first two bits of a bitmap (6 bits bitmap shown in [1, 2, 3, 4, 5, 6]). The wireless device may monitor a second DCI (M-DCI 1) that the wireless device misses receiving or fails in decoding. The second DCI may indicate a C-DAI/DAI=1 and a T-DAI=2. The second DCI may schedule a first transport block for the first cell and a second transport block for the second cell. The base station may determine a C-DAI/DAI value of the multi-cell DCI based on the first cell. For example, if the second DCI of a multi-cell scheduling schedules a first PDSCH for the first cell or a first SPS PDSCH for the first cell, a value of the C-DAI/DAI would be 1.

For example, the wireless device may determine the first cell for determining a C-DAI/DAI value of a multi-cell DCI based on a cell index of the first cell and a cell index of the second cell. For example, a cell index of the first cell may be smaller than a cell index of the second cell. For example, the wireless device may determine the first cell that is a scheduling cell and one of schedulable/scheduled cells by the multi-cell scheduling. For example, the first cell schedules the second DCI and the second DCI comprises/indicates resource(s) for the first cell. For example, the wireless device may determine a primary cell (if the primary cell is belonging to the schedulable/scheduled cells), as the first cell. For example, the wireless device may determine a PUCCH cell (if the PUCCH cell is belonging to the schedulable/scheduled cells) as the first cell. Some other mechanisms to determine the first cell among the schedulable/scheduled cells by the multi-cell scheduling are not prohibited. The wireless device treats the second DCI, from a HARQ-ACK codebook determination perspective, as if a single-cell DCI scheduling two transport blocks. The wireless device may map a first HARQ-ACK information bit for a first transport block of the first cell. Instead of mapping a second HARQ-ACK information bit for a second transport block of the first cell, the wireless device may map the second HARQ-ACK information bit for a first transport block of the second cell.

Embodiments may limit a number of schedulable/scheduled cells as to maximum two. In FIG. 28, the wireless device may map a third HARQ-ACK information bit for the first cell based on the second DCI (M-DCI 1). The wireless device may map a fourth HARQ-ACK information bit for the second cell based on the second DCI (M-DCI 2). The wireless device may determine two HARQ-ACK information bits based on a third DCI (e.g., DCI 2). The third DCI may indicate/comprise a C-DAI/DAI=2 (as it schedules second PDSCH for the first cell) and a T-DAI=3 (as totally three DCIs scheduled PDSCH(s) and/or SPS PDSCH release(s)). The two HARQ-ACK information bits based on the third DCI may be mapped to two last HARQ-ACK information bits of the 6 bit bitmap. The wireless device may encode the bitmap and transmit via a PUCCH resource (e.g., HARQ).

In an example, the wireless device may receive the first DCI of a single-cell scheduling based on a first DCI format (e.g., a DCI format 1_1, a DCI format 1_0, a DCI format 1_2) scheduling reception of PDSCH(s) and/or SPS PDSCH release(s). The wireless device may receive the second DCI of a multi-cell scheduling based on a second DCI format (e.g., a DCI format 1_3) scheduling reception of PDSCH(s) and/or SPS PDSCH release(s) of a plurality of cells. The wireless device may receive the third DCI of a single-cell scheduling based on a third DCI format (e.g., a DCI format 1_1, a DCI format 1_0, a DCI format 1_2) scheduling reception of PDSCH(s) and/or SPS PDSCH release(s). In an example, the first DCI format may be same as the second DCI format. In this case, the wireless device may receive the first DCI, where the first DCI is scrambled with a CRC based on a first RNTI (e.g., a C-RNTI). The wireless device may receive the second DCI where the second DCI is scrambled with a CRC based on a second RNTI (e.g., a M-C-RNTI, a multi-cell-RNTI). The wireless device may receive the third DCI based on the first RNTI. In an example, the first DCI format may be different from the second DCI format. In this case, the wireless device may receive the second DCI where the second DCI is scrambled with a CRC based on the first RNTI.

In an example, the wireless device may miss receiving the second DCI (M-DCI 1). The wireless device may not know whether the wireless device missed a single-cell scheduling DCI or a multi-cell scheduling DCI. In response to receiving the third DCI, the wireless device may determine that a DCI has missed as a C-DAI value of the third DCI indicates 2 and a T-DAI value of the third DCI indicates 3. The wireless device may determine that a DCI for the first cell is missed. The wireless device may not be able to determine whether the wireless device missed a DCI based on the first DCI format (e.g., a single cell scheduling DCI) or a DCI based on the second DCI format (e.g., a multi-cell scheduling DCI). The wireless device may generate two NACK bits corresponding to the second DCI. Embodiments reduce ambiguity in terms of HARQ-ACK codebook determination regardless whether the wireless device misses one or more multi-cell DCIs and/or one or more single-cell DCIs.

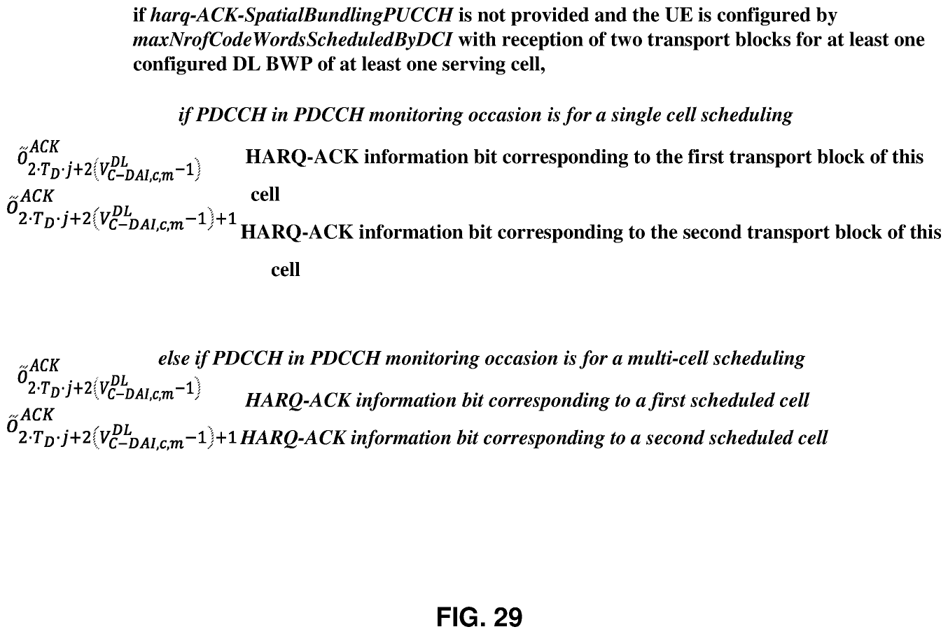

FIG. 29 illustrates a pseudo code for an example embodiment shown in FIG. 28. The pseudo code of FIG. 29 shows an alternative approach of FIG. 27 to determine HARQ-ACK feedback information corresponding to one or more multi-cell DCIs via one or more PDCCH monitoring occasions mapped to a PUCCH/HARQ feedback resource. When the wireless device receives a PDCCH (or a DCI) in a PDCCH monitoring occasion, the wireless device may generate two HARQ-ACK information bits corresponding to the PDCCH (or the DCI). For example, when the DCI is based on a first DCI format of a single-cell scheduling or the DCI is scrambled with a CRC of a first RNTI for a single-cell scheduling, the wireless device may determine a first HARQ-ACK bit corresponding to a first transport block of a cell and a second HARQ-ACK bit corresponding to a second transport block of the cell. For example, the DCI schedules resources for the cell. For example, when the DCI is based on a second DCI format of a multi-cell scheduling or the DCI is scrambled with a CRC of a second RNTI for a multi-cell scheduling, the wireless device may determine a first HARQ-ACK bit corresponding to a first transport block of the cell and a second HARQ-ACK bit corresponding to a first transport block of a second cell. For example, the DCI schedules resources for the cell and the second cell. The wireless device determines the cell for a DAI determination wherein the cell has smaller cell index than the second cell. The wireless device may determine the cell as the DCI is carried via the cell.

In an example, a base station may transmit one or more RRC messages comprising configuration parameters. The configuration parameters may indicate/comprise a parameter to enable a HARQ-ACK codebook determination for one or more DCI formats of a multi-cell scheduling based on an example embodiment illustrated in FIG. 26/FIG. 27. The configuration parameters may indicate/comprise a second parameter to enable a HARQ-ACK codebook determination for the one or more DCI formats of the multi-cell scheduling based on an example embodiment illustrates in FIG. 28/FIG. 29. For example, the base station may indicate the example embodiment of FIG. 28/FIG. 29 when the configuration parameters may indicate a maximum number of codewords is larger than 1 at least for one downlink bandwidth part of at least one cell. Otherwise, the base station may indicate the example embodiment of FIG. 26/FIG. 27. For example, the base station may indicate an example embodiment of FIG. 26/FIG. 27 when a number of scheduled/schedulable cells of the multi-cell scheduling exceeds two. Otherwise, the base station may indicate to use an example embodiment of FIG. 28/FIG. 29. In an example, a wireless device may determine whether to follow an example embodiment of FIG. 26/FIG. 27 or an example embodiment of FIG. 28/FIG. 29. For example, when a maxNrofCodeWordsScheduledByDCI is indicated being larger than 1 for at least one downlink BWP of at least one cell and a number of schedulable/scheduled cells by a multi-cell scheduling DCI is equal to maxNrofCodeWordsScheduledByDCI, the wireless device may determine a HARQ-ACK codebook based on an example embodiment of FIG. 28/FIG. 29. Otherwise, the wireless device may determine the HARQ-ACK codebook based on an example embodiment of FIG. 26/FIG. 27.

In an example, a wireless device may receive a multi-cell DCI comprising resource assignments for a plurality of serving cells. For example, the multi-cell DCI may be based on a first DCI format of a multi-cell scheduling. The first DCI format may comprise N C-DAI/DAI fields, where N is a number of the plurality of serving cells. For example, each C-DAI/DAI field of N C-DAI/DAI fields may correspond to each cell of the plurality of serving cells. A base station and/or the wireless device may determine a total DAI (T-DAI) value of the multi-cell DCI by accumulating a first increment of a first C-DAI/DAI of the N C-DAI/DAI fields corresponding to a first cell of the plurality serving cells, a second increment of a second C-DAI/DAI of the N C-DAI/DAI fields corresponding to a second cell of the plurality of serving cells, and i-th increment of a i-th C-DA/DAI of the N C-DAI/DAI fields corresponding to a i-th cell of the plurality of serving cells, and so on. For example, when N=2, the multi-cell DCI may increment by 2 from a previous DCI via a previous PDCCH monitoring occasion.

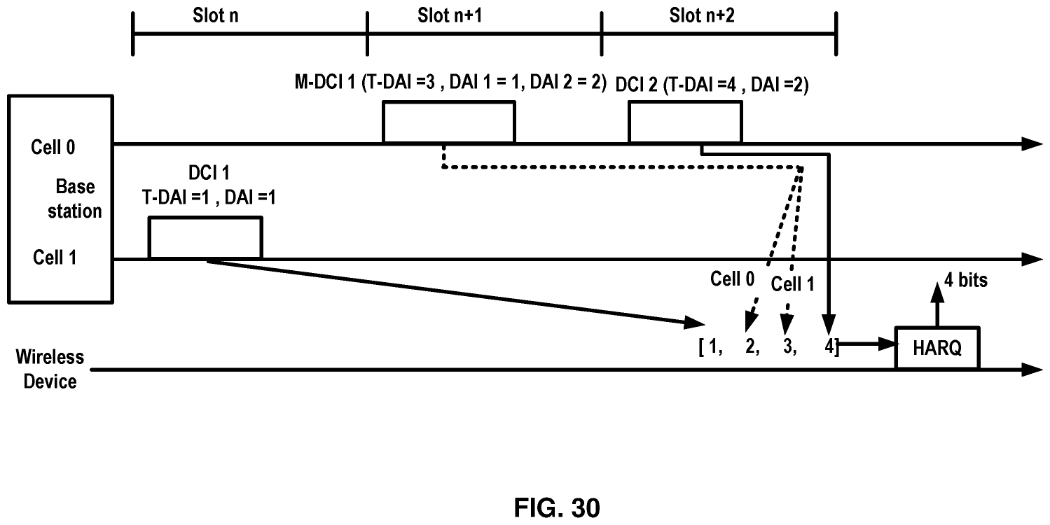

FIG. 30 illustrates an example embodiment. Similar to FIG. 26, the wireless device may receive a first DCI (DCI 1) indicating a C-DAI/DAI=1 and a T-DAI=1 as the first DCI schedules a first PDSCH for a second cell (Cell 1) via a first PDCCH monitoring occasion mapped to a PUCCH/HARQ-ACK resource. The wireless device may monitor a second PDCCH monitoring occasion. The base station may transmit a second DCI (M-DCI 1) indicating a T-DAI=3 and a first C-DAI/DAI=1 and a second C-DAI/DAI=2. The first C-DAI/DAI may correspond to a first cell (Cell 0). The second C-DAI/DAI may correspond to the second cell (Cell 1). The T-DAI is incremented by 2 from a previous DCI (DCI 1). The wireless device may receive a third DCI (DCI 2) indicating a C-DAI/DAI=2 and a T-DAI=4. The wireless device may determine HARQ-ACK information bits of total 4 bits assuming a maximum transport block/codeword is configured as 1. The wireless device may determine a first HARQ-ACK bit corresponding to the first DCI.

The wireless device may determine a fourth HARQ-ACK bit corresponding to the third DCI. The wireless device may miss receiving the second DCI. The wireless device may generate two NACKs for a second HARQ-ACK bit and a third HARQ-ACK bit. When the wireless device receives the second DCI, the wireless device may map the second HARQ-ACK bit for the first cell and map the third HARQ-ACK bit for the second cell. Embodiments may increase DCI overhead with more DAI/C-DAI fields for a multi-cell DCI. Embodiments reduces ambiguity in a HARQ-ACK codebook determination. Embodiments allows efficient HARQ-ACK feedback multiplexing between multi-cell DCIs and single-cell DCIs.

In an example, a wireless device may not multiplex a first HARQ-ACK codebook for one or more first DCI formats used for a multi-cell scheduling and a second HARQ-ACK codebook for one or more second DCI formats used for a single-cell scheduling. The wireless device may determine a first PUCCH/HARQ-ACK resource, where the wireless device may transmit the first HARQ-ACK codebook. The wireless device may determine a second PUCCH/HARQ-ACK resource, where the wireless device may transmit the second HARQ-ACK codebook. For example, the wireless device may determine the first HARQ-ACK codebook based on a Type-1 HARQ-ACK codebook determination. The wireless device may determine the second HARQ-ACK codebook based on a same type (e.g., Type-1 HARQ-ACK codebook determination) to the first HARQ-ACK codebook. The wireless device may apply the Type-1 HARQ-ACK codebook determination, or Type-2 HARQ-ACK codebook determination or Type-3 HARQ-ACK codebook determination for both the first HARQ-ACK codebook and the second HARQ-ACK codebook.

In an example, the wireless device may transmit the first HARQ-ACK codebook and the second HARQ-ACK codebook in response to one or more following cases. For example, the first PUCCH resource may not overlap with the second PUCCH resource in a time domain or in a carrier domain. For example, the first PUCCH is scheduled via a first cell (e.g., a PCell or a PUCCH cell) and the second PUCCH is scheduled via a second cell (e.g., a PUCCH cell or a PCell). The first cell is different from the second cell. For example, the first PUCCH resource may occur non-overlapped time with the second PUCCH resource. For example, the first PUCCH resource and the second PUCCH resource may overlap. Yet, there is a PUSCH overlapping with the first PUCCH resource and the second PUCCH resource. The wireless device may piggyback both the first HARQ-ACK codebook and the second HARQ-ACK codebook via the PUSCH. For example, the first PUCCH resource are fully overlapped with the second PUCCH resource in time and frequency and code domain. The wireless device may concatenate the first HARQ-ACK codebook and the second HARQ-ACK codebook and transmit the concatenated HARQ-ACK codebook via the first PUCCH resource (or the second PUCCH resource).

In an example, the wireless device may drop one of the first HARQ-ACK codebook and the second HARQ-ACK codebook in one or more following cases. For example, a first priority of the first HARQ-ACK codebook may be different from a second priority of the second HARQ-ACK codebook. The wireless device may determine a priority of a HARQ-ACK codebook based on priority(s) of corresponding PDSCH(s) and/or SPS PDSCH release(s). For example, a wireless device may be configured with transmitting one HARQ-ACK codebook at a time via a PUCCH resource. For example, a base station may transmit one or more RRC messages indicating/comprising configuration parameters. The configuration parameters may indicate/comprise a separate HARQ-ACK codebook transmission or a joint HARQ-ACK codebook transmission between the first HARQ-ACK codebook and the second HARQ-ACK codebook. For example, MCellACKNACKFeedbackMode=JointFeedback may indicate that the wireless device may concatenate the first HARQ-ACK codebook and the second HARQ-ACK codebook. For example, MCellACKNACKFeedbackMode=SeparateFeedback may indicate that the wireless device may transmit either the first HARQ-ACK codebook or the second HARQ-ACK codebook in a PUCCH resource when the first PUCCH resource and the second PUCCH resource overlap.

For example, the wireless device may determine the first HARQ-ACK codebook based on the first priority of the first HARQ-ACK codebook being higher than the second priority of the second HARQ-ACK codebook. For example, the wireless device may determine the first HARQ-ACK codebook based on the first priority and the second priority being equal and the first HARQ-ACK codebook is corresponding to one or more multi-cell DCIs. For example, a HARQ-ACK feedback for a multi-cell scheduling may be prioritized over a HARQ-ACK feedback for a single-cell scheduling.

This may reduce reliability of a HARQ-ACK feedback operation. This may increase power consumption by the wireless device by transmitting more uplink signals. Embodiments, however, reduces implementation complexity of the wireless device. Embodiments reduces ambiguity/misalignment between the base station and the wireless device in terms of a HARQ-ACK codebook determination.

In an example, a base station and/or a wireless device may determine C-DAI/DAI and T-DAI of one or more first DCIs based on one or more first DCI formats of a single cell scheduling separately/independently from C-DAI/DAI and T-DAI of one or more second DCIs based on one or more second DCI formats of a multi-cell scheduling. For example, the base station and/or the wireless device may increment a value of C-DAI/DAI across one or more DCIs, based on the one or more first DCI formats, scheduling resource(s) for a serving cell. The base station and/or the wireless device may increment a value of T-DAI across the one or more first DCIs across one or more serving cells. For example, the base station and/or the wireless device may increment a value of C-DAI/DAI across one or more DCIs, based on the one or more second DCI formats, scheduling resource(s) for a serving cell. The base station and/or the wireless device may increment a value of T-DAI across the one or more second DCIs across one or more serving cells. The wireless device may determine a first HARQ-ACK codebook corresponding to the one or more first DCIs. The wireless device may determine a second HARQ-ACK codebook corresponding to the one or more second DCIs.

The wireless device may concatenate the first HARQ-ACK codebook and the second HARQ-ACK codebook if joint HARQ-ACK feedback is configured (e.g., configured via RRC signaling of MCellACKNACKFeedbackMode=JointFeedback). The wireless device may transmit the first HARQ-ACK codebook or the second HARQ-ACK codebook if separate HARQ-ACK feedback is configured (e.g., configured via RRC signaling of MCellACKNACKFeedbackMode=SeparateFeedback) and a first PUCCH resource for the first HARQ-ACK codebook overlaps with a second PUCCH resource for the second HARQ-ACK codebook.

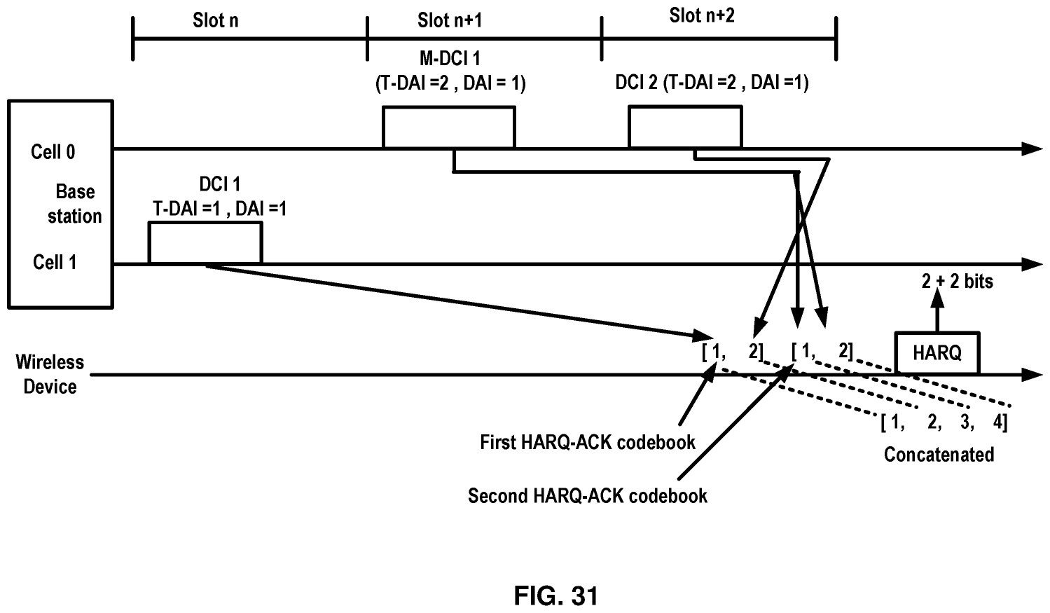

FIG. 31 illustrates an example embodiment of independent DAI determination between a single cell and a multi-cell scheduling. The wireless device may receive a first DCI (DCI 1) and a third DCI (DCI 2) for a single cell scheduling. The wireless device may determine a first HARQ-ACK codebook based on the first DCI and the third DCI of the single cell scheduling. The wireless device may monitor/receive a second DCI (M-DCI 1). The wireless device may determine a second HARQ-ACK codebook when the wireless device receives the second DCI. The wireless device may not determine the second HARQ-ACK codebook if the wireless device misses the second DCI. FIG. 31 illustrates that the wireless device receives the second DCI. The wireless device may concatenate the first HARQ-ACK codebook and the second HARQ-ACK codebook. The wireless device may transmit the concatenated HARQ-ACK bits via a PUCCH/HARQ-ACK resource (e.g., HARQ). In FIG. 31, the wireless device may transmit two HARQ-ACK bits based on the first DCI and the third DCI. The wireless device may determine/generate two HARQ-ACK bits for a multi-cell scheduling as the multi-cell DCI schedules two cells. The wireless device may not generate a HAQR-ACK information bits if the wireless device misses the second DCI that comprises/indicates resources of a first cell (Cell 0) and a second cell (Cell 1). The base station and/or the wireless device may determine a total-DAI (T-DAI) value of a M-DCI based on a number of scheduled cells. The base station and/or the wireless device may determine a total (T-DAI) value regardless of a number of scheduled cells. The wireless device may concatenate two bits of HARQ-ACK information bits corresponding to a single-cell scheduling first and two bits of HARQ_ACK information bits corresponding to a multi-cell scheduling second (e.g., the first HARQ-ACK codebook corresponding to a single cell scheduling before the second HARQ-ACK codebook corresponding to a multi-cell scheduling). In FIG. 31, the wireless device may transmit four bits of HARQ-ACK information bits after concatenation via the PUCCH resource.

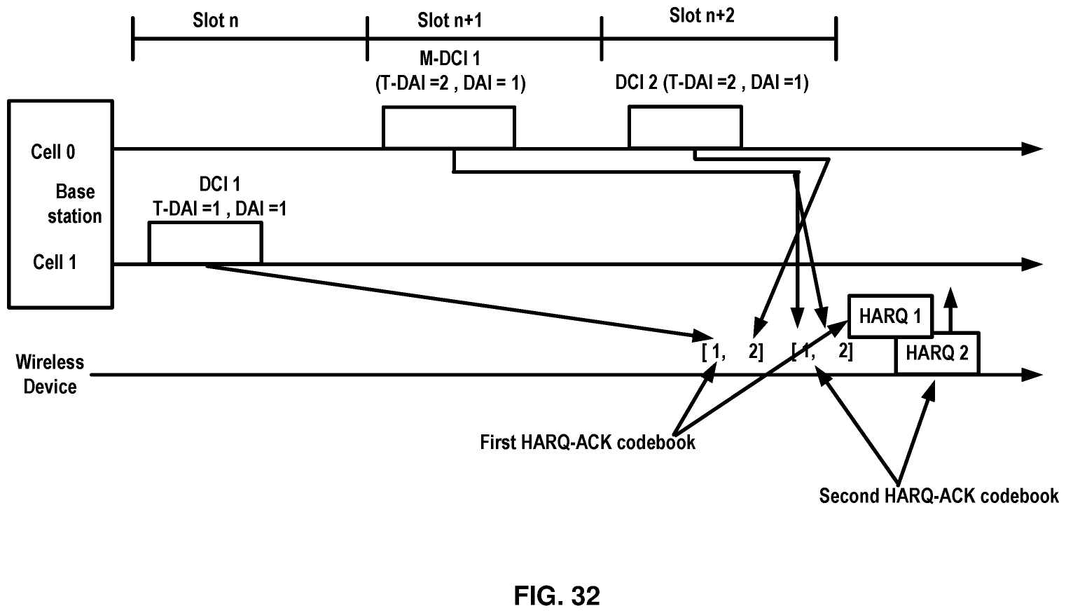

FIG. 32 illustrates an example embodiment of independent transmission of a first HARQ-ACK codebook corresponding to a single cell scheduling and a second HARQ-ACK codebook corresponding to a multi-cell scheduling. The scenario shown in FIG. 32 is similar to that shown in FIG. 31 except that the wireless device may determine a first PUCCH resource corresponding to the single cell scheduling and a second PUCCH resource corresponding to the multi-cell scheduling independently. For example, the wireless device may determine the first PUCCH resource (HARQ 1) based on one or more PDSCH-to-HARQ feedback timing indicator values of the first DCI (DCI 1) and the third DCI (DCI 2). The wireless device may determine the second PUCCH resource (HARQ 2) based on a PDSCH-to-HARQ feedback timing indicator value of the second DCI (M-DCI 1). A base station and/or the wireless device may determine C-DAI/DAI/T-DAI values of a DCI independently for a single cell scheduling and a multi-cell scheduling. The wireless device may generate/determine a first HARQ-ACK codebook corresponding to the first DCI and the third DCI. The wireless device may generate/determine a second HARQ-ACK codebook corresponding to the second DCI. When the first PUCCH resource overlaps with the second PUCCH resource, the wireless device may determine one of the first HARQ-ACK codebook and the second HARQ-ACK codebook based on a rule. For example, the rule is based on a priority of each HARQ-ACK codebook (e.g., select a higher priority HARQ-ACK codebook). For example, the rule is based on a multi-cell scheduling is prioritized. For example, the rule is based on a priority first and then prioritize the multi-cell scheduling of both HARQ-ACK codebooks having a same priority. FIG. 32 shows an example that the wireless device determines to transmit the second HARQ-Ack codebook. The wireless device ma transmits a PUCCH via the second PUCCH resource and may drop a transmission of a PUCCH via the first PUCCH. The wireless device may transmit the second HARQ-ACK codebook via the second PUCCH resource. The wireless device may drop the first HARQ-ACK codebook.

For example, the base station may transmit one or more RRC messages indicating configuration parameters. The configuration parameters may indicate a first multi-cell scheduling. For the first multi-cell scheduling, a first cell is a scheduling cell and a multi-cell DCI of the first multi-cell scheduling schedules resources of the first cell and a second cell. The configuration parameters may indicate a second multi-cell scheduling. For the second multi-cell scheduling, a third cell is a scheduling cell and a multi-cell DCI of the second multi-cell scheduling schedules resources of the third cell, a fourth cell and a fifth cell. For example, the wireless device may determine a maximum number N of scheduled cells by a multi-cell DCI across one or more configured serving cells. In the above example, the wireless device may determine 3 as the maximum number of scheduled cells. The wireless device may determine N*P bits of HARQ-ACK information bits corresponding to a multi-cell DCI, when the wireless device receives the multi-cell DCI comprising a C-DAI/DAI. For example, N is the maximum number of scheduled cells. For example, P is a maximum number of transport blocks or codewords scheduled by a multi-cell DCI for a cell of one or more scheduled cells. For example, P may be configured via maxNrofCodeWordsScheduledByDCI. The configuration parameters may comprise/indicate a first maxNrofCodeWordsScheduledByDCI for a downlink bandwidth part of a cell. The first maxNrofCodeWordsScheduledByDCI may correspond to a number of codewords or transport blocks scheduled via a single cell DCI (e.g., based on one or more DCI formats of a single cell scheduling). The configuration parameters may comprise/indicate a second maxNrofCodeWordsScheduledByDCI for a downlink bandwidth part of a cell. The second maxNrofCodeWordsScheduledByDCI may correspond to a number of codewords or transport blocks scheduled via a multi-cell DCI for a cell (e.g., based on one or more DCI formats of a multi-cell scheduling).

In an example, a base station may indicate, via RRC signaling, a HARQ-ACK codebook multiplexing mechanism between a single-cell scheduling and a multi-cell scheduling. For example, an example embodiment shown in FIG. 26 may be referred as a first HARQ-ACK multiplexing type. For example, an example embodiment shown in FIG. 28 may be referred as a second HARQ-ACK multiplexing type. For example, an example embodiment shown in FIG. 30 may be referred as a third HARQ-ACK multiplexing type. For example, an example embodiment shown in FIG. 31 may be referred as a fourth HARQ-ACK multiplexing type. The base station may transmit one or more RRC messages indicating configuration parameters. The configuration parameters may comprise/indicate a multi-cell scheduling. The configuration parameters may comprise/indicate a type for a HARQ-ACK multiplexing between first DCIs of a single-cell scheduling and DCIs of a second multi-cell scheduling. Based on the HARQ-ACK multiplexing type, the wireless device may determine a bit size of a C-DAI/DAI or a number of C-DAI/DAI fields in a multi-cell DCI (e.g., based on example embodiment shown in FIG. 30). Based on the HARQ-ACK multiplexing type, the wireless device may determine one HARQ-ACK codebook for both single-cell DCIs and multi-cell DCIs or may determine separate HARQ-ACK codebook for each single-cell DCIs and multi-cell DCIs respectively. Based on the HARQ-ACK multiplexing type, the wireless device may determine a number of HARQ-ACK information bits and an order of the HARQ-ACK information bits. In an example, an example embodiment shown in FIG. 32 may be referred as a fifth HARQ-ACK multiplexing type, and may be configured by a base station via a RRC signaling.

In an example, a base station may transmit one or more RRC messages indicating configuration parameters. The configuration parameters may comprise/indicate a multi-cell scheduling. The configuration parameters may indicate a first cell as a scheduling cell. The configuration parameters may indicate the first cell and a second cell as a plurality of scheduled cells. The configuration parameters may comprise/indicate a HARQ-ACK determination type as a Type-1 (e.g., semi-static) HARQ-ACK codebook determination. The configuration parameters may indicate a first list of time domain resource allocation (TDRA) entries for the first cell. The first list of TDRA entries may be used for one or more DCI formats of a single cell scheduling. The configuration parameters may indicate a second list of time domain resource allocation (TDRA) entries for the first cell (and the second cell). The second list of TDRA entries may be used for one or more second DCI formats of a multi-cell scheduling. In response to being configured with the Type-1 HARQ-ACK codebook determination, the wireless device may determine that a set of scheduling offset values (e.g., k0) indicated by a DCI based on the one or more DCI formats of the single cell are equivalent to a second set of scheduling offset values (e.g., k0) indicated by a second DCI based on the one or more second DCI formats. The wireless device may determine a HARQ-ACK codebook based on the first list of TDRA entries. Scheduling offset values indicated by a single cell DCI for the first cell and scheduling offset values indicated by a multi-cell DCI for the first cell may be same. In such a case, the wireless device may determine one or more two HARQ-ACK bits corresponding to a PDCCH monitoring occasion for a cell.

In an example, a wireless device may determine that a set of values of a PDSCH-to-HARQ feedback timing indicator by a multi-cell DCI based on one or more first DCI formats may belong to or equivalent to or superset of a set of values of a PDSCH-to-HARQ feedback timing indicator by a single-cell DCI based on one or more second DCI formats. For example, the one or more first DCI formats may comprise/indicate resources for a plurality of cells. For example, the one or more second DCI formats may comprise/indicate resource for a cell.

In an example, when the wireless device is configured with the Type-1 HARQ-ACK codebook determination, the wireless device may determine a first HARQ-ACK codebook for one or more PDCCH monitoring occasions of a single cell DCI. The wireless device may determine a second HARQ-ACK codebook for one or more second PDCCH monitoring occasions of a multi-cell DCI. the wireless device may concatenate the first HARQ-ACK codebook and the second HARQ-ACK codebook. The wireless device may transmit the concatenated bits via a PUCCH/HARQ-ACK resource. The wireless device may determine the one or more PDCCH monitoring occasions for the single cell scheduling across one or more serving cells. The wireless device may determine the one or more second PDCCH monitoring occasions for the multi-cell scheduling across the one or more serving cells.

Example embodiments may be applied for multiplexing first HARQ-ACK information bit(s) corresponding to one or more group-common DCIs comprising/indicating resources for a cell and second HARQ-ACK information bit(s) corresponding to one or more DCIs comprising/indicating resources for a second cell. For example, the one or more group-common DCIs may indicate/comprise resources of the cell for one or more wireless devices. For example, the one or more group-common DCIs may be CRC scrambled with a first RNTI, that is not a C-RNTI. For example, the first RNTI may comprise a MBMS-C-RNTI (Multimedia Broadcast/Multicast service), a MBS-RNTI (multicast broadcast service), and/or a broadcast-RNTI, and/or a SC-PTM-RNTI (single-cell point to multicast). Example embodiments may be applied for multiplexing first HARQ-ACK information bit(s) corresponding to one or more sidelink DCIs comprising/indicating resources for a sidelink cell/carrier/BWP and second HARQ-ACK information bit(s) corresponding to one or more DCIs comprising/indicating resources of a second cell. Example embodiments may be applied for multiplexing first HARQ-ACK information bit(s) corresponding to one or more DCIs comprising/indicating resources for a satellite link/carrier/cell/HIP and second HARQ-ACK information bit(s) corresponding to one or more DCIs comprising/indicating resources of a second cell.

In an example, a wireless device may receive a first downlink control information (DCI) via a first physical downlink control channel (PDCCH) monitoring occasion. The first DCI may indicate resources of a plurality of cells, a first downlink assignment index (DAI), and a physical uplink control channel (PUCCH) resource corresponding to the first DCI. For example, the first DAI may be determined based on a number of the plurality of cells. The wireless device may receive a second DCI via a second PDCCH monitoring occasion that starts no earlier than the first monitoring occasion. The second DCI may indicate resource for data scheduled for a first cell, a second DAI and the PUCCH resource corresponding to the second DCI. For example, the second DAI may be determined based on the first DAI. Based on the first DAI and the second DAI, the wireless device may determine hybrid automatic repeat request (HARQ) information bits corresponding to the first DCI and the second DCI. For example, the HARQ-ACK information bits comprise bits based on an order of start time of the first PDCCH monitoring occasion and the second monitoring occasion. The wireless device may transmit uplink signal comprising the HARQ information bits.

According to an example embodiment, the first DAI may represent a total number of PDCCH monitoring occasions across serving cells and a total number of scheduled cells, up to the first PDCCH monitoring occasion. For example, the serving cells may comprise the plurality of cells and the first cell. The total number of PDCCH monitoring occasions may count one or more PDCCH monitoring occasions. For example, the wireless device may receive one or more DCIs, for the serving cells, scheduling receptions of physical downlink shared channels (PDSCHs) and/or semi-persistent-scheduling (SPS) PDSCH release via the one or more PDCCH monitoring occasions. For example, the total number of scheduled cells may sum a number of scheduled cells by one or more DCIs comprising resource assignments for the plurality of cells. For example, the first DAI may be a sum of the total number of PDCCH monitoring occasions and the total number of scheduled cells by extracting a number of the one or more DCIs.

According to an example embodiment, the second DAI may represent a total number of PDCCH monitoring occasions across the serving cells and a total number of scheduled cells, up to the second PDCCH monitoring occasion. For example, the total number of PDCCH monitoring occasions may count one or more PDCCH monitoring occasions. For example, the wireless device may receive one or more DCIs, for the serving cells, scheduling receptions of physical downlink shared channels (PDSCHs) and/or semi-persistent-scheduling (SPS) PDSCH release via the one or more PDCCH monitoring occasions. The total number of scheduled cells may sum a number of scheduled cells by one or more DCIs comprising resource assignments for the plurality of cells. The second DAI may be a sum of the total number of PDCCH monitoring occasions and the total number of scheduled cells by extracting a number of the one or more DCIs. According to an example embodiment, the HARQ information bits may comprise one or more HARQ information bits corresponding to the first DCI and one or more second HARQ information bits corresponding to the second DCI in response to the second PDCCH monitoring occasion occurs after the first PDCCH monitoring occasion. For example, the HARQ information bits may comprise one or more HARQ information bits corresponding to the first DCI and one or more second HARQ information bits corresponding to the second DCI in response to the second PDCCH monitoring occasion occurs at a same time to the first PDCCH monitoring occasion and a lowest indexed cell of the plurality of cells has lower cell index than the first cell.

According to an example embodiment, the first DAI may represent an accumulative number of PDCCH monitoring occasions for a second cell of the plurality of cells and a total number of scheduled cells, up to the first PDCCH monitoring occasion. For example, the accumulative number of PDCCH monitoring occasions may count one or more PDCCH monitoring occasions. For example, the wireless device receives one or more DCIs, for the second cell, scheduling receptions of physical downlink shared channels (PDSCHs) and/or semi-persistent-scheduling (SPS) PDSCH release via the one or more PDCCH monitoring occasions. For example, the total number of scheduled cells may sum a number of scheduled cells by one or more DCIs comprising resource assignments for the plurality of cells. The first DAI may be a sum of the accumulative number of PDCCH monitoring occasions and the total number of scheduled cells by extracting a number of the one or more DCIs. For example, the wireless device may determine the second cell of the plurality of cells, where a cell index of the second cell is a lowest among cell indexes of the plurality of cells. For example, the wireless device may determine the second cell of the plurality of cells, the wireless device receives the first DCI via the second cell. For example, the wireless device may determine the second cell of the plurality of cells, wherein the second cell is a primary cell or a PUCCH cell. For example, the wireless device may determine the second cell of the plurality of cells, wherein a subcarrier spacing of the second cell is a smallest among subcarrier spacings of the plurality of cells.

According to an example embodiment, the second DAI may be determined based on an accumulative number of PDCCH monitoring occasions for the first cell. The second DAI may be further based on a total number of scheduled cells, up to the second PDCCH monitoring occasion in response to the first cell is equal to the second cell. The second DAI may be a sum of the accumulative number of PDCCH monitoring occasions and the total number of scheduled cells by extracting a number of the one or more DCIs. The second DAI may not account a total number of scheduled cells, up to the second PDCCH monitoring occasion in response to the first cell is different from the second cell.

According to an example embodiment, the wireless device may receive one or more radio resource control (RRC) messages indicating configuration parameters. The configuration parameters may indicate/comprise one or more bandwidth parts for each serving cell of serving cells. The configuration parameters may indicate/comprise a number of transport blocks scheduled by a DCI for a BWP of the one or more bandwidth parts of a cell, where the number of transport blocks scheduled by the DCI is larger than 1. The configuration parameters may indicate/comprise a first DCI format indicating downlink resources for a second cell and a third cell. The configuration parameters may indicate/comprise a second DCI format indicating downlink resource for the first cell. For example, the first DCI may be based on the first DCI format and the plurality of cells may comprise the second cell and the third cell. For example, the second DCI may be based on the second DCI format. According to an example embodiment, the wireless device may determine first two HARQ-Acknowledgement (HARQ-ACK) information bits corresponding to the first DCI, wherein a first bit of the first two HARQ-ACK information bits corresponds to the second cell and a second bit of the first two HARQ-ACK information bits corresponds to the third cell. The wireless device may determine second two HARQ-ACK information bits corresponding to the second DCI, wherein a first bit of the second two HARQ-ACK information bits corresponds to a first transport block for the first cell and a second bit of the second two HARQ-ACK information bits corresponds a second transport block for the first cell. For example, the HARQ information bits may comprise the first two HARQ-ACK information bits and the second two HARQ-ACK information bits. For example, the first DAI may represent a total number of PDCCH monitoring occasions across the serving cells up to the first PDCCH monitoring occasion. The second DAI may represent a total number of PDCCH monitoring occasions across the serving cells up to the second PDCCH monitoring occasion. The first DAI may represent an accumulative number of PDCCH monitoring occasions for the second cell up to the first PDCCH monitoring occasion. For example, the second DAI may represent an accumulative number of PDCCH monitoring occasions for the first cell up to the second PDCCH monitoring occasion. For example, a cell index of the second cell may be lower than a cell index of the third cell. For example, the wireless device may receive the first DCI via the second cell. For example, the second cell may be a primary cell or a PUCCH cell. For example, a subcarrier spacing of the second cell may be smaller than a subcarrier spacing of the third cell.

According to an example embodiment, the wireless device may receive one or more radio resource control (RRC) messages indicating one or more first DCI formats indicating downlink resources for the plurality of cells and one or more second DCI formats indicating downlink resource for the first cell. The first DCI may be based on one of the one or more first DCI formats. The second DCI may be based on one of the one or more second DCI formats. For example, the first DAI may represent a total number of PDCCH monitoring occasions across serving cells and a total number of scheduled cells, up to the first PDCCH monitoring occasion, where the serving cells may comprise the plurality of cells. The total number of PDCCH monitoring occasions may count one or more PDCCH monitoring occasions, where the wireless device receives one or more DCIs, based on the one or more first DCI formats for the serving cells, scheduling receptions of physical downlink shared channels (PDSCHs) and/or semi-persistent-scheduling (SPS) PDSCH release via the one or more PDCCH monitoring occasions. For example, the total number of scheduled cells may sum a number of scheduled cells by one or more DCIs comprising resource assignments for the plurality of cells. The first DAI may be a sum of the accumulative number of PDCCH monitoring occasions and the total number of scheduled cells by extracting a number of the one or more DCIs. The second DAI may be a sum of the total number of PDCCH monitoring occasions and the total number of scheduled cells by extracting a number of the one or more DCIs. According to an example embodiment, the HARQ information bits may comprise one or more HARQ information bits corresponding to the first DCI and one or more second HARQ information bits corresponding to the second DCI in response to the second PDCCH monitoring occasion occurs after the first PDCCH monitoring occasion. For example, the HARQ information bits may comprise one or more HARQ information bits corresponding to the first DCI and one or more second HARQ information bits corresponding to the second DCI in response to the second PDCCH monitoring occasion occurs at a same time to the first PDCCH monitoring occasion and a lowest indexed cell of the plurality of cells has lower cell index than the first cell.

According to an example embodiment, the wireless device may determine a first HARQ-ACK codebook based on the first DCI and a second HARQ-ACK codebook based on the second DCI. The wireless device may determine the HARQ information bits by concatenating the second HARQ-ACK codebook and the first HARQ-ACK codebook.

In an example, a wireless device may receive a first downlink control information (DCI). The first DCI may indicate resources of a plurality of cells, a first downlink assignment index (DAI) and a first physical uplink control channel (PUCCH) resource corresponding to the first DCI. The wireless device may receive a second DCI. The second DCI may indicate resource for data scheduled for a first cell, a second DAI, and a second PUCCH resource corresponding to the second DCI. The wireless device may determine a first hybrid automatic repeat request (HARQ) information bits based on the first DAI. For example, the first DAI may be based on a number of the plurality of cells. The wireless device may determine a second HARQ information bits based on the second DAI. The second DAI information bits may be based on the first cell. In response to the first PUCCH resource overlapping with the second PUCCH resource, the wireless device may transmit an uplink signal comprising the first HARQ information bits or the second HARQ information bits based on at least one of comparing a first priority of the first HARQ information bits and a second priority of the second HARQ information bits, and a number of the plurality of cells being larger than one.

In an example, a wireless device may receive a first downlink control information (DCI). The first DCI may indicate resources of a plurality of cells, and a first physical uplink control channel (PUCCH) resource corresponding to the first DCI. The wireless device may receive a second DCI. The second DCI may indicate resource for data scheduled for a first cell, a second DAI, and a second PUCCH resource corresponding to the second DCI. For example, the plurality of cells may comprise the first cell. The wireless device may determine a hybrid automatic repeat request (HARQ) information bits for the first cell based on a first DAI of the plurality of DAI fields of the first DCI and the second DAI of the second DCI. The wireless device may transmit an uplink signal comprising the HARQ information bits.

In an example, a wireless device may receive one or more radio resource control (RRC) messages indicating configuration parameters. The configuration parameters may indicate/comprise a Type-1 hybrid automatic repeat request acknowledgement (HARQ-ACK) codebook determination. The configuration parameters may indicate/comprise one or more first DCI format indicating resources for a plurality of cells, where the plurality of cells comprises a first cell. The configuration parameters may indicate/comprise a first set of time domain resource allocation (TDRA) for a first cell, wherein the first set of TDRA may be indicated via first DCIs based on the one or more first DCI formats. The configuration parameters may indicate/comprise one or more second DCI format indicating resource for the first cell. The configuration parameters may indicate/comprise a second set of TDRA for the first cell, wherein the second set of TDRA may be indicated via second DCIs based on the one or more second DCI format. The wireless device may determine HARQ-ACK information bits corresponding to the first DCIs and the second DCIs based on the second set of TDRA. For example, the first set of TDRA may indicate a same set of scheduling offset values to the second set of TDRA. For example, a scheduling offset value may indicate a gap between a DCI and a scheduled PDSCH.

What is claimed is:

1. A wireless device comprising:
one or more processors; and
memory storing instructions that, when executed by the one or more processors, causes the wireless device to:
receive, via a first physical downlink control channel (PDCCH) monitoring occasion, a downlink control information (DCI) scheduling physical downlink shared channel (PDSCH) receptions on a plurality of cells, wherein:
the DCI comprises a downlink assignment index (DAI) field with a value indicating an accumulative number of one or more pairs of: PDCCH monitoring occasion and cell; and
the one or more pairs comprise the first PDCCH monitoring occasion paired with a first cell with a smallest cell index among the plurality of cells; and
transmit a hybrid automatic repeat request acknowledgment (HARQ-ACK) codebook comprising feedback bits of the PDSCH receptions, wherein the HARQ-ACK codebook is based on the value.

2. The wireless device of claim 1, wherein the instructions further cause the wireless device to:
receive, via a second PDCCH monitoring occasion, a second DCI indicating a second DAI field having a second value based on the value of the DAI; and
transmit, based on a timing order of the first PDCCH monitoring occasion and the second PDCCH monitoring occasion, a second HARQ-ACK codebook comprising second feedback bits corresponding to the DCI and the second DCI.

3. The wireless device of claim 2, wherein the DCI and the second DCI schedule the PDSCH receptions for at least two of the plurality of cells.

4. The wireless device of claim 2, wherein the HARQ-ACK codebook and the second HARQ-ACK codebook are a same HARQ-ACK codebook.

5. The wireless device of claim 1, wherein the instructions further cause the wireless device to receive one or more radio resource control (RRC) messages indicating one or more DCI formats indicating one or more downlink resources for the PDSCH receptions on one or more of the plurality of cells.

6. The wireless device of claim 1, wherein the DCI comprises resource assignment fields indicating time resources and frequency resources for the PDSCH receptions on the plurality of cells.

7. The wireless device of claim 1, wherein each PDSCH reception, of the PDSCH receptions, is scheduled on a respective cell of the plurality of cells.

8. The wireless device of claim 1, wherein the DAI field indicates a counter DAI (C-DAI) value.

9. A base station comprising:
one or more processors; and
memory storing instructions that, when executed by the one or more processors, causes the base station to:
transmit, via a first physical downlink control channel (PDCCH) monitoring occasion, a downlink control information (DCI) scheduling physical downlink shared channel (PDSCH) transmissions on a plurality of cells, wherein:
the DCI comprises a downlink assignment index (DAI) field with a value indicating an accumulative number of one or more pairs of: PDCCH monitoring occasion and cell; and
the one or more pairs comprise the first PDCCH monitoring occasion paired with a first cell with a smallest cell index among the plurality of cells; and
receive a hybrid automatic repeat request acknowledgment (HARQ-ACK) codebook comprising feedback bits of the PDSCH transmissions, wherein the HARQ-ACK codebook is based on the value.

10. The base station of claim 9, wherein the instructions further cause the base station to:
transmit, via a second PDCCH monitoring occasion, a second DCI indicating a second DAI field having a second value based on the value of the DAI; and
receive, based on a timing order of the first PDCCH monitoring occasion and the second PDCCH monitoring occasion, a second HARQ-ACK codebook comprising second feedback bits corresponding to the DCI and the second DCI.

11. The base station of claim 10, wherein the DCI and the second DCI schedule the PDSCH transmissions for at least two of the plurality of cells.

12. The base station of claim 10, wherein the HARQ-ACK codebook and the second HARQ-ACK codebook are a same HARQ-ACK codebook.

13. The base station of claim 9, wherein the instructions further cause the base station to transmit one or more radio resource control (RRC) messages indicating one or more DCI formats indicating one or more downlink resources for the PDSCH transmissions on one or more of the plurality of cells.

14. The base station of claim 9, wherein the DCI comprises resource assignment fields indicating time resources and frequency resources for the PDSCH receptions on the plurality of cells.

15. The base station of claim 9, wherein each PDSCH transmission, of the PDSCH transmissions, is scheduled on a respective cell of the plurality of cells.

16. The base station of claim 9, wherein the DAI field indicates a counter DAI (C-DAI) value.

17. A non-transitory computer-readable medium comprising instructions that, when executed by one or more processors of a wireless device, cause the wireless device to:
receive, via a first physical downlink control channel (PDCCH) monitoring occasion, a downlink control information (DCI) scheduling physical downlink shared channel (PDSCH) receptions on a plurality of cells, wherein:
the DCI comprises a downlink assignment index (DAI) field with a value indicating an accumulative number of one or more pairs of: PDCCH monitoring occasion and cell; and
the one or more pairs comprise the first PDCCH monitoring occasion paired with a first cell with a smallest cell index among the plurality of cells; and
transmit a hybrid automatic repeat request acknowledgment (HARQ-ACK) codebook comprising feedback bits of the PDSCH receptions, wherein the HARQ-ACK codebook is based on the value.

18. The non-transitory computer-readable medium of claim 17, wherein the instructions further cause the wireless device to:
receive, via a second PDCCH monitoring occasion, a second DCI indicating a second DAI field having a second value based on the value of the DAI; and
transmit, based on a timing order of the first PDCCH monitoring occasion and the second PDCCH monitoring occasion, a second HARQ-ACK codebook comprising second feedback bits corresponding to the DCI and the second DCI.

19. The non-transitory computer-readable medium of claim 17, wherein the instructions further cause the wireless device to receive one or more radio resource control (RRC) messages indicating one or more DCI formats indicating one or more downlink resources for the PDSCH receptions on one or more of the plurality of cells.

20. The non-transitory computer-readable medium of claim 17, wherein the DCI comprises resource assignment fields indicating time resources and frequency resources for the PDSCH receptions on the plurality of cells.
